(19) United States
(12) Patent Application Publication
(10) Pub. No.: US 2026/0070835 A1
(43) Pub. Date: Mar. 12, 2026

(54) NATIVELY COLORED GLASS-BASED ARTICLES

(71) Applicant: CORNING INCORPORATED, CORNING, NY (US)

(72) Inventors: Nikhila Balasubramanya, Corning, NY (US); Carol Ann Click, Corning, NY (US); Megan Aurora DeLamielleure, Corning, NY (US); Qiang Fu, Painted Post, NY (US); Charlene Marie Smith, Corning, NY (US); Alana Marie Whittier, Painted Post, NY (US)

(21) Appl. No.: 19/319,147

(22) Filed: Sep. 4, 2025

Related U.S. Application Data
(60) Provisional application No. 63/692,493, filed on Sep. 9, 2024.
(60) Provisional application No. 63/705,142, filed on Oct. 9, 2024.

(51) Int. Cl. C03C 3/097; C03C 4/02; C03C 10/00

(52) U.S. Cl. CPC C03C 3/097; C03C 4/02; C03C 10/0054; C03C 2203/10; C03C 2203/52

(57) ABSTRACT

A natively colored glass-based article has a composition, based on 100 mol % of the composition, including from 55.0 mol % to 80.0 mol % SiO₂, from 0.2 mol % to 35 mol % Li₂O, from 0.01 mol % to 5.0 mol % Na₂O, from greater than or equal to 0.01 mol % to less than or equal to 5.0 mol % K₂O, and from 0.0005 mol % to 5.0 mol % of one or more colorants including silver, gold, copper, NiO, Cr₂O₃, CO₃O₄, and/or MnO₂. The composition can have a molar ratio (Na₂O+K₂O)/(Li₂O+Na₂O+K₂O) from 0.0015 to 0.10. In aspects, the composition can have from 10.0 mol % to 30 mol % Li₂O. In aspects, the composition can have from 0.5 mol % to 8.0 mol % P₂O₅ and from 3.0 mol % to 10.0 mol % ZrO₂.

### CROSS-REFERENCE TO RELATED APPLICATIONS

This application claims the benefit of priority under 35 U.S.C. § 119 of U.S. Provisional Application No. 63/705,142 filed on Oct. 9, 2024, and U.S. Provisional Application No. 63/692,493 filed on Sep. 9, 2024, the contents of each of which are relied upon and incorporated herein by reference in their entireties.

### FIELD

The present specification generally relates to natively colored glass-based articles. More specifically, the present specification is directed to natively colored glass-based articles that may be formed into glass or glass-ceramic for electronic devices.

### TECHNICAL BACKGROUND

Glass-based articles are commonly used, for example, in consumer electronic devices (e.g., liquid crystal displays (LCDs), electrophoretic displays (EPD), organic light-emitting diode displays (OLEDs), plasma display panels (PDPs)), where glass-based articles can form part of a housing as well as covering the display. The mobile nature of many consumer electronic devices (e.g., smart phones, tablets, portable media players, personal computers, and cameras) makes these devices particularly vulnerable to accidental dropping on hard surfaces, such as the ground. Glass-based components may become damaged upon impact with hard surfaces.

Various industries, including the consumer electronics industry, desire colored materials with the same or similar strength and fracture toughness properties as existing, non-colored, ion-exchange strengthened glasses. However, the color of glass-based articles may be limited by existing techniques. Accordingly, a need exists to develop methods of making new colors of glass-based articles having improved damage resistance. Additionally or alternatively, there exists a need to quickly produce colored glass-based articles with consistent appearance.

### SUMMARY

There are set forth herein natively colored glass-based articles with high fracture toughness and/or high thermal conductivity. Chemical strengthening processes can be used to achieve high strength and high toughness properties. Also, the natively colored glass-based articles include glass-ceramics (e.g., including petalite and/or lithium disilicate crystal phases) can have increased fracture toughness relative to glass substrates. The natively colored glass-based material disclosed herein can provide good dimensional stability, good impact resistance, good crack resistance, good puncture resistance, and/or good flexural strength. The natively colored glass-based article can include a compressive stress region (e.g., be chemically strengthened), which can provide improved crack resistance, puncture resistance, impact resistance, and/or improved flexural strength. Also, minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article.

Natively colored glass-based substrates, articles, and/or housings including the same include at least one colorant. A predetermined color of the glass article and/or natively colored glass can be achieved by controlling an amount and identity of the colorant. The examples demonstrate that the one or more colorants (e.g., gold, copper, cobalt, chromium) can be added without impairing the mechanical properties of the corresponding article. Providing a natively colored glass housing with a colored glass article can eliminate the need for an additional layer to impart color to the housing, which can simplify assembly and provide a more consistent color. Consequently, the natively colored glass housing including the glass article can provide an aesthetically pleasing appearance (e.g., color) while simultaneously protecting an electronic device from damage and/or permitting wireless communication therethrough.

As discussed herein, the inventors have unexpectedly determined that the addition of low amounts of other alkali metal oxides (e.g., sodium oxide, potassium oxide), for example in predetermined ratios, can improve the heat transfer properties of the corresponding glass melt. In particular, the colorants used to obtain natively colored glass-based articles can decrease radiative heat transfer of the corresponding glass melt, which can pose processing problems (e.g., increased thermal gradients leading to inhomogeneity and/or limitations on throughput). By increasing the radiative heat transfer, these problems can be mitigated without impairing a meltability, appearance, or potential crystal structures in the resulting natively colored article. Until the work of the present inventors, it is believed that the impact of various alkali metal oxides on heat transfer (e.g., radiative), especially for colored glass-based melts, had not been investigated or understood. For example, adding relatively small amounts of larger alkali metal oxides (e.g., Na₂O+K₂O) can increase radiative thermal transfer (e.g., of colored glass-based melts) without significantly impacting resistivity, ion-exchangeability, and/or associated crystal phases (e.g., in the case of glass-ceramics). Moreover, it is believed that it was not possible to reliably quantify radiative heat transfer coefficients at (or near) temperatures of glass melts; consequently, the relationship between non-lithium alkali metal oxides and radiative heat transfer coefficient could not have been appreciated, especially for low amounts of non-lithium alkali metal oxides relative to a total amount of alkali metal oxides.

Aspect 1. A natively colored glass-based article comprising a composition, based on 100 mol % of the composition, comprising:
from greater than or equal to 55.0 mol % to less than or equal to 80.0 mol % SiO₂;
from greater than or equal to 10.0 mol % to less than or equal to 30 mol % Li₂O;
from greater than or equal to 0.01 mol % to less than or equal to 5.0 mol % Na₂O;
from greater than or equal to 0.01 mol % to less than or equal to 5.0 mol % K₂O; and
from greater than or equal to 0.0005 mol % to less than or equal to 5.0 mol % of one or more colorants, the one or more colorants includes silver, gold, copper, NiO, Cr₂O₃, Co₃O₄, MnO₂, or combinations thereof,
wherein a molar ratio (Na₂O+K₂O)/(Li₂O+Na₂O+K₂O) is from greater than or equal to 0.0015 to less than or equal to 0.10.

Aspect 2. The natively colored glass-based article aspect 1, wherein the composition further comprises:
from greater than or equal to 0.5 mol % to less than or equal to 8.0 mol % P₂O₅; and
from greater than or equal to 3.0 mol % to less than or equal to 10.0 mol % ZrO₂.

Aspect 3. A natively colored glass-based article comprising a composition, based on 100 mol % of the composition, comprising:
from greater than or equal to 55.0 mol % to less than or equal to 80.0 mol % SiO₂;
from greater than or equal to 0.2 mol % to less than or equal to 35 mol % Li₂O;
from greater than or equal to 0.01 mol % to less than or equal to 5.0 mol % Na₂O;
from greater than or equal to 0.01 mol % to less than or equal to 5.0 mol % K₂O;
from greater than or equal to 0.5 mol % to less than or equal to 8.0 mol % P₂O₅;
from greater than or equal to 3.0 mol % to less than or equal to 10.0 mol % ZrO₂; and
from greater than or equal to 0.0005 mol % to less than or equal to 5.0 mol % of one or more colorants, the one or more colorants includes silver, gold, NiO, Cr₂O₃, Co₃O₄, MnO₂, or combinations thereof,
wherein a molar ratio (Na₂O+K₂O)/(Li₂O+Na₂O+K₂O) is from greater than or equal to 0.0015 to less than or equal to 0.10.

Aspect 4. The natively colored glass-based article of aspect 3, wherein the composition comprises from greater than or equal to 10.0 mol % to less than or equal to 30 mol % Li₂O.

Aspect 5. The natively colored glass-based article of any one of aspects 1-4, wherein the composition comprises from greater than or equal to 60.0 mol % to less than or equal to 75.0 mol % SiO₂.

Aspect 6. The natively colored glass-based article of any one of aspects 1-5, wherein the composition further comprises:
from greater than or equal to 0.0 mol % to less than or equal to 20.0 mol % Al₂O₃;
from greater than or equal to 0.0 mol % to less than or equal to 4.0 mol % B₂O₃; and
from greater than or equal to 0.0 mol % to less than or equal to 3 mol % CaO.

Aspect 7. The natively colored glass-based article of any one of aspects 1-5, wherein the composition further comprises from greater than or equal to 1.0 mol % to less than or equal to 8.0 mol % Al₂O₃.

Aspect 8. The natively colored glass-based article of any one of aspects 1-7, wherein the composition comprises from greater than or equal to 13.0 mol % to less than or equal to 30.0 mol % of a total amount of Li₂O, Na₂O, and K₂O.

Aspect 9. The natively colored glass-based article of any one of aspects 1-8, wherein the composition comprises:
from greater than or equal to 0.01 mol % to less than or equal to 0.5 mol % Na₂O; and
from greater than or equal to 0.01 mol % to less than or equal to 1.0 mol % K₂O.

Aspect 10. The natively colored glass-based article of any one of aspects 1-9, wherein the composition comprises:
from greater than or equal to 0.02 mol % to less than or equal to 3.0 mol % Na₂O; and
from greater than or equal to 0.03 mol % to less than or equal to 2.0 mol % K₂O.

Aspect 11. The natively colored glass-based article of any one of aspects 1-10, wherein the molar ratio (Na₂O+K₂O)/(Li₂O+Na₂O+K₂O) is from greater than or equal to 0.005 to less than or equal to 0.10.

Aspect 12. The natively colored glass-based article of any one of aspects 1-11, wherein the composition comprises:
from greater than or equal to 0.0 mol % to less than or equal to 1.0 mol % MgO; and
from greater than or equal to 0.0 mol % to less than or equal to 1.0 mol % CaO.

Aspect 13. The natively colored glass-based article of any one of aspects 1-12, wherein the natively colored glass-based article exhibits:
a CIE L* value from greater than or equal to 15 to less than or equal to 90;
a CIE a* value from greater than or equal to −75 to less than or equal to 75; and
an absolute value of a CIE b* value from greater than or equal to 5.0 to less than or equal to 100.

Aspect 14. The natively colored glass-based article of any one of aspects 1-12, wherein the natively colored glass-based article exhibits:
a CIE L* value from greater than or equal to 55 to less than or equal to 75;
a CIE a* value is greater than or equal to 28 and less than or equal to 40; and
a CIE b* value is greater than or equal to −5 to less than or equal to 5.

Aspect 15. The natively colored glass-based article of any one of aspects 1-12, wherein the natively colored glass-based article exhibits:
a CIE L* value from greater than or equal to 15 to less than or equal to 40;
a CIE a* value is greater than or equal to 15 and less than or equal to 50; and
a CIE b* value is greater than or equal to −100 to less than or equal to −70.

Aspect 16. The natively colored glass-based article of any one of aspects 1-12, wherein the natively colored glass-based article exhibits:
a CIE L* value from greater than or equal to 15 to less than or equal to 40;
a CIE a* value is greater than or equal to 15 and less than or equal to 50; and
a CIE b* value is greater than or equal to 5 to less than or equal to 35.

Aspect 17. The natively colored glass-based article of any one of aspects 13-16, wherein a sum of an absolute value of CIE a* value and an absolute value of the CIE b* value (|a*|+|b*|) is greater than or equal to 10 and less than or equal to 100.

Aspect 18. The natively colored glass-based article of aspect 17, wherein the sum of the absolute value of CIE a* value and the absolute value of the CIE b* value (|a*|+|b*|) is greater than the CIE L* value.

Aspect 19. The natively colored glass-based article of any one of aspects 1-18, wherein the composition comprises from greater than or equal to 0.1 mol % to less than or equal to 5.0 mol % of a combination of NiO, Co₃O₄, and MnO₂.

Aspect 20. The natively colored glass-based article of any one of aspects 1-19, wherein the composition comprises gold in an amount from 1 parts-per-million to 100 parts-per-million.

Aspect 21. The natively colored glass-based article of any one of aspects 1-20, wherein the one or more colorants includes Au in a range from greater than or equal to 0.001 mol % to less than or equal to 0.50 mol %.

Aspect 22. The natively colored glass-based article of any one of aspects 1-21, wherein the one or more colorants includes Co₃O₄ in a range from greater than or equal to 0.01 mol % to less than or equal to 1.0 mol %.

Aspect 23. The natively colored glass-based article of any one of aspects 1-22, wherein the one or more colorants includes Cr₂O₃ in a range from greater than or equal to 0.01 mol % to less than or equal to 1.0 mol %.

Aspect 24. The natively colored glass-based article of any one of aspects 1-23, wherein the composition comprises:
CuO in a range from greater than or equal to 0.01 mol % to less than or equal to 0.5 mol %; and
SnO₂ in a range from greater than or equal to 0.01 mol % to less than or equal to 0.5 mol %.

Aspect 25. The natively colored glass-based article of any one of aspects 1-24, wherein the composition is free of rare earth oxides.

Aspect 26. The natively colored glass-based article of any one of aspects 1-25, wherein the composition exhibits a liquidus viscosity from greater than or equal to 50 Pascal-seconds to less than or equal to 550 Pascal-seconds.

Aspect 27. The natively colored glass-based article of any one of aspects 1-26, wherein the composition exhibits a radiative thermal conductivity at 1600° C. from greater than or equal to 150 Watts per meter-Kelvin (W/m-K) to less than or equal to 400 W/m-K.

Aspect 28. The natively colored glass-based article of aspect 27, wherein the radiative thermal conductivity is from greater than or equal to 200 W/m-K to less than or equal to 300 W/m-K.

Aspect 29. The natively colored glass-based article of any one of aspects 1-28, wherein the natively colored glass-based article is a glass-ceramic having a petalite crystal phase.

Aspect 30. The natively colored glass-based article of any one of aspects 1-28, wherein the natively colored glass-based article is a glass-ceramic having a lithium disilicate crystal phase.

Aspect 31. The natively colored glass-based article of any one of aspects 29-30, wherein the natively colored glass-based article exhibits:
a Young's modulus from greater than or equal to 100 GigaPascals to less than or equal to 250 GigaPascals; and
a fracture toughness K_{IC} from greater than or equal to 1.0 MPa m^{1/2} to less than or equal to 2.0 MPa m^{1/2}.

Aspect 32. The natively colored glass-based article of any one of aspects 1-31, further comprising a compressive stress layer having a maximum compressive stress from greater than or equal to 500 MegaPascals to less than or equal to 1500 MegaPascals.

Aspect 33. The natively colored glass-based article of any one of aspects 1-32, further comprising a thickness defined between a first major surface and a second major surface opposite the first major surface, the thickness is from 200 μm to 5 mm.

Aspect 34. The natively colored glass-based article of any one of aspects 1-33, wherein the glass-based article comprises a dielectric constant at frequencies from 10 GigaHertz to 60 GigaHertz of from greater than or equal to 5.6 to less than or equal to 6.4.

Aspect 35. A consumer electronic product, comprising:
a housing comprising a front surface, a back surface, and side surfaces;
electrical components at least partially within the housing, the electrical components comprising a controller, a memory, and a display, the display at or adjacent the front surface of the housing; and
a cover substrate disposed over the display,
wherein at least one of a portion of the housing comprises the natively colored glass-based article of any one of aspects 1-33.

Aspect 36. A method of forming a natively colored glass-based article comprising:
heating precursor materials to form a molten material, a composition of the molten material comprises, based on 100 mol % of the composition, comprising:
   from greater than or equal to 0.01 mol % to less than or equal to 5.0 mol % Na₂O;
   from greater than or equal to 0.01 mol % to less than or equal to 5.0 mol % K₂O; and
   from greater than or equal to 0.0005 mol % to less than or equal to 5.0 mol % of one or more colorants, the one or more colorants includes silver, gold, NiO, Cr₂O₃, Co₃O₄, MnO₂, or combinations thereof, and
cooling the molten material to form the natively colored glass-based article,
wherein a molar ratio (Na₂O+K₂O)/(Li₂O+Na₂O+K₂O) is from greater than or equal to 0.0015 to less than or equal to 0.10, the molten material exhibits a radiative thermal conductivity at 1600° C. from greater than or equal to 150 Watts per meter-Kelvin (W/m-K) to less than or equal to 400 W/m-K, and the natively colored glass-based article exhibits:
   a CIE L* value from greater than or equal to 15 to less than or equal to 90;
   a CIE a* value from greater than or equal to −75 to less than or equal to 75; and
   a CIE b* value is greater than or equal to −100 to less than or equal to 100.

Aspect 37. The method of aspect 36, wherein the radiative thermal conductivity is from greater than or equal to 200 W/m-K to less than or equal to 300 W/m-K.

Aspect 38. The method of any one of aspects 36-37, wherein the composition of the molten material further comprises:
from greater than or equal to 55.0 mol % to less than or equal to 80.0 mol % SiO₂; and
from greater than or equal to 10.0 mol % to less than or equal to 30 mol % Li₂O.

Aspect 39. A method of forming a natively colored glass-based article comprising:
heating precursor materials to form a molten material, a composition of the molten material comprises, based on 100 mol % of the composition, comprising:
   from greater than or equal to 55.0 mol % to less than or equal to 80.0 mol % SiO₂;
   from greater than or equal to 10.0 mol % to less than or equal to 30 mol % Li₂O.
   from greater than or equal to 0.01 mol % to less than or equal to 5.0 mol % Na₂O;
   from greater than or equal to 0.01 mol % to less than or equal to 5.0 mol % K₂O; and
   from greater than or equal to 0.0005 mol % to less than or equal to 5.0 mol % of one or more colorants, the one or more colorants includes silver, gold, NiO, Cr₂O₃, Co₃O₄, MnO₂, or combinations thereof, and
cooling the molten material to form the natively colored glass-based article,
wherein a molar ratio (Na₂O+K₂O)/(Li₂O+Na₂O+K₂O) is from greater than or equal to 0.0015 to less than or equal to 0.10, and the natively colored glass-based article exhibits:
   a CIE L* value from greater than or equal to 15 to less than or equal to 90;
   a CIE a* value from greater than or equal to −75 to less than or equal to 75; and
   a CIE b* value is greater than or equal to −100 to less than or equal to 100.

Aspect 40. The method of any one of aspects 36-39, wherein the composition further comprises:
from greater than or equal to 0.5 mol % to less than or equal to 8.0 mol % P₂O₅; and
from greater than or equal to 3.0 mol % to less than or equal to 10.0 mol % ZrO₂.

Aspect 41. A method of forming a natively colored glass-based article:
heating precursor materials to form a molten material, a composition of the molten material comprises, based on 100 mol % of the composition, comprising:
   from greater than or equal to 55.0 mol % to less than or equal to 80.0 mol % SiO₂;
   from greater than or equal to 0.2 mol % to less than or equal to 35 mol % Li₂O;
   from greater than or equal to 0.01 mol % to less than or equal to 5.0 mol % Na₂O;
   from greater than or equal to 0.01 mol % to less than or equal to 5.0 mol % K₂O;
   from greater than or equal to 0.5 mol % to less than or equal to 8.0 mol % P₂O₅;
   from greater than or equal to 3.0 mol % to less than or equal to 10.0 mol % ZrO₂; and
   from greater than or equal to 0.0005 mol % to less than or equal to 5.0 mol % of one or more colorants, the one or more colorants includes silver, gold, NiO, Cr₂O₃, Co₃O₄, MnO₂, or combinations thereof, and
cooling the molten material to form the natively colored glass-based article,
wherein a molar ratio (Na₂O+K₂O)/(Li₂O+Na₂O+K₂O) is from greater than or equal to 0.0015 to less than or equal to 0.10, and the natively colored glass-based article exhibits:
   a CIE L* value from greater than or equal to 15 to less than or equal to 90;
   a CIE a* value from greater than or equal to −75 to less than or equal to 75; and
   a CIE b* value is greater than or equal to −100 to less than or equal to 100.

Aspect 42. The method of any one of aspects 36-41, wherein the composition further comprises:
from greater than or equal to 0.0 mol % to less than or equal to 20.0 mol % Al₂O₃;
from greater than or equal to 0.0 mol % to less than or equal to 4.0 mol % B₂O₃; and
from greater than or equal to 0.0 mol % to less than or equal to 3 mol % CaO.

Aspect 43. The method of any one of aspects 36-42, wherein the composition further comprises from greater than or equal to 1.0 mol % to less than or equal to 8.0 mol % Al₂O₃.

Aspect 44. The method of any one of aspects 36-43, wherein the composition comprises:
from greater than or equal to 0.02 mol % to less than or equal to 3.0 mol % Na₂O; and
from greater than or equal to 0.03 mol % to less than or equal to 2.0 mol % K₂O.

Aspect 45. The method of any one of aspects 36-44, wherein the molar ratio (Na₂O+K₂O)/(Li₂O+Na₂O+K₂O) is from greater than or equal to 0.005 to less than or equal to 0.10.

Aspect 46. The method of any one of aspects 36-45, wherein the composition comprises:
from greater than or equal to 0.0 mol % to less than or equal to 1.0 mol % MgO; and
from greater than or equal to 0.0 mol % to less than or equal to 1.0 mol % CaO.

Aspect 47. The method of any one of aspects 36-46, wherein the natively colored glass-based article exhibits an absolute value of a CIE b* value from greater than or equal to 5.0 to less than or equal to 100.

Aspect 48. The method of any one of aspects 36-46, wherein the natively colored glass-based article exhibits:
the CIE L* value from greater than or equal to 55 to less than or equal to 75;
the CIE a* value is greater than or equal to 28 and less than or equal to 40; and
the CIE b* value is greater than or equal to −5 to less than or equal to 5.

Aspect 49. The method of any one of aspects 36-46, wherein the natively colored glass-based article exhibits:
the CIE L* value from greater than or equal to 15 to less than or equal to 40; and
the CIE a* value is greater than or equal to 15 and less than or equal to 50.

50. The method of any one of aspects 36-46, wherein the natively colored glass-based article exhibits:
the CIE L* value from greater than or equal to 15 to less than or equal to 40;
the CIE a* value is greater than or equal to 15 and less than or equal to 50; and
the CIE b* value is greater than or equal to 5 to less than or equal to 35.

Aspect 51. The method of any one of aspects 36-50, wherein a sum of an absolute value of CIE a* value and the absolute value of the CIE b* value (|a*|+|b*|) is greater than or equal to 10 and less than or equal to 100.

Aspect 52. The method of aspect 51, wherein the sum of the absolute value of CIE a* value and the absolute value of the CIE b* value (|a*|+|b*|) is greater than the CIE L* value.

Aspect 53. The method of any one of aspects 36-52, wherein the composition comprises from greater than or equal to 0.1 mol % to less than or equal to 5.0 mol % of a combination of NiO, Co₃O₄, and MnO₂.

Aspect 54. The method of any one of aspects 36-53, wherein the composition comprises gold in an amount from 1 parts-per-million to 100 parts-per-million.

Aspect 55. The method of any one of aspects 36-54, wherein the one or more colorants includes Au in a range from greater than or equal to 0.001 mol % to less than or equal to 0.50 mol %.

Aspect 56. The method of any one of aspects 36-55, wherein the one or more colorants includes Co₃O₄ in a range from greater than or equal to 0.01 mol % to less than or equal to 1.0 mol %.

Aspect 57. The method of any one of aspects 36-56, wherein the one or more colorants includes Cr₂O₃ in a range from greater than or equal to 0.01 mol % to less than or equal to 1.0 mol %.

Aspect 58. The method of any one of aspects 36-57, wherein the composition comprises:
CuO in a range from greater than or equal to 0.01 mol % to less than or equal to 0.5 mol %; and
SnO₂ in a range from greater than or equal to 0.01 mol % to less than or equal to 0.5 mol %.

Aspect 59. The method of any one of aspects 36-58, wherein the composition is free of rare earth oxides.

Aspect 60. The method of any one of aspects 36-59, wherein the composition exhibits a liquidus viscosity from greater than or equal to 50 Pascal-seconds to less than or equal to 550 Pascal-seconds.

Aspect 61. The method of any one of aspects 36-60, wherein the natively colored glass-based article exhibits:
a Young's modulus from greater than or equal to 100 GigaPascals to less than or equal to 250 GigaPascals; and
a fracture toughness K_{IC} from greater than or equal to 1.0 MPa m^{1/2} to less than or equal to 2.0 MPa m^{1/2}.

Aspect 62. The method of any one of aspects 36-61, further comprising:
heating natively colored glass-based article at a temperature from 500° C. to 800° C. for a period of time from 30 minutes to 24 hours to form one or more crystal phases including a petalite crystal phase, a lithium disilicate crystal phase, or combinations thereof.

Aspect 63. The colored glass-based article of any one of aspects 1-34, wherein the composition comprises from greater than or equal to 0.1 mol % to less than or equal to 5.0 mol % of the one or more colorants.

Aspect 64. The method of any one of aspects 36-62, wherein the composition of the molten material comprises from greater than or equal to 0.1 mol % to less than or equal to 5.0 mol % of the one or more colorants.

Additional features and advantages will be set forth in the detailed description which follows, and in part will be readily apparent to those skilled in the art from that description or recognized by practicing the aspects and/or embodiments described herein, including the detailed description which follows, the claims, as well as the appended drawings

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

### BRIEF DESCRIPTION OF THE DRAWINGS

FIG. 1 is a schematic plan view of an example consumer electronic device according to aspects of the disclosure;

FIG. 2 is a schematic perspective view of the example consumer electronic device of FIG. 1;

FIG. 3 is a conceptual diagram from a back view of a communicating device, more specifically of a cellular phone, according to an aspect of the disclosure;

FIG. 4 is a simplified conceptual view of the device of FIG. 3 in a slightly exploded cross-section taken along line 4-4 of FIG. 3;

FIG. 5 is a cross-sectional view of a natively colored glass-based housing including a glass-based article in accordance with aspects of the disclosure; and

FIG. 6 illustrates a flow chart of methods of making glass-based articles and/or natively colored glass-based housings in accordance with aspects of the disclosure;

FIG. 7 illustrates a step in a method of making glass-based articles and/or natively colored glass-based housings comprising ion exchange;

FIG. 8 schematically depicts a cross section of natively colored glass-based article having compressive stress regions according to aspects described and disclosed herein;

FIG. 9 schematically illustrates a relationship between thermal conductivity (K) in W/m-K on the vertical axis (i.e., y-axis) as a function of alkali metal oxide content (R₂O) in mol % on the horizontal axis (i.e., x-axis) for example compositions;

FIG. 10 schematically illustrates a relationship between thermal conductivity (K) in W/m-K on the vertical axis (i.e., y-axis) as a function of iron (Fe) in wt % on the horizontal axis (i.e., x-axis) for example natively colored compositions;

FIG. 11 schematically illustrates a relationship between resistivity (R) in Ohm-in on the vertical axis (i.e., y-axis) as a function of sodium and potassium content (Na+K) in mol % on the horizontal axis (i.e., x-axis) for example compositions;

FIG. 12 schematically illustrates temperature profiles in a glass melter with temperature (T) in degrees Celsius on the vertical axis (i.e., y-axis) versus position (x) in inches (in) along a travel direction in the glass melter on the horizontal axis (i.e., x-axis); and

FIG. 13 schematically illustrates results from X-ray diffraction (XRD) for example glass-ceramics.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

Reference will now be made in detail to natively colored glass-based articles according to various aspects. The colored glasses can contain lithia as a primary alkali metal oxide, which can have good ion exchangeability and achieve high strength and high toughness properties. By chemical strengthening or ceramming natively colored glass-based articles, high strength, high toughness, and high indentation cracking resistance can be achieved, which can increase the drop performance, strength, toughness, and other attributes of the natively colored glass-based articles. As discussed herein, the inventors have unexpectedly determined that the addition of low amounts of other alkali metal oxides (e.g., sodium oxide, potassium oxide), for example in predetermined ratios, can improve the heat transfer properties of the corresponding glass melt. In particular, the colorants used to obtain natively colored glass-based articles can decrease radiative heat transfer of the corresponding glass melt, which can pose processing problems (e.g., increased thermal gradients leading to inhomogeneity and/or limitations on throughput). By increasing the radiative heat transfer, these problems can be mitigated without impairing a meltability, appearance, or potential crystal structures in the resulting natively colored article.

As described herein, the concentration of constituent components (e.g., SiO₂, Al₂O₃, Li₂O, and the like) in natively colored glass-based compositions (e.g., glass-based articles) are given in mole percent (mol %) on an oxide basis, unless otherwise specified. Components of the natively colored glass-based composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. Throughout the disclosure, the composition of natively colored glass-based articles and/or natively colored glass-based substrates refers to the composition of the formed article or substrate as determined in wt % by: X-ray fluorescence and comparison with standard samples for alumina, phosphorous, alkaline earth metals, transition metals (e.g., ZnO, TiO₂, Fe₂O₃, SnO₂), sodium oxide, and potassium oxide; an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%−materials measured using X-ray fluorescence, ICP, and flame emission spectroscopy), and then the composition is converted from wt % to mol %, as reported herein. The composition refers to the composition of the formed article or substrate—not the raw materials added to form the glass-based article and/or glass-based substrate.

As used herein, a “glass-based substrate” refers to a glass-based piece that has not been ion exchanged. Similarly, a “glass-based article” refers to a glass-based piece that has been ion exchanged and is formed by subjecting a glass-based substrate to an ion exchange process. A “glass-based substrate” and a “glass-based article” are defined accordingly and include glass-based substrates and glass-based articles as well as substrates and articles that are made wholly or partly of a glass-based material, such as glass-based substrates that include a surface coating. While glass-based substrates and glass-based articles may generally be referred to herein for the sake of convenience, the descriptions of glass-based substrates and glass-based articles should be understood to apply equally to glass-based substrates and glass-based articles. Likewise, the claims are not necessarily limited to either an ion-exchanged glass-based article or a glass-based substrate that has not been ion exchanged unless otherwise indicated. In aspects, the glass-based material may comprise (in mol %) from 55 mol % to 80 mol % SiO₂, from 1 mol % to 8 mol % Al₂O₃, from 10 mol % to 35 mol % of at least one alkali metal oxide (R₂O) including from 0.2 mol % to 30 mol % Li₂O, from 0.001 mol % to 5 mol % of a colorant, and at least one of B₂O₃ or P₂O₅. In further aspects, the glass-based material can comprise from 0.5 mol % to 8.0 mol % P₂O₅ and from 0.2 mol % to 16 mol % ZrO₂. In further aspects, the glass-based material can comprise from 10.0 mol % to 30 mol % Li₂O. In further aspects, the glass-based material may comprise (in mol %) from 60 mol % to 75 mol % SiO₂, from 1 mol % to 8 mol % Al₂O₃, from 0.5 mol % to 8 mol % P₂O₅, from 10.0 mol % to 30 mol % Li₂O, non-zero amounts of Na₂O and K₂O, from 0 mol % to 1 mol % MgO, from 0 mol % to 3 mol % CaO, from 3.0 mol % to 10.0 mol % ZrO₂, from 0 mol % to 0.25 mol % SnO₂, and from from 0.01 mol % to 1.0 mol % of the colorant. In aspects, a glass-based material may optionally further comprise in a range from 0 mol % to 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. In aspects, the glass-based material can comprise an iron oxide, titanium dioxide, a cobalt oxide, a cerium oxide, a vanadium oxide, and/or a chromium oxide. In aspects, the colorant of the glass-based material can include silver, gold, copper, nickel (e.g., NiO), chromium (e.g., Cr₂O₃), cobalt (e.g., Co₃O₄), manganese (e.g., MnO₂), or combinations thereof.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. In aspects, glass-ceramics can comprise a petalite crystal structure and/or a lithium disilicate crystal structure—either or which can be the predominant crystal structure. In further aspects, glass-ceramics can additionally comprise a beta-quartz solid solution, a beta-spodumene solid solution, a lithium phosphate (Li₃PO₄) crystal phase, and/or a zirconium-containing crystal phase.

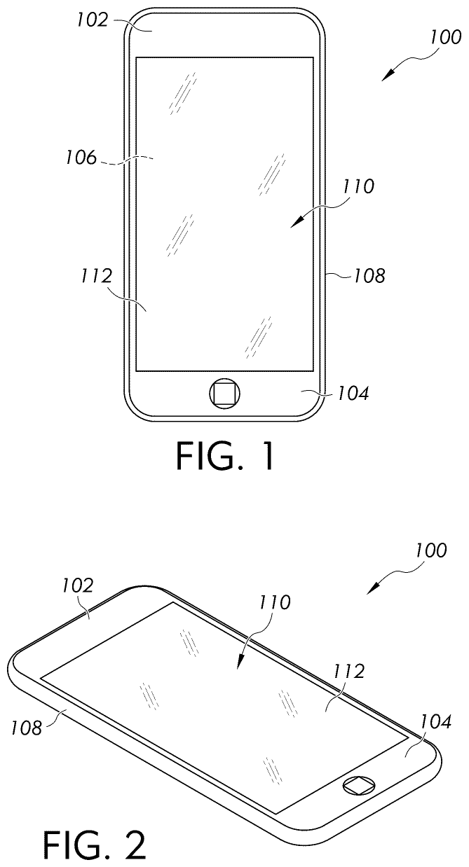

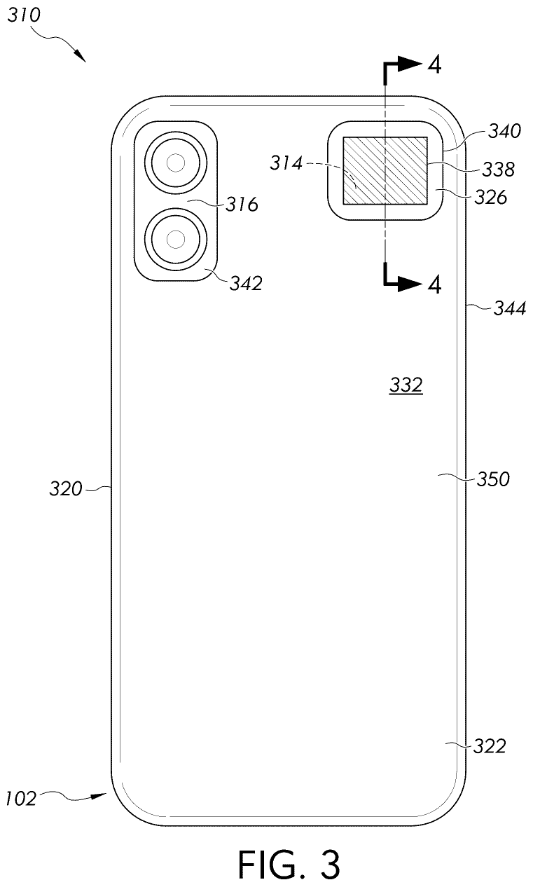

FIGS. 3-5 illustrate views of natively colored glass housings 322 or 500 including glass articles 511 that can be incorporated to consumer electronic products (e.g., display devices), for example, those shown in FIGS. 1-4. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus discussed throughout the disclosure. The consumer electronic product can comprise a portable electronic device, for example, a smartphone, a tablet, a wearable device, or a laptop.

The foldable apparatus disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 1-2. Specifically, FIGS. 1-2 show a consumer electronic device 100 including a housing 102 having front 104, back 106, and side surfaces 108. Although not shown, the consumer electronic device can comprise electrical components that are at least partially inside or entirely within the housing. For example, electrical components include at least a controller, a memory, and a display. As shown in FIGS. 1-2, the display 110 can be at or adjacent to the front surface of the housing 102. The consumer electronic device can comprise a cover substrate 112 at or over the front surface of the housing 102 such that it is over the display 110. In aspects, at least a portion of the housing 102 may include the glass article and/or the natively colored glass housing disclosed herein.

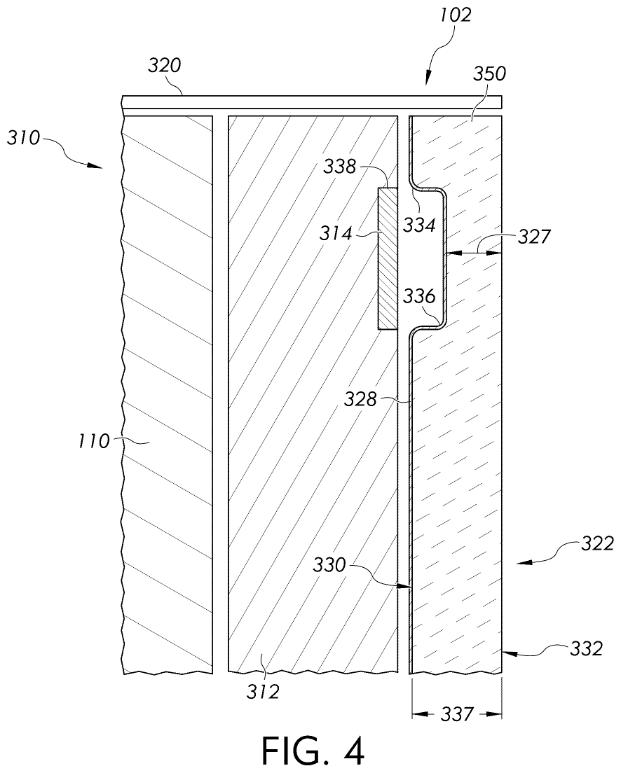

Referring to FIGS. 3-4, a communicating device 310 (i.e., electronic device with wireless signal communication capability; e.g., broadband communicating device, cellular phone, smartphone, control panel, console, dashboard, tablet, handheld computer, electronic tool) includes circuitry 312 (see FIG. 4). The consumer electronic device 100 shown in FIGS. 1-2 is an example of the communicating device 310. In aspects, the circuitry 312 includes an antenna 314. The circuitry 312 may further include other components, for example a camera 316 (FIG. 3), printed circuit board, processor, memory, display 110 (FIG. 3), battery, connector port, and other componentry.

In aspects, the antenna 314 can comprise a patterned metal wire or layer, or other such device (e.g., transceiver, receiver, transmitter, antenna array, communication module) configured to transmit and/or receive communication signals at or over a frequency range. A surface area of the antenna is defined as an area within a perimeter 338 surrounding the antenna. In further aspects, the surface area of the antenna can be 25 cm² or less, 15 cm² or less, 10 cm² or less, 100 μm² or more, 1 mm² or more, 25 mm² or more, or 100 mm² or more. In further aspects, the antenna 314 can be configured for wireless communication (e.g., transmitting, receiving, operating, and/or otherwise communicating) with transmission of signals at a frequency of 100 MHz or more, 1 GHz or more, 10 GHz or more, 24 GHz or more, 24.25 GHz or more, GHz or more, 26 GHz or more, 28 GHz or more, 100 GHz or less, 60 GHz or less, 50 GHz or less, 47 GHz or less, or 40 GHz or less. For example, the antenna may operate in a frequency range from 26 GHz to 40 GHz or from 60 GHz to 80 GHz. Communication at a frequency greater than 26 GHz may be particularly benefited from the present disclosure because such signals may be more inhibited by transmission through solid materials, and may accordingly be improved greatly by use of a housing 102 incorporating the structure 326 described herein. As such, the antenna 314 can be positioned and/or oriented such that signals are transmitted through the structure 326 (e.g., directly facing the structure 326, the structure 326 may overlay at least a portion of the antenna 314). In further aspects, a minimum distance between the antenna 314 to a portion of the glass article defining the structure 326 can be 5 mm or less, 3 mm or less, 2 mm or less, or 0.6 mm or less. Alternatively, the antenna 314 and the portion of the glass article defining the structure 326 may be in direct contact or separated only by a thickness of the coating 328.

In aspects, as shown in FIGS. 3-4, the communicating device 310 includes a housing 102 enclosing some or all of the circuitry 312. The housing 102 may include a frame 320, for example a metallic (e.g., aluminum, steel) sidewall, a natively colored glass housing 322 (e.g., back), and a display 110 (e.g., see FIGS. 1-2). The housing 102 may include alternative structures as well, for example a panel integral with frame forming a back with sidewalls within which circuitry 312 and other components may be located, and/or such as having the housing 102 integrated with a keyboard, touch panel, or other features in addition to or instead of the display.

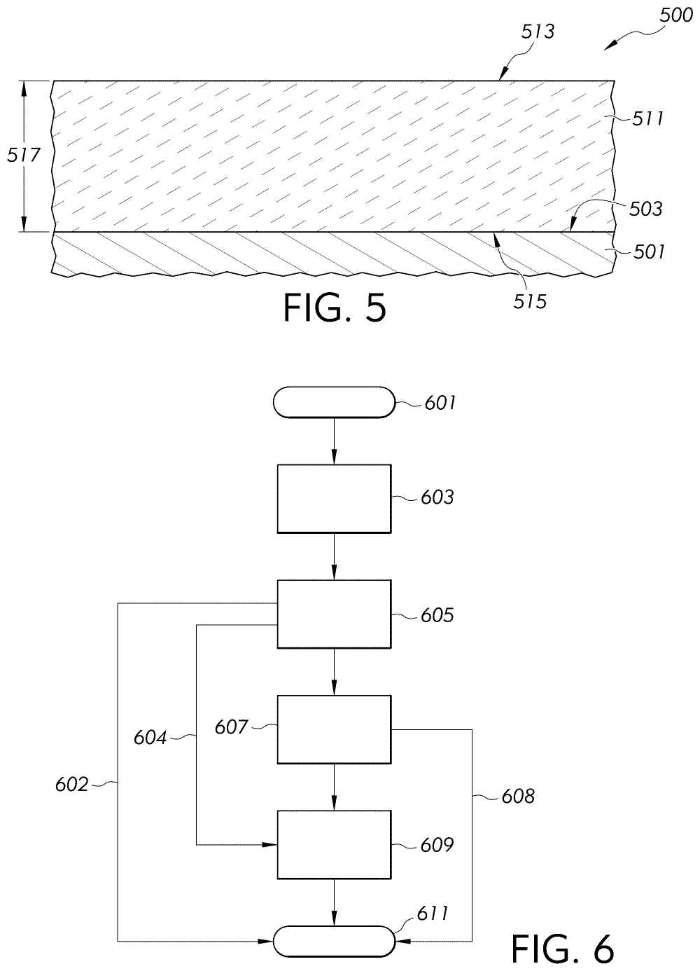

In aspects, as shown in FIGS. 3-4, the natively colored glass housing 322 may comprise (e.g., include, mostly consist of by weight or volume, be) a glass article 350. The glass article 350 may be flat, may have curved edges, may be bowed, or otherwise. As shown in FIG. 4, The natively colored glass housing 322 may include layer(s) 328, for example a scratch-resistant coating, an anti-reflective, or other coatings on a surface of the glass article 350 (e.g., first major surface 332, second major surface 330 of the glass article 350), and may further include decorative ink and/or other layers on a surface thereof as well. For example, the coating 328 on the second major surface 330 of the glass article can comprise any of the aspects and/or be the same as the reflector 501 discussed below with reference to FIG. 5. Conceivably, although not shown, the natively colored glass housing may simply consist of a sheet of glass, where layers, coatings, etc. are unneeded for the corresponding device.

In aspects, as shown in FIG. 4, the glass article 350 includes a structure 326. The structure 326 may be an integral portion of the glass article 350 such that glass of the glass article 350 continuously extends throughout the glass article 350, including defining the structure 326. For example, the structure 326 may be a recess, trench, bump, plateau, or other feature formed in or on the glass article 350. The glass article 350 may have more than one such structure 326. Such a structure may be formed in many conceivable ways, for example, by etching away a portion of the glass article 350, milling away a portion of the glass article 350, pressing the glass of the glass article 350 in a mold, welding additional glass onto the glass article 350. As such, glass forming the structure 326 may have the same composition as the glass of the glass article 350 outside of the structure 326. The glass of the structure 326 may also share a common microstructure with the glass of the glass article 350 outside of the structure 326, such as having the same types and distributions of crystals, for example if the glass is a glass-ceramic, and/or the same types and distributions of colorants. In aspects, as shown in FIG. 4, the structure 326 is formed as a recess relative to a major surface (e.g., second major surface 330) of the glass article 350. As used herein, the “major surfaces” of the glass article 350 sheet are sides of the sheet having the most surface area (e.g., front and back sides). A major surface may be surrounded by edges of a sheet that extend between the major surfaces. For a more complex body, major surfaces may be surfaces thereof have areas defined by perimeters of edges, where the major surfaces have surface areas substantially greater than other surfaces of the body (e.g., sidewalls), for example at least 50% greater.

In aspects, as shown in FIG. 4, the glass article 350 comprises a thickness 337, which is defined as an average distance between the second major surface 330 and the first major surface 332 opposite the first major surface excluding any portion of the glass article 350 including the structure 326 descried above. In further aspects, the thickness 337 can be within one or more of the ranges discussed below for the thickness 517 with reference to FIG. 5. In further aspects, the thickness 337 can be substantially uniform across the second major surface 330 and/or more than 50% of the glass article can comprise a local thickness within 10% of the thickness 337.

In aspects, as shown in FIGS. 3-4, the structure 326 comprises a perimeter 340 on a major surface (e.g., second major surface 330) of the glass article 350, where the perimeter 340 demarcates a second thickness 327 of the structure 326 that differs from the thickness 337, for example, by 50 μm or more, by 100 μm or more, by 150 μm or more, by 200 μm or more, by 300 μm or more, by 500 μm or more (e.g., located at corner 336 as shown in FIG. 4B). For example, the second thickness 327 of the structure 326 may be 600 μm or less, 500 μm or less, or 400 μm or less, while the thickness 337 of the glass article 350 may be 600 μm or more, 700 μm or more, 800 μm or more (or any of the ranges described herein for the thickness 517). Alternatively, although not shown, the second thickness 327 may be greater than the thickness 337 by 50 μm or more, by 100 μm or more, by 150 μm or more, by 200 μm or more, by 300 μm or more, by 500 μm or more. As shown in FIGS. 3-4, the perimeter 340 forms a closed loop on the major surface (e.g., second major surface 330), where a shape of the perimeter 340 may be rectilinear, curved, or curvilinear and can comprise any shape (e.g., square, blocky, ziggurat-shaped with rectangular rows of diminishing length overlaying one another, triangular, oval, or even more complex geometries). For example, the perimeter 340 of the structure 326 may be shaped as a silhouette of a logo and/or registered trademark or other recognizable design or shape. As used herein, a surface area of the structure is defined as the surface area within the perimeter of the structure projected onto the first major surface of the glass article. In aspects, a surface area of the structure 326 may be 100 cm² or less, 50 cm² or less, 25 cm² or less, 25 μm² or more, 100 μm² or more, 1 mm² or more, 25 mm² or more, or 4 cm² or more. In aspects, the glass article can comprise a housing of a communicating device and the glass article may have more than one such structure, as shown in FIG. 3, where the structure 326 overlays the antenna 314 while another structure 342 forms a portion of a camera or sensor encasement (e.g., camera 316). In further aspects, the structure 326 and/or 342 can overlay at least a portion and/or all of the surface area corresponding to the antenna 314 and/or the camera 316.

Forming the structure 326 and/or 342 in a middle or interior portion of the glass article 350, spaced inward from outside edges 344 of the glass article 350 (see, FIG. 3) may help mitigate structural weaknesses or stress concentrations of the glass article 350 that may be associated forming the structure 326 and/or 342. Forming edges or corners 334 and/or 336 or the perimeter 340 of the structure 326 with a geometry that reduces concentration of stress at the edges or corners 334 and/or 336 may also help strengthen the glass article 350 when forming the structure 326. Such a geometry may include rounding or dulling vertices or corners 334 and/or 336 of the structure 326, as may be done through etching or localized melting/heating (e.g., with a laser). For example, the glass article 350 may smoothly transition between the thickness 337 and the second thickness 327 at corner 334 and/or 336 over a distance from 5 μm to 700 μm, from 10 μm to 500 μm, from 20 μm to 500 μm, from 100 μm to 500 μm, or any range or subrange therebetween, as measured in a direction perpendicular to a direction of the thickness 337.

Throughout the disclosure, CIE color coordinates are with reference to the CIELAB 1976 color space established by the International Commission on Illumination (CIE). Unless otherwise indicated, CIE color coordinates are measured in transmission through the glass article using an F02 illuminant and an observer angle of 10°. The CIELAB 1976 color space expresses color as three values: L* for the lightness from black (0) to white (100), a* from green (−) to red (+), and b* from blue (−) to yellow (+). Unless otherwise indicated, the CIE color coordinates are measured for a natively colored glass-based article having a thickness of 0.8 mm.

FIG. 5 illustrates a natively colored glass housing 500 comprising the glass article 511 and the reflector 501. In aspects, the reflector 501 comprises an opaque material. As used herein, opaque means than an average transmittance in the wavelength range of 400 nm to 700 nm through a 1.0 mm thick piece of a material is 10% or less. The average transmittance in the wavelength range of 400 nm to 700 nm is calculated by measuring the transmittance of whole number wavelengths from 400 nm to 700 nm and averaging the measurements. In aspects, the reflector comprises a CIE L* value of 70 or more. An exemplary material for the reflector is aluminum. In aspects, as shown in FIG. 5, the glass article 511 can be disposed on and/or contact a surface 503 of the reflector 501 can contact the glass article 511. Providing the reflector can increase a perceived brightness of the glass article.

Unless otherwise indicated, transmittance data (total transmittance and diffuse transmittance) in the visible spectrum is measured with a Lambda 950 UV/Vis/NIR Spectrophotometer manufactured by PerkinElmer Inc. (Waltham, Massachusetts USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. The term “average transmittance,” as used herein with respect to the visible spectrum, refers to the average of transmittance measurements made within a given wavelength range with each whole numbered wavelength weighted equally. Unless otherwise indicated, as described herein, the “average transmittance” with respect to the visible spectrum is reported over the wavelength range from 380 nm to 750 nm (inclusive of endpoints). Unless otherwise specified, the average transmittance is indicated for article thicknesses from 0.4 mm to 5 mm, inclusive of endpoints. Unless otherwise specified, when average transmittance is indicated, this means that each thickness within the range of thicknesses from 0.4 mm to 5 mm has an average transmittance as specified. For example, colored glass articles having average transmittances of 10% to 92% over the wavelength range from 380 nm to 750 nm means that each thickness within the range of 0.4 mm to 5 mm (e.g., 0.6 mm, 0.9 mm, 2 mm, etc.) has an average transmittance in the range of 10% to 92% for the wavelength range from 380 nm to 750 nm.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIG. 5, the glass article 511 comprises a first major surface 513 and a second major surface 515 opposite the first major surface 513. In aspects, as shown, the first major surface 513 and/or the second major surface 515 can comprise planar surfaces, although other shapes and designs are possible in other aspects. A thickness 517 of the glass article 511 is defined as an average distance between the first major surface 513 and the second major surface 515. In aspects, the thickness 517 can be 30 micrometers (μm) or more, 50 μm or more, 80 μm or more, 100 μm or more, 150 μm or more, 200 μm or more, 400 μm or more, 500 μm or more, 600 μm or more, 5 millimeters (mm) or less, 3 mm or less, 2 mm or less, 1 mm or less, 800 μm or less, 700 μm or less, 600 μm or less, 550 μm or less, 500 μm or less, or 300 μm or less. In aspects, the thickness 517 can be in a range from 30 μm to 5 mm, from 50 μm to 5 mm, from 80 μm to 5 mm, from 100 μm to 5 mm, from 200 μm to 5 mm, from 400 μm to 3 mm, from 500 μm to 2 mm, from 600 μm to 1 mm, or any range or subrange therebetween.

The glass article 511 and/or 350 comprises a glass-based material. In aspects, the glass-based material can comprise a pencil hardness of 8H or more, for example, 9H or more. As used herein, pencil hardness is measured using ASTM D 3363-20 with standard lead graded pencils. Throughout the disclosure, an elastic modulus (e.g., Young's modulus) and/or a Poisson's ratio is measured using ISO 527-1:2019. In aspects, the glass article 511 and/or 350 can comprise an elastic modulus in a range from 40 GPa to 140 GPa, from 50 GPa to 100 GPa, from 60 GPa to 80 GPa, or any range or subrange therebetween.

Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects.

In the natively colored glass-based compositions described herein, SiO₂ is the largest constituent and, as such, SiO₂ is the primary constituent of the glass network formed from the natively colored glass-based compositions. Pure SiO₂ has a relatively low CTE. However, pure SiO₂ has a high melting point. Accordingly, if the concentration of SiO₂ in the natively colored glass-based compositions is too high, the formability of the natively colored glass-based compositions may be diminished as higher concentrations of SiO₂ increase the difficulty of melting the glass, which, in turn, adversely impacts the formability of the composition. If the concentration of SiO₂ in the natively colored glass-based compositions is too low the chemical durability of the resulting material may be diminished, and the resulting material may be susceptible to surface damage during post-forming treatments. In aspects, the composition comprises SiO₂ in an amount of 55 mol % or more, 58 mol % or more, 59 mol % or more, 60 mol % or more, 61 mol % or more, 62 mol % or more, 63 mol % or more, 64 mol % or more, 65 mol % or more, 67 mol % or more, 70 mol % or more, 80 mol % or less, 77 mol % or less, 75 mol % or less, 73 mol % or less, 70 mol % or less, 69 mol % or less, 68 mol % or less, 67 mol % or less, 66 mol % or less, 65 mol % or less, 64 mol % or less, 63 mol % or less, 62 mol % or less, 61 mol % or less, 60 mol % or less, or 59 mol % or less. In aspects, the composition can comprise SiO₂ in a range from greater than or equal to 55 mol % to less than or equal to 80 mol %, from greater than or equal to 58 mol % to less than or equal to 77 mol %, from greater than or equal to 60 mol % to less than or equal to 75 mol %, from greater than or equal to 61 mol % to less than or equal to 73 mol %, from greater than or equal to 62 mol % to less than or equal to 70 mol %, from greater than or equal to 63 mol % to less than or equal to 69 mol %, from greater than or equal to 64 mol % to less than or equal to 68 mol %, from greater than or equal to 65 mol % to than or equal to 67 mol %, or any range or subrange therebetween. In preferred aspects, the composition comprises SiO₂ in an amount from greater than or equal to 55 mol % to less than or equal to 80 mol %, from greater than or equal to 60 mol % to less than or equal to 75 mol %, or from greater than or equal to 62 mol % to less than or equal to 70 mol %.

The natively colored glass-based compositions can include Al₂O₃. Al₂O₃ may serve as a glass network former, similar to SiO₂. Al₂O₃ may increase the viscosity of the glass-based composition due to its tetrahedral coordination in a glass melt formed from a glass-based composition, decreasing the formability of the glass-based composition when the amount of Al₂O₃ is too high. However, when the concentration of Al₂O₃ is balanced against the concentration of SiO₂ and the concentration of alkali oxides in the glass-based composition, Al₂O₃ can reduce the liquidus temperature of the glass melt, thereby enhancing the liquidus viscosity and improving the compatibility of the glass-based composition with certain forming processes. In aspects, the composition comprises Al₂O₃ in a concentration of 1.0 mol % or more, 2.0 mol % or more, 2.5 mol % or more, 3.0 mol % or more, 3.5 mol % or more, 4.0 mol % or more, 5.0 mol % or more, 6.0 mol % or more, 8.0 mol % or less, 7.0 mol % or less, 6.0 mol % or less, 5.0 mol % or less, 4.0 mol % or less, or 3.0 mol % or less. In aspects, the composition can comprise an amount of Al₂O₃ in a range from greater than or equal to 1.0 mol % to less than or equal to 8.0 mol %, from greater than or equal to 2.0 mol % to less than or equal to 7.0 mol %, from greater than or equal to 2.5 mol % to less than or equal to 6.0 mol %, from greater than or equal to 3.0 mol % to less than or equal to 5.0 mol %, from greater than or equal to 3.5 mol % to less than or equal to 4.0 mol %, or any range or subrange therebetween. In preferred aspects, the composition comprises Al₂O₃ in an amount from greater than or equal to 1.0 mol % to less than or equal to 8.0 mol %, from greater than or equal to 2.5 mol % to less than or equal to 6.0 mol %, or from greater from greater than or equal to 3.0 mol % to less than or equal to 5.0 mol %.

The glass-based compositions described herein can include P₂O₅. The inclusion of P₂O₅ increases the diffusivity of ions in the glass-based, increasing the speed of the ion exchange process. If too much P₂O₅ is included in the composition the amount of compressive stress imparted in an ion exchange process may be reduced and volatility at free surfaces during manufacturing may increase to undesirable levels. In aspects, the composition comprises P₂O₅ in an amount of 0.5 mol % or more, 0.7 mol % or more, 1.0 mol % or more, 1.2 mol % or more, 1.5 mol % or more, 2.0 mol % or more, 2.5 mol % or more, 3.0 mol % or more, 4.0 mol % or more, 8.0 mol % or less, 7.0 mol % or less, 6.0 mol % or less, 5.0 mol % or less, 4.0 mol % or less, 3.0 mol % or less, 2.0 mol % or less, or 1.5 mol % or less. In aspects, composition comprises an amount of P₂O₅ in a range from greater than or equal to 0.5 mol % to less than or equal to 8 mol %, from greater than or equal to 0.7 mol % to less than or equal to 7.0 mol %, from greater than or equal to 1.0 mol % to less than or equal to 6.0 mol %, from greater than or equal to 1.2 mol % to less than or equal to 5.0 mol %, from greater than or equal to 1.5 mol % to less than or equal to 4.0 mol %, from greater than or equal to 2.0 mol % to less than or equal to 3.0 mol %, from greater than or equal to 2.5 mol % to less than or equal to 3.0 mol %, or any range or subrange therebetween. Alternatively, in aspects, the glass-based composition is free of P₂O₅. In preferred aspects, the composition comprises P₂O₅ in an amount from greater than or equal to 0.5 mol % to less than or equal to 8.0 mol %, from greater than or equal to 1.0 mol % to less than or equal to 7.0 mol %, or from greater than or equal to 2.5 mol % to less than or equal to 6.0 mol %.

The glass-based compositions described herein can include B₂O₃. The inclusion of B₂O₃ increases the fracture toughness of the glass-based material. In particular, the glass-based compositions include boron in the trigonal configuration which increases the Knoop scratch threshold and fracture toughness of the glass-based article. If too much B₂O₃ is included in the composition the amount of compressive stress imparted in an ion exchange process may be reduced and volatility at free surfaces during manufacturing may increase to undesirable levels. In aspects, the composition can comprise B₂O₃ in an amount of 0.5 mol % or more, 1 mol % or more, 1.5 mol % or more, 2 mol % or more, 2.5 mol % or more, 3 mol % or more, 5 mol % or less, 4.5 mol % or less, 4 mol % or less, 3.8 mol % or less, 3.6 mol % or less, or 3.5 mol % or less. In aspects, the composition can comprise an amount of B₂O₃ in a range from greater than or equal to 0.5 mol % to less than or equal to 5 mol %, from greater than or equal to 0.5 mol % to less than or equal to 4 mol %, from greater than or equal to 0.5 mol % to less than or equal to 3.6 mol %, from greater than or equal to 1 mol % to less than or equal to 3.6 mol %, from greater than or equal to 2 mol % to less than or equal to 3.6 mol %, from greater than or equal to 2.5 mol % to less than or equal to 3.5 mol %, from greater than or equal to 3 mol % to less than or equal to 3.5 mol %, or any range or subrange therebetween. Alternatively, in aspects, the glass-based composition is free of B₂O₃.

The glass-based compositions include Li₂O. The inclusion of Li₂O in the glass-based composition allows for better control of an ion exchange process and further reduces the softening point of the composition, thereby increasing the manufacturability of the composition. The presence of Li₂O in the glass-based compositions also allows the formation of a stress profile with a parabolic shape. The Li₂O in the glass-based compositions can enable the high fracture toughness values described herein. In aspects, the composition comprises Li₂O in an amount from 0.2 mol % or more, 1.0 mol % or more, 2.0 mol % or more, 5.0 mol % or more, 8.0 mol % or more, 10.0 mol % or more, 11.0 mol % more, 12.0 mol % or more, 13.0 mol % or more, 14.0 mol % or more, 15.0 mol % or more, 17.0 mol % or more, 20.0 mol % or more, 22.0 mol % or more, 25.0 mol % or more, 30.0 mol % or less, 27.0 mol % or less, 25.0 mol % or less, 22.0 mol % or less, 20.0 mol % or less, 19.0 mol % or less, 18.0 mol % or less, or 17.0 mol % or less, 15.0 mol % or less, 14.0 mol % or less, 13.0 mol % or less, 12.0 mol % or less, 11.0 mol % or less, 10.0 mol % or less, or 5.0 mol % or less. In aspects, the composition comprises an amount of Li₂O in a range from greater from greater than or equal to 0.2 mol % to less than or equal to 30.0 mol %, from greater than or equal to 1.0 mol % to less than or equal to 27.0 mol %, from greater than or equal to 2.0 mol % to less than or equal to 25.0 mol %, from greater than or equal to 5.0 mol % to less than or equal to 22.0 mol %, from greater than or equal to 8.0 mol % to less than or equal to 20.0 mol %, from greater than or equal to 10.0 mol % to less than or equal to 19.0 mol %, from greater than or equal to 11.0 mol % to less than or equal to 18.0 mol %, from greater than or equal to 12.0 mol % to less than or equal to 17.0 mol %, from greater than or equal to 13.0 mol % to less than or equal to 16.0 mol %, from greater than or equal to 14.0 mol % to less than or equal to 15.0 mol %, or any range or subrange therebetween. In preferred aspects, the composition comprises Li₂O in an amount from greater than or equal to 0.2 mol % to less than or equal to 30.0 mol %, from greater than or equal to 10.0 mol % to less than or equal to 20.0 mol %, or from than or equal to 11.0 mol % to less than or equal to 15.0 mol %.

The glass-based compositions described herein can include Na₂O and/or K₂O. Na₂O and/or K₂O may aid in the ion-exchangeability of the glass-based composition, and improve the formability, and thereby manufacturability, of the glass-based composition. However, if too much Na₂O is added to the glass-based composition, the CTE may be too low, and the melting point may be too high. Additionally, if too much Na₂O is included in the composition relative to the amount of Li₂O the ability of the glass-based substrate to achieve a deep depth of compression when ion exchanged may be reduced. The glass-based compositions may include K₂O. The inclusion of K₂O in the glass-based composition increases the potassium diffusivity in the glass-based material, enabling a deeper depth of a compressive stress spike (DOL_{SP}) to be achieved in a shorter amount of ion exchange time. If too much K₂O is included in the composition the amount of compressive stress imparted during an ion-exchange process may be reduced. In aspects, the composition comprises Na₂O in an amount of 0.01 mol % or more, 0.02 mol % or more, 0.03 mol % or more, 0.04 mol % or more, 0.05 mol % or more, 0.07 mol % or more, 0.10 mol % or more, 0.2 mol % or more, 0.5 mol % or more, 0.7 mol % or more, 1.0 mol % or more, 2.0 mol % or more, 5.0 mol % or more, 3.0 mol % or less, 2.0 mol % or less, 1.0 mol % or less, 0.5 mol % or less, 0.2 mol % or less, 0.10 mol % or more, 0.07 mol % or less, 0.05 mol % or less, 0.04 mol % or less, 0.03 mol % or less, or 0.02 mol % or less. In aspects, the composition comprises an amount of Na₂O in a range from greater than or equal to 0.01 mol % to less than or equal to 5.0 mol %, from greater than or equal to 0.02 mol % to less than or equal to 3.0 mol %, from greater than or equal to 0.03 mol % to less than or equal to 2.0 mol %, from greater than or equal to 0.04 mol % to less than or equal to 1.0 mol %, from greater than or equal to 0.05 mol % to less than or equal to 0.5 mol %, from greater than or equal to 0.10 mol % to less than or equal to 0.20 mol %, or any range or subrange therebetween. In aspects, the composition can comprise an amount of Na₂O less than or equal to 0.5 mol %, for example, in a range from greater than or equal to 0.01 mol % to less than or equal to 0.5 mol %, from greater than 0.01 mol % to less than or equal to 0.2 mol %, from greater than or equal to 0.02 mol % to less than or equal to 0.10 mol %, from greater than or equal to 0.02 mol % to less than or equal to 0.02 mol % to less than or equal to 0.07 mol %, from greater than or equal to 0.03 mol % to less than or equal to 0.05 mol %, from greater than or equal to 0.03 mol % to less than or equal to 0.04 mol %, or any range or subrange therebetween. In preferred aspects, the composition comprises Na₂O in an amount from greater than or equal to 0.01 mol % to less than or equal to 3.0 mol % Na₂O, greater than or equal to 0.02 mol % to less than or equal to 0.5 mol %, or from greater than or equal to 0.03 mol % to less than or equal to 0.10 mol %. In aspects, the composition can comprise K₂O in an amount within one or more of the ranges discussed above in this paragraph for Na₂O.

R₂O, as used herein, is a total amount of alkali metal oxides, namely, the sum (in mol %) of Li₂O, Na₂O, and K₂O present in the glass-based article (i.e., R₂O=Li₂O (mol %)+Na₂O (mol %)+K₂O (mol %). Alkali metal oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali metal oxides (e.g., two or more alkali metal oxides) in the glass composition, a phenomenon referred to as the “mixed alkali effect.” However, it has been found that if the amount of alkali oxide is too high, the average coefficient of thermal expansion can be undesirably increased. In aspects, the concentration of R₂O in the glass-based article can be 10.0 mol % or more, 11.0 mol % or more, 12.0 mol % or more, 13.0 mol % or more, 14.0 mol % or more, 15.0 mol % or more, 16.0 mol % or more, 17.0 mol % or more, 18.0 mol % or more, 30.0 mol % or less, 25.0 mol % or less, 20.0 mol % or less, 18.0 mol % or less, 16.0 mol % or less, 15.0 mol % or less, or 14.0 mol % or less. In aspects, the concentration of R₂O in the glass-based article can be from greater than or equal to 10.0 mol % to less than or equal to 30.0 mol %, from greater than or equal to 11.0 mol % to less than or equal to 25.0 mol %, from greater than or equal to 12.0 mol % to less than or equal to 20.0 mol %, from greater than or equal to 13.0 mol % to less than 17.0 mol %, from greater than or equal to 14.0 mol % to less than or equal to 16.0 mol %, from greater than or equal to 14.0 mol % to less than or equal to 15.0 mol %, or any range or subrange therebetween. In preferred aspects, a total amount of R₂O in the glass-based article can be from greater than or equal to 10.0 mol % to less than or equal to 30.0 mol %, from greater than or equal to 13.0 mol % to less than or equal to 20.0 mol %, or from greater than or equal to 14.0 mol % to less than or equal to 17.0 mol %.

The glass-based compositions described herein may be described in terms of a molar ratio of non-lithium alkali metal oxides (e.g., Na₂O+K₂O) to a total amount of alkali metal oxides (i.e., R₂O). Until the work of the present inventors, it is believed that the impact of various alkali metal oxides on heat transfer (e.g., radiative), especially for colored glass-based melts, had not been investigated or understood. As discussed herein, the inventors have unexpectedly determined that the addition of low amounts of other alkali metal oxides (e.g., sodium oxide, potassium oxide), for example in predetermined ratios, can improve the heat transfer properties of the corresponding glass melt. For example, adding relatively small amounts of larger alkali metal oxides (e.g., Na₂O+K₂O) can increase radiative thermal transfer (e.g., of colored glass-based melts) without significantly impacting resistivity, ion-exchangeability, and/or associated crystal phases (e.g., in the case of glass-ceramics). Moreover, it is believed that it was not possible to reliably quantify radiative heat transfer coefficients at (or near) temperatures of glass melts; consequently, the relationship between non-lithium alkali metal oxides and radiative heat transfer coefficient could not have been appreciated, especially for low amounts of non-lithium alkali metal oxides relative to a total amount of alkali metal oxides. In aspects, a molar ratio of non-lithium alkali metal oxides to a total amount of alkali metal oxides (e.g., (Na₂O+K₂O)/R₂O), can be 0.0015 or more, 0.0020 or more, 0.0025 or more, 0.0030 or more, 0.0040 or more, 0.0050 or more, 0.006 or more, 0.007 or more, 0.010 or more, 0.020 or more, 0.030 or more, 0.050 or more, 0.10 or less, 0.08 or less, 0.05 or less, 0.020 or less, 0.010 or less, 0.008 or less, 0.006 or less, 0.005 or less, 0.004 or less, 0.0030 or less, or 0.0025 or less. In aspects, a molar ratio of non-lithium alkali metal oxides to a total amount of alkali metal oxides (e.g., (Na₂O+K₂O)/R₂O) can be from greater than or equal to 0.0015 to less than or equal to 0.10, from greater than or equal to 0.0020 to less than or equal to 0.08, from greater than or equal to 0.0025 to less than or equal to 0.05, from greater than or equal to 0.0030 to less than or equal to 0.020, from greater than or equal to 0.0040 to less than or equal to 0.010, from greater than or equal to 0.0050 to less than or equal to 0.008, from greater than or equal to 0.0050 to less than or equal to 0.006, or any range or subrange therebetween. In preferred aspects, a molar ratio of non-lithium alkali metal oxides to a total amount of alkali metal oxides (e.g., (Na₂O+K₂O)/R₂O) can be from greater than or equal to 0.0015 to less than or equal to 0.10, from greater than or equal to 0.0020 to less than or equal to 0.01, or from greater than or equal to 0.0030 to less than or equal to 0.006. The unexpected benefits associated with these ratios are demonstrated by the examples discussed herein.

Throughout the disclosure, “RO” refers to a total amount of alkaline earth metal oxides and divalent transition metal oxides. “RO” can refer to a total amount of MgO, CaO, SrO, BaO, and ZnO. In aspects, divalent cation oxides (e.g., alkaline earth oxides) can improve the melting behavior of glass-based compositions. In aspects, divalent cation oxides can improve stress relaxation. In aspects, alkaline earth oxides can charge balance tetrahedral alumina. Providing RO can increase a volume resistivity of the resulting glass-based substrate and/or glass-based article, for example, because of the relatively high field strength of alkaline earth metal ions and/or decreasing a mobility of alkali metal ions. In aspects, the composition can comprise RO in an amount of 0.0 mol % or more, 0.1 mol % or more, 0.2 mol % or more, 0.5 mol % or more, 1.0 mol % or more, 1.5 mol % or more, 2.0 mol % or more, 3.0 mol % or more, 5.0 mol % or less, 4.0 mol % or less, 3.0 mol % or less, 2.0 mol % or less, 1.0 mol % or less, 0.5 mol % or less, or 0.2 mol % or less. In aspects, the composition can comprise an amount of RO in a range from greater than or equal to 0.0 mol % to less than or equal to 5.0 mol %, from greater than or equal to 0.1 mol % to less than or equal to 4.0 mol %, from greater than or equal to 0.2 mol % to less than or equal to 3.0 mol %, from greater than or equal to 0.5 mol % to less than or equal to 2.0 mol %, from greater than or equal to 0.5 mol % to less than or equal to 1.0 mol %, or any range or subrange therebetween. In preferred aspects, the composition comprises RO in an amount from greater than or equal to 0.0 mol % to less than or equal to 5.0 mol % or from 0.5 mol % to 2.0 mol %. In aspects, the glass-based composition can be free of RO.

The glass-based compositions described herein may optionally include MgO and/or CaO. MgO and/or CaO may lower the viscosity of a glass, which enhances the formability and manufacturability of the composition. The inclusion of MgO and/or CaO in a glass-based composition may also improve the strain point and the Young's modulus of the glass-based composition. However, if too much MgO is added to the glass-based composition, the liquidus viscosity may be too low for compatibility with desirable forming techniques. The addition of too much MgO and/or CaO may also increase the density and the CTE of the glass-based composition to undesirable levels. The addition of too much CaO may undesirably impede the ion exchangeability of the glass-based substrate. The inclusion of CaO in the glass-based composition also helps to achieve the high fracture toughness values described herein. The inclusion of MgO and/or CaO in the glass-based composition can also help to achieve high fracture toughness in some aspects. In aspects, the composition can comprise MgO within one or more of the ranges discussed above for RO. In aspects, the composition can comprise CaO within one or more of the ranges discussed above for RO. In aspects, the composition can comprise ZnO within one or more of the ranges discussed above for RO. In aspects, the glass-based composition can be free of one or more of MgO, CaO, SrO, ZnO, and/or BaO.

In aspects, the glass-based composition can optionally include ZrO₂. The addition of ZrO₂ can improve the stability of the corresponding glass melt, for example, by significantly reducing devitrification during forming and/or decreasing the liquidus temperature. At relative high amounts, ZrO₂ can form a primary liquidus phase that can significantly reduce the liquidus viscosity. Also, the addition of ZrO₂ can reduce a grain size of petalite (in glass-ceramic articles). Also, the addition of ZrO₂ can increase the fracture toughness of the resulting glass-based article. In aspects, an amount of ZrO₂ in the glass-based composition can be 0.2 mol % or more, 0.5 mol % or more, 1.0 mol % or more, 3.0 mol % or more, 4.0 mol % or more, 5.0 mol % or more, 6.0 mol % or more, 7.0 mol % or more, 8.0 mol % or more, 10.0 mol % or less, 9.0 mol % or less, 8.0 mol % or less, 7.5 mol % or less, 7.0 mol % or less, 6.0 mol % or less, 5.0 mol % or less, or 4.0 mol % or less. In aspects, an amount of ZrO₂ in the glass-based composition can be in a range from greater than or equal to 0.2 mol % to less than or equal to 10.0 mol %, from greater than or equal to 0.5 mol % to less than or equal to 9.0 mol %, from greater than or equal to 1.0 mol % to less than or equal to 8.0 mol %, from greater than or equal to 3.0 mol % to less than or equal to 7.5 mol %, from greater than or equal to 4.0 mol % to less than or equal to 7.0 mol %, from greater than or equal to 5.0 mol % to less than or equal to 6.0 mol %, or any range or subrange therebetween. Alternatively, the glass-based composition may be free of ZrO₂, for example, due to cost and supply constraints as well as the previously described devitrification issues. In preferred aspects, an amount of ZrO₂ in the glass-based composition can be in a range from greater than or equal to 0.2 mol % to less than or equal to 10.0 mol %, from greater than or equal to 3.0 mol % to less than or equal to 9.0 mol %, or from greater than or equal to 4.0 mol % to less than or equal to 8.0 mol %.

The glass-based composition can also comprise additional components, including fining agents and/or colorants. While these components can be present in amounts up to 5 mol %, individual components in these categories are often present at sub mol % (e.g., less than 1.0 mol %) amounts. Consequently, unless otherwise indicated, amounts of these components (e.g., fining agents, colorants) will be specified by superaddition to a base composition (e.g., SiO₂, Al₂O₃, RO, R₂O, ZrO₂, and/or P₂O₅). As used herein, superaddition refers to an amount of a component added based on 100 mol % of a base composition, where a person having ordinary skill in the art understands how to renormalize such compositions to obtain 100 mol % of the entire composition, if desired.

The glass-based compositions may optionally include one or more fining agents. In aspects, the fining agent may include, for example, SnO₂. In aspects, SnO₂ may be present in the glass-based composition (e.g., by superaddition and/or based on 100 mol % of the entire composition) in an amount less than or equal to 0.2 mol %, such as from greater than or equal to 0 mol % to less than or equal to 0.2 mol %, greater than or equal to 0 mol % to less than or equal to 0.1 mol %, greater than or equal to 0 mol % to less than or equal to 0.05 mol %, greater than or equal to 0.1 mol % to less than or equal to 0.2 mol %, and all ranges and subranges between the foregoing values. In aspects, the glass-based composition may be free of SnO₂. In aspects, the glass-based composition may be free of one or both of arsenic and antimony. In preferred aspects, the composition comprises SnO₂ (e.g., by superaddition and/or based on 100 mol % of the entire composition) in an amount from greater than or equal to 0 mol % to less than or equal to 0.2 mol % or from greater than or equal to 0 mol % to less than or equal to 0.1 mol %.

The glass-based compositions described herein can optionally include TiO₂. The inclusion of too much TiO₂ in the glass-based composition may result in the composition being susceptible to devitrification and/or exhibiting an undesirable coloration as well as undesirably changing the liquidus. The inclusion of TiO₂ in the glass-based composition prevents the undesirable discoloration of the glass-based material if exposed to intense ultraviolet light, such as during post-processing treatments. In aspects, the composition can comprise TiO₂ (e.g., by superaddition and/or based on 100 mol % of the entire composition) in an amount of 0 mol % or more, 0.1 mol % or more, 0.15 mol % or more, 1 mol % or less, 0.5 mol % or less, or 0.3 mol % or less. In aspects, the composition (e.g., by superaddition and/or based on 100 mol % of the entire composition) can comprise an amount of TiO₂ in a range from greater than or equal to 0 mol % to less than or equal to 1 mol %, from greater than or equal to 0.1 mol % to less than or equal to 0.5 mol %, from greater than or equal to 0.15 mol % to less than or equal to 0.3 mol %, or any range or subrange therebetween. Alternatively, in aspects, the glass-based composition can be free of TiO₂. In preferred aspects, the composition comprises TiO₂ (e.g., by superaddition and/or based on 100 mol % of the entire composition) in an amount from greater than or equal to 0 mol % to less than or equal to 1 mol % or from greater than or equal to 0.1 mol % to less than or equal to 0.5 mol %.

The natively colored glass-based articles includes one or more colorants. In aspects, the colorant silver, gold, copper, nickel (e.g., NiO), chromium (e.g., Cr₂O₃), cobalt (e.g., Co₃O₄), manganese (e.g., MnO₂ and/or other oxidation states). It is to be understood that the natively colored glass-based articles can additionally or alternatively can comprise iron (e.g., Fe₂O₃), titanium dioxide (TiO₂), cerium oxide (e.g., CeO₂), a vanadium oxide (e.g., V₂O₅), or similar compounds that can influence and/or impart color to the colored glass-based article. In aspects, an amount of the one or more colorants can be 0.1 mol % or more, 0.2 mol % or more, 0.3 mol % or more, 0.5 mol % or more, 0.7 mol % or more, 1.0 mol % or more, 1.2 mol % or more, 1.5 mol % or more, 2.0 mol % or more, 5.0 mol % or less, 3.0 mol % or less, 2.5 mol % or less, 2.0 mol % or less, 1.5 mol % or less, 1.0 mol % or less, 0.8 mol % or less, 0.6 mol % or less, 0.5 mol % or less, 0.4 mol % or less, 0.3 mol % or less, or 0.2 mol % or less. In aspects, an amount of the one or more colorants can be from greater than or equal to 0.1 mol % to less than or equal to 5.0 mol %, from greater than or equal to 0.2 mol % to less than or equal to 3.0 mol %, from greater than or equal to 0.3 mol % to less than or equal to 2.5 mol %, from greater than or equal to 0.5 mol % to less than or equal to 2.0 mol %, from greater than or equal to 0.7 mol % to less than or equal to 1.5 mol %, from greater than or equal to 1.0 mol % to less than or equal to 1.2 mol %, or any range or subrange therebetween. Alternatively or additionally, in aspects, the amount of the one or more colorants can be 0.0005 mol % or more, 0.001 mol % or more, 0.01 mol % or more, 0.02 mol % or more, 0.05 mol % or more, or 0.1 mol % or more, for example, from greater than or equal to 0.0005 mol % to less than or equal to 5.0 mol %, from greater than or equal to 0.001 mol % to less than or equal to 5.0 mol %, from greater than or equal to 0.01 mol % to less than or equal to 5.0 mol %, from greater than or equal to 0.02 mol % to less than or equal to 5.0 mol %, from greater than or equal to 0.05 mol % to less than or equal to 5.0 mol %, or from greater than or equal to 0.01 mol % to less than or equal to 5.0 mol %. In further aspects, the amount of the one or more colorants can be 1.0 mol % or less, for example, from greater than or equal to 0.0005 mol % to less than or equal to 1.0 mol %, from greater than or equal to 0.001 mol to less than or equal to 0.3 mol %, from greater than or equal to 0.01 mol % to less than or equal to 0.2 mol %, from greater than or equal to 0.02 mol % to less than or equal to 0.1 mol %, from greater than or equal to 0.05 mol % to less than or equal to 0.08 mol %, or any range or subrange therebetween.

When the natively colored glass-based composition includes gold (Au) and/or silver (Ag), lower processing temperatures (e.g., melting temperature, fining temperature maximum temperature—including due to spatial inhomogeneity) can improve the retention of these colorants. Also, the addition (or increase) in Li₂O and/or alkali metal oxides (more generally) can improve the retention of these colorants, for example, by decreasing the melting temperature of the glass-based composition. Without wishing to be bound by theory, in aspects where the colorant package includes Au and/or Ag, it is believed that additions of SnO₂ may also aid in the reduction of Au and/or Au in the glass, leading to the formation of gold particles and/or silver particles. In aspects that include SnO₂ and/or Sb₂O₃, the SnO₂ and/or Sb₂O₃ may also function as a fining agent. Without wishing to be bound by theory, it is believed that additions of SnO₂ may also aid in the reduction of Au in the glass, leading to the formation of gold particles. Additionally, reducing the use of carbonate-containing raw materials can improve the retention of these colorants. In aspects, an amount of gold and/or silver in the glass-based composition (e.g., by superaddition) can be 1 part-per-million (ppm) or more, 5 ppm or more, 10 ppm or more, 15 ppm or more, 30 ppm or more, 50 ppm or more, 100 ppm or more, 200 ppm or less, 10,000 ppm or less, 2,000 ppm or less, 1,000 ppm or less, 500 ppm or less, 200 ppm or less, 100 ppm or less, 50 ppm or less, or 20 ppm or less. In aspects, an amount of gold and/or silver in the glass-based composition (e.g., by superaddition) can be from greater than or equal to 1 ppm to less than or equal to 10,000 ppm, from greater than or equal to 5 ppm to less than or equal to 2,000 ppm, from greater than or equal to 10 ppm to less than or equal to 1,000 ppm, from greater than or equal to 15 ppm to less than or equal to 500 ppm, from greater than or equal to 30 ppm to less than or equal to 200 ppm, from greater than or equal to 50 ppm to less than or equal to 100 ppm, or any range or subrange therebetween. Additionally or alternatively, an amount of gold and/or silver can be within one or more of the ranges for the total amount of one or more colorants discussed above (e.g., from 0.0005 mol % to 5.0 mol %, from 0.01 mol % to 5.0 mol %, from 0.1 mol % to 5.0 mol %, from 0.2 mol % to 3.0 mol %, from 0.5 mol % to 2.0 mol %). For example, natively colored glass-based articles containing silver and/or gold can exhibit a red (e.g., rose) appearance.

In aspects, the one or more colorants can include copper, cerium, and/or cobalt, which can produce a blue color in the natively colored glass-based articles. In aspects, the natively colored glass-based article may comprise a concentration of CeO₂ of 0.1 mol % or more, 0.2 mol % or more, 0.3 mol % or more, 2.0 mol % or less, 1.5 mol % or less, 1.0 mol % or less, 0.75 mol % or less, 0.5 mol % or less, or 0.4 mol % or less. In aspects, the natively colored glass-based article may comprise a concentration of CeO₂ from greater than or equal to 0.1 mol % to less than or equal to 2.0 mol %, from greater than or equal to 0.2 mol % to less than or equal to 1.5 mol %, from greater than or equal to 0.2 mol % to less than or equal to 1.0 mol %, from greater than or equal to 0.3 mol % to less than or equal to 0.75 mol %, from greater than or equal to 0.3 mol % to less than or equal to 0.5 mol %, from greater than or equal to 0.3 mol % to less than or equal to 0.4 mol %, or any range or subrange therebetween. In aspects, cobalt (e.g., Co₃O₄) can be within one or more of the ranges discussed in the previous sentence for CeO₂. Alternatively, cobalt (e.g., Co₃O₄) used in combination with other colorants, in which case, cobalt can be present in a relatively low concentration, for example, greater than 0 mol %, 0.0001 mol % or more, 0.0002 mol % or more, 0.0005 mol % or more, 0.001 mol % or more, 0.01 mol % or less, 0.0095 mol % or less, 0.009 mol % or less, 0.0085 mol % or less, 0.008 mol % or less, 0.0075 mol % or less, 0.007 mol % or less, 0.0065 mol % or less, 0.006 mol % or less, 0.0055 mol % or less, 0.005 mol % or less, 0.0045 mol % or less, 0.004 mol % or less, 0.0035 mol % or less, 0.003 mol % or less, 0.0025 mol % or less, or 0.002 mol % or less. In aspects, the glass article may comprise a concentration of Co₃O₄ from greater than 0 mol % to 0.01 mol % or less, from 0.0001 mol % to 0.009 mol % or less, from 0.0001 mol % to 0.008 mol %, from 0.0001 mol % to 0.007 mol %, from 0.0002 mol % to 0.006 mol %, from 0.0002 mol % to 0.005 mol %, from 0.0005 mol % to 0.004 mol %, from 0.0005 mol % to 0.003 mol %, from 0.01 mol % to 0.02 mol %, or any range or subrange therebetween.

In aspects, the one or more colorants can include chromium (e.g., Cr₂O₃). In further aspects, decreased Al₂O₃ content (e.g., less than or equal to 8.0 mol %) can increase a solubility of chromium in the natively colored glass-based article (e.g., reducing and/or avoiding the formation of Cr-spinel crystals), which can expand the color gamut that may be achieved in the resultant natively colored glass-based articles. Additionally, in further aspects, the glass-based composition and the resultant natively colored glass-based articles can be per-alkali (i.e., R₂O (mol %)+R′O (mol %)−Al₂O₃ (mol %) is 0.5 mol % or more) to increase the solubility of Cr₂O₃ and avoid Cr-spinel crystal formation. However, when the glass composition has an excessive amount of alkali after charge balancing Al₂O₃, the alkali may form non-bridging oxygen around SiO₂, which degrades fracture toughness. Accordingly, in aspects, R₂O+R′O−Al₂O₃ in the glass article may be limited (e.g., less than or equal to 6 mol %) to prevent a reduction in fracture toughness. In aspects, the natively colored glass-based article may comprise Cr₂O₃ in an amount within one or more of the ranges discussed above and/or greater than 0 mol % or more, 0.001 mol % or more, 0.005 mol % or less, 0.01 mol % or more, 0.05 mol % or more, 2.0 mol % or less, 1.5 mol % or less, 1.0 mol % or less, 0.5 mol % or less, 0.2 mol % or less, or 0.1 mol % or less. In aspects, the glass article may comprise Cr₂O₃ from greater than 0 mol % to less than or equal to 2.0 mol %, from greater than or equal to 0.001 mol % to less than or equal to 1.5 mol %, from greater than or equal to 0.005 mol % to less than or equal to 1.0 mol %, from greater than or equal to 0.01 mol % to less than or equal to 0.50 mol %, from greater than or equal to 0.05 mol % to less than or equal to 0.2 mol %, or any range or subrange therebetween. In aspects, the glass article may comprise Cr₂O₃ from 100 ppm to 10,000 ppm, from 100 ppm to 5,000 ppm, from 300 ppm to 2,000 ppm, from 500 ppm to 1,000 ppm, or any range or subrange therebetween.

In aspects, the one or more colorant can include copper. In further aspects, the copper (e.g., CuO) can be present in combination with a fining agent (e.g., SnO₂), for example with each component (e.g., CuO and SnO₂) being present in an amount of 0.01 mol % or more, 0.02 mol % or more, 0.05 mol % or more, 0.10 mol % or more, 0.15 mol % or more, 0.20 mol % or more, 0.25 mol % or more, 5.0 mol % or less, 1.0 mol % or less, 0.5 mol % or less, 0.4 mol % or less, 0.3 mol % or less, 0.25 mol % or less, 0.20 mol % or less, or 0.10 mol % or less. In amounts of copper (e.g., CuO) and a fining agent (e.g., SnO₂) can each be present in a range from greater than or equal to 0.01 mol % to less than or equal to 5.0 mol %, from greater than or equal to 0.02 mol % to less than or equal to 1.0 mol %, from greater than or equal to 0.05 mol % to less than or equal to 0.5 mol %, from greater than or equal to 0.10 mol % to less than or equal to 0.3 mol %, from greater than or equal to 0.20 mol % to less than or equal to 0.25 mol %, or any range or subrange therebetween. Without wishing to be bound by theory, a fining agent (e.g., SnO₂) that is a multi-valent oxide can oxidation of copper to the 2+ oxidation state, which can produce a blue color in the natively colored glass-based article.

In aspects, the glass-based composition can optionally comprise Fe₂O₃ in an amount of greater than 0 mol %, 0.01 mol % or more, 0.02 mol % or more, 0.05 mol % or more, 0.10 mol % or more, 0.2 mol % or more, 0.3 mol % or more, 2.0 mol % or less, 1.5 mol % or less, 1.0 mol % or less, 0.7 mol % or less, 0.5 mol % or less, 0.3 mol % or less, or 0.2 mol % or less. In aspects, the glass-based composition can optionally comprise Fe₂O₃ in an amount from greater than 0 mol % to less than or equal to 2.0 mol %, from greater than or equal to 0.01 mol % to less than or equal to 1.5 mol %, from greater than or equal to 0.02 mol % to less than or equal to 1.0 mol %, from greater than or equal to 0.05 mol % to less than or equal to less than or equal to 0.7 mol %, from greater than or equal to 0.10 mol % to less than or equal to 0.5 mol %, from greater than or equal to 0.2 mol % to less than or equal to 0.3 mol %, or any range or subrange therebetween. Alternatively, in aspects, the glass-based composition may be free of Fe₂O₃. Iron is often present in raw materials utilized to form glass-based compositions, and as a result may be detectable in the glass-based compositions described herein even when not actively added to the glass-based batch.

The glass-based compositions described herein may be formed primarily from (i.e., containing 0.5 mol % or more of each) SiO₂, Al₂O₃, Li₂O, P₂O₅, and/or one or more colorant, where the glass-based compositions can optionally include (and/or include in amounts less than or equal to 0.5 mol %) Na₂O, K₂O, MgO, and/or CaO. In aspects, the glass-based compositions are free of components other than SiO₂, Al₂O₃, Li₂O, Na₂O, K₂O, MgO, CaO, P₂O₅, a fining agent (e.g., SnO₂), and one or more colorant (e.g., silver, gold, copper, nickel, chromium, cobalt, manganese).

In aspects, colorants based on transition metal oxides and/or rare earth oxides may further include oxides of V, Mn, Fe, Cu, Zr, Nb, Mo, Tc, Ru, Rh, Pd, Cd, Hf, Ta, W, Re, Os, Ir, Pt, Pr, Nd, Sm, Eu, Gd, Tb, Dy, Ho, and Er. Alternatively, the glass-based compositions can be free of rare earth oxides, including oxides of Sc, Y, La, Ce, Pr, Nd, Pm, Sm, Eu, Gd, Tb, Dy, Ho, Er, Tm, Yb, and/or Lu. In aspects, the glass-based composition may be free of at least one of Ta₂O₅, HfO₂, La₂O₃, and Y₂O₃. In aspects, the glass-based composition may be free of Ta₂O₅, HfO₂, La₂O₃, and Y₂O₃. While these components may increase the fracture toughness of the glass-based when included, there are cost and supply constraints that make using these components undesirable for commercial purposes. Stated differently, the ability of the glass-based compositions described herein to achieve high fracture toughness values within the inclusion of Ta₂O₅, HfO₂, La₂O₃, and Y₂O₃ provides a cost and manufacturability advantage.

In aspects, the glass article 350 and/or 511 (e.g., natively colored glass-based article) can comprise a CIE L* value of 15 or more, 20 or more, 25 or more, 30 or more, 35 or more, 40 or more 45 or more, 50 or more, 55 or more, 60 or more, 65 or more, 70 or more, 75 or more, 85 or more, 90 or less, 85 or less, 80 or less, 75 or less, 70 or less, 65 or less, 60 or less, 55 or less, 50 or less, 45 or less, 40 or less, 35 or less, or 30 or less. In aspects, the CIE L* value can be from 15 to 90, from 20 to 85, from 25 to 80, from 30 to 75, from 35 to 70, from 40 to 65, from 45 to 55, or any range or subrange therebetween. In aspects, the glass article 350 and/or 511 can comprise a CIE L* value greater than or equal to 50, for example, from 50 to 90, from 55 to 85, from 60 to 80, from 65 to 75, from 65 to 70, or any range or subrange therebetween. Providing a CIE L* value from 50 to 90 can provide an aesthetically pleasing, bright color of the glass article. Without wishing to be bound by theory, it is believed that glasses having CIELAB color coordinates within the range of CIE L* value greater than 90 (e.g., greater than 96.5) can be faintly colored or transparent to wavelengths of visible light (i.e., wavelengths of light from 380 nm to 750 nm, inclusive of endpoints). Alternatively, in aspects, the CIE L* value can be less than or equal to 50, for example, from 15 to 50, from 20 to 45, from 25 to 40, from 30 to 35, or any range or subrange therebetween. Providing a CIE L* value from 15 to 50 can produce a noticeably colored (e.g., darkly and/or opaquely) glass-based article, which can be aesthetically pleasing.

In aspects, the glass article 350 and/or 511 (e.g., natively colored glass-based article) can comprise an absolute value of a CIE a* (i.e., |a*|) value of 0.3 or more, 0.5 or more, 0.8 or more, 1 or more, 3 or more, 5 or more, 10 or more, 15 or more, 18 or more, 20 or more, 25 or more, or 30 or more. In aspects, the CIE a* value can be −75 or more, −60 or more, −45 or more, −30 or more, −15 or more, −10 or more, −5 or more, −3 or more, −1 or more, 0.5 or more, 1 or more, 5 or more, 10 or more, 15 or more, 20 or more, 25 or more, 30 or more, 40 or more, 50 or more, 75 or less, 60 or less, 50 or less, 45 or less, 40 or less, 35 or less, 30 or less, 25 or less, 20 or less, 15 or less, 10 or less, 5 or less, 3 or less, 1 or less, −0.5 or less, −1 or less, −5 or less, −10 or less, −15 or less, −20 or less, −25 or less, −30 or less, −35 or less, −40 or less, or −45 or less. In aspects, the CIE a* value (excluding values from −0.3 to 0.3) can range from −75 to 75, from −60 to 60, from −50 to 50, from −45 to 45, from −40 to 40, from −35 to 35, from −30 to 30, from −25 to 25, from −20 to 20, from −15 to 15, from −10 to 10, from −5 to 5, or any range or subrange therebetween. In aspects, the CIE a* value can be greater than or equal to 15, for example, from 15 to 50, 20 to 45, 25 to 40, from 30 to 35, or any range or subrange therebetween. Alternatively, the CIE a* value can be less than or equal to −10, for example, from −50 to −10, from −45 to −15, from −40 to −20, from −35 to −25, from −30 to −25, or any range or subrange therebetween.

In aspects, the glass article 350 and/or 511 (e.g., natively colored glass-based article) can comprise an absolute value of a CIE b* (i.e., |b*|) value of 0.2 or more, 0.3 or more, 0.5 or more, 1 or more, 3 or more, 5 or more, 8 or more, 10 or more, 20 or more, 50 or more, 70 or more, or 80 or more. In aspects, the CIE b* value can be −100 or more, −90 or more, −75 or more, −50 or more, −35 or more, −20 or more, −5 or more, −1 or more, 0.2 or more, 0.3 or more, 0.5 or more, 1 or more, 3 or more, 5 or more, 8 or more, 10 or more, 20 or more, 50 or more, 70 or more, 100 or less, 90 or less, 75 or less, 50 or less, 35 or less, 20 or less, 10 or less, 5 or less, −0.2 or less, −0.3 or less, −0.5 or less, −1 or less, −5 or less, −10 or less, −20 or less, −35 or less, −50 or less, or −70 or less. In aspects, the CIE b* value (excluding from −0.2 to 0.2) can range from −100 to 100, from −90 to 90, from −75 to 75, from −50 to 50, from −35 to 35, from −20 to 20, from −5 to 8, from −1 to 5, from 0.2 to 3, from 0.3 to 1, or any range or subrange therebetween. In aspects, the CIE b* value can be from −5 to 5, from −3 to 3, from −1 to 1, from −0.5 to 0.5, from −0.3 to 0.3, or any range or subrange therebetween. Alternatively, in aspects, the CIE b* value can be from 5 to 35, from 8 to 30, from 10 to 25, from 15 to 20, or any range or subrange therebetween.

In aspects, the natively colored glass-based article can exhibit a CIE L* value from 15 to 90 (e.g., from 55 to 75), a CIE a* value from 15 to 50 (e.g., from 25 to 40), and a CIE b* value from −5 to 5, which can have a red appearance Alternatively, in aspects, the natively colored glass-based article can exhibit a CIE L* value from 15 to 90 (e.g., from 15 to 40), a CIE a* value from 15 to 75 (e.g., from 20 to 60), and a CIE b* value from −100 to −70, which can have a blue (e.g., dark blue, royal blue) appearance. Alternatively, in aspects, the natively colored glass-based article can exhibit a CIE L* value from 15 to 90 (e.g., from 15 to 50), a CIE a* value from −30 to 30 (e.g., from −15 to 0.5), and a CIE b* value from 0 to 70 (e.g., from 5 to 35), which can have a green (e.g., dark green, forest green) appearance. In aspects, the CIE color coordinates exhibited by the natively colored glass-based article can have a sum of an absolute value of the CIE a* value and an absolute value of the CIE b* value (i.e., |a*|+|b*|) that is greater than or equal to 10, greater than or equal to 15, greater than or equal to 20, greater than or equal to 25, or greater than or equal 30, for example, from 10 to 100, from 15 to 90, from 20 to 85, from 25 to 80, from 30 to 75, from 35 to 70, from 40 to 65, from 45 to 60, from 50 to 55, or any range or subrange therebetween. In aspects, the CIE color coordinates exhibited by the natively colored glass-based article can have a sum of an absolute value of the CIE a* value and an absolute value of the CIE b* value (i.e., |a*|+|b*|) that is greater than the corresponding CIE L* value (i.e., |a*|+|b*|>L*), for example, when the CIE L* value is at least 15 (e.g., from 15 to 90, from 20 to 80, from 25 to 70, from 30 to 60).

The glass-based compositions described herein have liquidus viscosities that are compatible with manufacturing processes that are especially suitable for forming thin glass-based sheets. In aspects, the glass-based compositions can be compatible with a gob-pressing process. Gob-pressing can be used with relatively low liquidus viscosity glasses (described below). For example, a stream of molten material can be collected into a gob on a forming surface (e.g., mold or mating surface thereof) that is pressed to form a predetermined shape of the resulting glass-based article. It is to be understood that “gob” does not necessarily have a cylindrical shape; rather, as used herein, it refers to a collection of molten glass to be formed into the predetermined shape. Alternatively, in aspects, the glass-based composition can be compatible with down draw processes such as fusion-draw processes or slot draw processes.

As used herein, “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed herein is determined by the following method. First, the liquidus temperature of the glass-based composition is measured in accordance with ASTM C829-81 (2015), titled “Standard Practice for Measurement of Liquidus Temperature of Glass by the Gradient Furnace Method.” Next, the viscosity of the glass-based composition at the liquidus temperature is measured in accordance with ASTM C965-96 (2012), titled “Standard Practice for Measuring Viscosity of Glass Above the Softening Point”. Unless otherwise specified, the liquidus viscosity and temperature of a glass-based composition is measured before the composition is subjected to any ion-exchange process or any other strengthening process.

In aspects, the liquidus viscosity of the glass-based composition can be 50 Pascal-seconds (Pa-s) or more, 70 Pa-s or more, 100 Pa-s or more, 150 Pa-s or more, 200 Pa-s or more, 250 Pa-s or more, 300 Pa-s or more, 350 Pa-s or more, 400 Pa-s or more, 550 Pa-s or less, 500 Pa-s or less, 450 Pa-s or less, 400 Pa-s or less, 350 Pa-s or less, 300 Pa-s or less, 250 Pa-s or less, 200 Pa-s or less, 150 Pa-s or less, or 100 Pa-s or less. In aspects, the liquidus viscosity of the glass-based composition can be in a range from greater than or equal to 50 Pa-s to less than or equal to 550 Pa-s, from greater than or equal to 70 Pa-s to less than or equal to 500 Pa-s, from greater than or equal to 100 Pa-s to less than or equal to 450 Pa-s, from greater than or equal to 150 Pa-s to less than or equal to 400 Pa-s, from greater than or equal to 200 Pa-s to less than or equal to 350 Pa-s, from greater than or equal to 250 Pa-s to less than or equal to 300 Pa-s, or any range or subrange therebetween. Without wishing to be bound by theory, the lower liquidus viscosity glass-based articles (and compositions) disclosed herein are believed to be associated with higher K_{IC} values and improved ion exchange capability.

In aspects, the glass-based compositions described herein may form glass-based articles that exhibit an amorphous microstructure and may be crystals or crystallites. In other words, the glass-based articles formed from the glass compositions described herein may exclude glass-ceramic materials. Alternatively, in aspects, the glass-based articles can form glass-ceramics. In further aspects, the glass-ceramic can be found by heating an amorphous glass-based article to nucleate and/or grow crystallites. For example, a glass-based substrate can be heated at a temperature from 500° C. to 800° C. for a period of time from 30 minutes to 24 hours (or within one or more of the corresponding ranges discussed below with reference to methods) to form a resulting glass-ceramic substrate. In further aspects, the glass-ceramic can comprise a petalite phase and/or a lithium disilicate phase. In even further aspects, a primary crystal phase (i.e., the crystal phase with the greatest vol % of the glass-ceramic) can be petalite phase or lithium disilicate. In further aspects, an elastic modulus (e.g., Young's modulus) of the glass-ceramic substrates and/or glass-ceramic articles can be greater than or equal to 100 GPa, for example, from greater than or equal to 100 GPa to less than or equal to 250 GPa, from greater than or equal to 120 GPa to less than or equal to 220 GPa, from greater than or equal to 150 GPa to less than or equal to 200 GPa, from greater than or equal to 170 GPa to less than or equal to 200 GPa, or any range or subrange therebetween.

Glass-based compositions according to aspects have a high fracture toughness. Without wishing to be bound by theory, the high fracture toughness may impart improved drop performance to the glass-based compositions. The high fracture toughness of the glass-based compositions described herein increases the resistance of the glass-based substrates to damage and allows a higher degree of stress to be imparted to the resulting glass-based articles through ion exchange, as characterized by central tension, without becoming frangible. As used herein, “fracture toughness” refers to the K_{IC} value as measured by the chevron notched short bar method unless otherwise noted. The chevron notched short bar (CNSB) method utilized to measure the K_{IC} value is disclosed in Reddy, K. P. R. et al., “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Additionally, the K_{IC} values are measured on non-strengthened glass-based samples, such as measuring the K_{IC} value prior to ion exchanging a glass-based substrate to form a glass-based article. The K_{IC} values discussed herein are reported in MPa√m, unless otherwise noted. In aspects, the glass-based compositions exhibit a K_{IC} value of greater than or equal to 1.0 MPa√m, such as greater than or equal to 1.1 MPa√m, greater than or equal to 1.2 MPa√m, greater than or equal to 1.3 MPa√m, greater than or equal to 1.4 MPa√m, greater than or equal to 1.5 MPa√m, greater than or equal to 1.6 MPa√m, greater than or equal to 1.7 MPa√m, greater than or equal to 1.8 MPa√m, or more. In aspects, the glass-based compositions exhibit a K_{IC} value of from greater than or equal to 1.0 MPa√m to less than or equal to 2.0 MPa√m, such as from greater than or equal to 1.1 MPa√m to less than or equal to 1.9 MPa√m, from greater than or equal to 1.1 to less than or equal to from 1.8 MPa√m, from greater than or equal to 1.2 to less than or equal to from 1.7 MPa√m, from greater than or equal to 1.3 to less than or equal to from 1.6 MPa√m, from greater than or equal to 1.4 to less than or equal to from 1.5 MPa√m, or any ranges or sub-range therebetween.

Throughout the disclosure, volume electrical resistivity is measured in accordance with ASTM D257 modified for the high temperatures discussed herein. In aspects, a volume resistivity of the glass-based composition (e.g., glass-based substrate) at a temperature of 1385° C. (or 1420° C.) can be 1.25 Ohm-centimeters or more, 1.30 Ohm-centimeters or more, 1.35 Ohm-centimeters or more, 1.40 Ohm-centimeters or more, 1.45 Ohm-centimeters or more, 1.50×10¹⁶ Ohm-centimeters or more, 1.60 Ohm-centimeters or less, 1.55 Ohm-centimeters or less, 1.50 Ohm-centimeters or less, 1.45 Ohm-centimeters or less, or 1.40 Ohm-centimeters or less. In aspects, a volume resistivity of the glass-based composition (e.g., glass-based substrate) at a temperature of 1385° C. (or 1420° C.) can be in a range from greater than or equal to 1.25 Ohm-centimeters to less than or equal to 1.60 Ohm-centimeters, from greater than or equal to 1.30 Ohm-centimeters to less than or equal to 1.55 Ohm-centimeters, from greater than or equal to 1.35 Ohm-centimeters to less than or equal to 1.50 Ohm-centimeters, from greater than or equal to 1.40 Ohm-centimeters to less than or equal to 1.45 Ohm-centimeters, or any range or subrange therebetween. In preferred aspects, the volume electrical resistivity of the glass-based composition (e.g., glass-based substrate) at 1385° C. can be from greater than or equal to 1.25 Ohm-centimeters to less than or equal to 1.60 Ohm-centimeters, from greater than or equal to 1.30 Ohm-centimeters to less than or equal to 1.50 Ohm-centimeters, or from greater than or equal to 1.35 Ohm-centimeters to less than or equal to 1.40 Ohm-centimeters. In preferred aspects, the volume electrical resistivity of the glass-based composition (e.g., glass-based substrate) at 1420° C. can be from greater than or equal to 1.25 Ohm-centimeters to less than or equal to 1.60 Ohm-centimeters, from greater than or equal to 1.40 Ohm-centimeters to less than or equal to 1.55 Ohm-centimeters, or from greater than or equal to 1.45 Ohm-centimeters to less than or equal to 1.55 Ohm-centimeters. Providing glass-based compositions (e.g., glass-based substrates) with a volume electrical resistivity from 1.25 Ohm-centimeters to less than or equal to 1.60 Ohm-centimeters at 1385° C. and/or 1420° C. can facilitate melting of to form molten material by electrical resistance heating. As demonstrated by the examples herein, the addition of the relatively small amounts of sodium and potassium discussed herein do not significantly impact the electrical resistivity of the corresponding glass composition.

Throughout the disclosure, radiative thermal conductivity is measured using spectrophotometry of a sample heated to 1600° C. Unless otherwise indicated, a sample of 250 milligrams was heated in a crucible made of fused aluminum oxide that was heated to 1600° C. Absorption spectra were measured from 0.7 micrometers to 34.8 micrometers when the sample is at 1600° C. Based on this absorption spectrum, the radiative thermal conductivity based on known theoretical models. As used herein, the phrase “thermal conductivity” refers to radiative thermal conductivity at 1600° C., unless otherwise indicated. In aspects, the radiative thermal conductivity at 1600° C. of the glass composition (e.g., natively colored glass-based substrate) can be greater than or equal to 150 Watts per meter-Kelvin (W/m-K), greater than or equal to 170 W/m-K, greater than or equal to 200 W/m-K, greater than or equal to 220 W/m-K, greater than or equal to 250 W/m-K, greater than or equal to 270 W/m-K, greater than or equal to 300 W/m-K, greater than or equal to 350 W/m-K, less than or equal to 400 W/m-K, less than or equal to 350 W/m-K, less than or equal to 300 W/m-K, less than or equal to 270 W/m-K, less than or equal to 250 W/m-K, or less than or equal to 220 W/m-K. In aspects, the radiative thermal conductivity at 1600° C. of the glass composition (e.g., natively colored glass-based substrate) can be from greater than or equal to 150 W/m-K to less than or equal to 400 W/m-K, from greater than or equal to 170 W/m-K to less than or equal to 350 W/m-K, from greater than or equal to 200 W/m-K to less than or equal to 300 W/m-K, from greater than or equal to 220 W/m-K to less than or equal to 270 W/m-K, from greater than or equal to 250 W/m-K to less than or equal to 270 W/m-K, or any range or subrange therebetween.

As discussed with reference to the examples herein, the glass compositions (e.g., natively colored glass-based composition) disclosed herein have unexpectedly increased thermal conductivity. In particular, natively colored glass-based substrates (and articles) (e.g., having 0.1 mol % of the one or more colorants discussed herein), especially those that are darkly colored, can have decreased thermal conductivity (in the absence of the features of the present disclosure, e.g., the addition of small amounts of sodium and potassium within the ranges and/or ratios disclosed herein), for example, due to an increased opacity at a temperature of the glass melt (e.g., 1600° C.) relative to a transparent high-silica melt without such colorants. As discussed below, with reference to FIG. 12, poor thermal conductivity at a temperature of the glass melt for glass-based compositions having colorants (in the absence of the features of the present disclosure) can produce differences of hundreds of degrees Celsius (e.g., 200° C. or more) indicated by the vertical axis 1203 at the same location along the conveyance path (horizontal axis 1201) but a different distances from a wall of the glass-manufacturing apparatus (compare curves 1215 and 1213). This can pose issues for quality control (e.g., as different portions of the melt experience different thermal histories that can influence the color exhibited by the resulting glass-based substrate, melting, devitrification, etc.) if the flowrate is maintained at production scale. At the same time, this can pose issues for throughput, if the flowrate is decreased to allow additional time for such thermal gradients to decrease. Until the work of the present inventors, it is believed that the impact of various alkali metal oxides on heat transfer (e.g., radiative), especially for colored glass-based melts, had not been investigated or understood. Moreover, it is believed that it was not possible to reliably quantify radiative heat transfer coefficients at (or near) temperatures of glass melts; consequently, the relationship between non-lithium alkali metal oxides and radiative heat transfer coefficient could not have been appreciated, especially for low amounts of non-lithium alkali metal oxides relative to a total amount of alkali metal oxides.

As mentioned above, in aspects, the glass-based compositions (e.g., glass-based substrate) described herein can be strengthened, such as by ion exchange, making a glass-based article that is damage resistant for applications such as, but not limited to, display covers. As shown in FIG. 8, the natively colored glass-based article (e.g., glass article 511) has a first compressive stress region 811 extending from the first major surface 513 to a first depth of compression 813 (first distance 817), and/or the glass-based article (e.g., glass article 511) has a second compressive stress region 821 extending from the second major surface 515 to a second depth of compression 823 (second distance 827). The first compressive stress region 811 and/or the second compressive stress region 821 is under compressive stress (e.g., as a result of ion exchange). In further aspects, as shown in FIG. 8, the glass-based article (e.g., glass article 511) can comprise a central tension region 831 under tensile stress (e.g., central tension (CT)) and positioned between the first compressive stress region 811 and the second compressive stress region 821 (e.g., extending between the first depth of compression 813 (first distance 817) from the first major surface 513 and the second depth of compression 823 (second distance 827) from the second major surface 515). As used herein, “depth of compression” (DOC) refers to the depth at which the stress within the glass-based article changes from compressive to tensile. At the DOC, the stress crosses from a positive (compressive) stress to a negative (tensile) stress and thus exhibits a stress value of zero. According to the convention normally used in the art, compression or compressive stress is expressed as a positive (>0) stress and tension or tensile stress is expressed as a negative (<0) stress. Throughout this description, however, CS and CT are both expressed as positive or absolute values—i.e., as recited herein, CS=|CS|. The compressive stress (CS) has a maximum at or near the surface of the glass-based article, and the CS varies with distance d from the surface according to a function.

In aspects, the compressive stress region(s) may be created by chemically strengthening a glass-based substrate to form the glass-based article. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate can enable small (e.g., smaller than 10 mm or less) bend radii because the compressive stress from the chemical strengthening can counteract the bend-induced tensile stress on the outermost surface of the substrate (e.g., first major surface 513, or second major surface 515). Depth of compression (DOC) may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Ind7ustrial Co., Ltd. (Japan)), is used to measure a depth of compression. Unless specified otherwise, compressive stress (including surface CS) is measured by a surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 75 μm, SCALP is used to measure the depth of compression and central tension (CT). Where the stress in the substrate is generated by exchanging both potassium and sodium ions into the glass, and the article being measured is thicker than 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the first depth of compression and/or second depth of compression (see first distance 817 and/or second distance 827 in FIG. 8), as a percentage of the substrate thickness 807, can be 5% or more, 10% or more, 15% or more, 20% or more, 25% or more, 30% or more, 35% or less, 30% or less, 25% or less, 20% or less, 15% or less, or 10% or less. In even further aspects, the first depth of compression and/or the second depth of compression, as a percentage of the substrate thickness 807, can be in a range from 5% to 35%, from 10% to 30%, from 15% to 25%, from 20% to 25%, or any range or subrange therebetween. In aspects, the first depth of compression and/or the second depth of compression can be 10 μm or more, 30 μm or more, 50 μm or more, 100 μm or more, 150 μm or more, 200 μm or more, 250 μm or more, 500 μm or less, 400 μm or less, 300 μm or less, 250 μm or less, 200 μm or less, 150 μm or less, or 100 μm or less. In aspects, the first depth of compression and/or the second depth of compression can be in a range from greater than or equal to 10 μm to less than or equal to 500 μm, from greater than or equal to 30 μm to less than or equal to 400 μm, from greater than or equal to 50 μm to less than or equal to 300 μm, from greater than or equal to 100 μm to less than or equal to 250 μm, from greater than or equal to 150 μm to less than or equal to 200 μm, or any range or subrange therebetween. In aspects, the first depth of compression and/or the second depth of compression can be 150 μm or more, for example, in a range from greater than or equal to 150 μm to less than or equal to 500 μm, from greater than or equal to 200 μm to less than or equal to 400 μm, or any range or subrange therebetween. In aspects, the first depth of compression can be greater than, less than, or the same as the second depth of compression.

The first compressive stress region 811 comprises a maximum first compressive stress, and/or the second compressive stress region 821 comprises a maximum second compressive stress. In aspects, a location of the maximum first compressive stress and/or the maximum second compressive stress can be at (e.g., within 1 μm) of the corresponding major surface, although the corresponding maximum compressive stress can be located more than 1 μm from the corresponding major surface. In aspects, the maximum first compressive stress and/or the maximum second compressive stress can be 100 MegaPascals (MPa) or more, 300 MPa or more, 500 MPa or more, 600 MPa or more, 700 MPa or more, 800 MPa or more, 1,500 MPa or less, 1,200 MPa or less, 1,000 MPa or less, or 900 MPa or less. In aspects, the maximum first compressive stress and/or the maximum second compressive stress can be in a range from greater than or equal to 100 MPa to less than or equal to 1,500 MPa, from greater than or equal to 300 MPa to less than or equal to 1,200 MPa, from greater than or equal to 500 MPa to less than or equal to 1,000 MPa, from greater than or equal to 600 MPa to less than or equal to 1,000 MPa, from greater than or equal to 800 MPa to less than or equal to 1.00 MPa, or any range or subrange therebetween. Providing a maximum first compressive stress and/or a maximum second compressive stress in a range from 500 MPa to 1,500 MPa or from 500 MPa to 1,000 MPa can enable good impact and/or puncture resistance.

In aspects, Na⁺ and/or K⁺ ions can be exchanged into the glass-based article, and the Na⁺ ions diffuse to a deeper depth into the glass-based article than the K⁺ ions. The depth of penetration of K⁺ ions (“Potassium DOL” or “DOL” herein) is distinguished from DOC because it represents the depth of potassium penetration as a result of an ion exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL^{SP}), where a stress profile transitions from a steep spike region to a less-steep deep region. The deep region extends from the bottom of the spike to the depth of compression. In aspects, the depth of layer of one or more of the alkali metal ions associated with the corresponding compressive stress region (e.g., DOL^{SP}) of the glass-based article can be 3 μm or more, 4 μm or more, 5 μm or more, 6 μm or more, 7 μm or more, 10 μm or less, 9 μm or less, 8 μm or less, or 7 μm or less. In aspects, the depth of layer of one or more of the alkali metal ions associated with the corresponding compressive stress region (e.g., DOL^{SP}) can be in a range from 3 μm to 10 μm, from 4 μm to 9 μm, from 5 μm to 8 μm, from 6 μm to 7 μm, or any range or subrange therebetween.

The central tension region can comprise a maximum central tension (maximum CT). The measurement of a maximum CT value is an indicator of the total amount of stress stored in the strengthened articles. For this reason, the ability to achieve higher CT values correlates to the ability to achieve higher degrees of strengthening and increased performance. In aspects, the maximum CT can be 50 MPa or more, 75 MPa or more, 100 MPa or more, 120 MPa or less, 150 MPa or more, 170 MPa or more, 200 MPa or more, 300 MPa or less, 250 MPa or less, 200 MPa or less, 150 MPa or less, or 120 MPa or less. In aspects, the maximum CT can be in a range from greater than or equal to 50 MPa to less than or equal to 300 MPa, from greater than or equal to 70 MPa to less than or equal to 300 MPa, from greater than or equal to 100 MPa to less than or equal to 250 MPa, from greater than or equal to 150 MPa to less than or equal to 250 MPa, from greater than or equal to 170 MPa to less than or equal to 200 MPa, or any range or subrange therebetween. In preferred aspects, the maximum CT can be in a range from greater than 50 MPa to less than or equal to 300 MPa, from greater than or equal to 150 MPa to less than or equal to 250 MPa, or from greater than or equal to 170 MPa to less than or equal to 200 MPa.

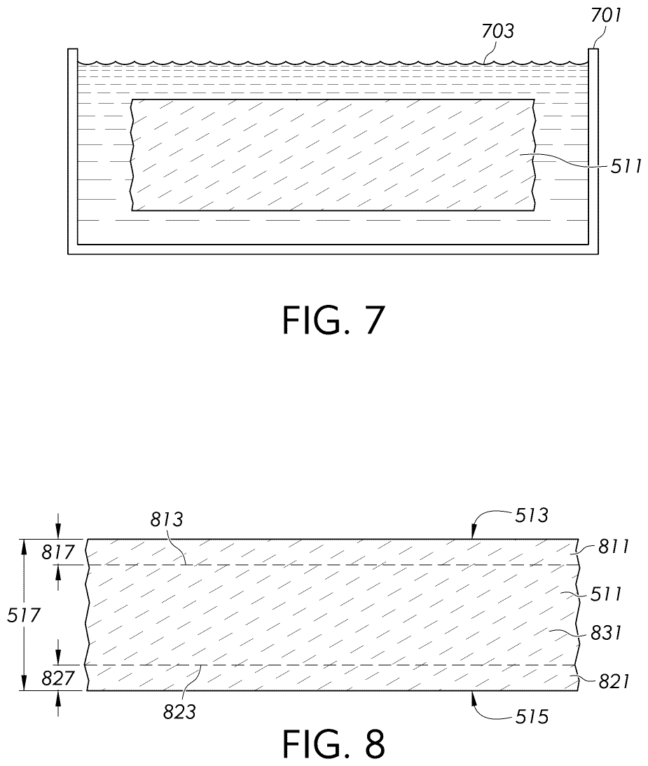

Methods of making natively colored glass-based substrates and/or natively colored glass-based articles of the present disclosure will now be discussed with reference to the flow chart of FIG. 6, the natively colored glass-based articles of FIGS. 5 and 8, and a method step illustrated in FIG. 7. As discussed above, natively colored glass-based substrates and/or natively colored glass-based articles comprising compositions in accordance with the present disclosure can be obtained by forming them with a variety of forming processes, including gob forming or ribbon forming processes, for example, slot draw, down-draw, fusion down-draw, up-draw, press roll, redraw, or float. Alternatively, glass-based substrates comprising compositions in accordance with the present disclosure may be obtained by purchase. In aspects, the glass-based substrate can be an amorphous substrate or a glass-ceramic. In further aspects, a glass-ceramic can be formed by heating a glass-based substrate to nucleate and/or grow crystals (e.g., as discussed below with reference to step 607). As discussed above, glass-ceramics in accordance with the present disclosure can comprise petalite and/or lithium disilicate, for example, a primary crystal phase.

Methods can start at step 601. In aspects, step 601 can comprise obtaining raw materials for the glass composition, for example, including silica, alumina, alkali metal oxides (e.g., lithia, sodium oxide, potassium oxide), zirconia, phosphorous pentoxide, and one or more colorants. In aspects, methods can proceed to step 603 comprising heating precursor materials (e.g., raw materials for the glass composition) to form a glass melt. In further aspects, a ratio of the precursor materials (e.g., raw materials) can within one or more of the corresponding ranges (e.g., mol % for individual components, relative ratios for alkali metal oxides) discussed above. In further aspects, the heating can comprise passing an electrical current through the precursor materials, where the electrical resistivity of the precursor materials results in heating as a result of the current. For example, the heating by electrical resistance can be facilitated by providing an electrical resistivity (e.g., at 1385° C., at 1420° C.) within one or more of the ranges discussed above (e.g., from 1.25 Ohm-centimeters to less than or equal to 1.6 Ohm-centimeters). In further aspects, a radiative thermal conductivity of the glass melt can be within one or more of the corresponding ranges mentioned above (e.g., from 150 W/m-K to 400 W/m-K, from 200 W/m-K to 300 W/m-K). As discussed herein, the glass compositions (e.g., natively colored glass-based composition) disclosed herein have unexpectedly increased thermal conductivity, especially for darkly colored compositions. The increased thermal conductivity facilitates increased homogeneity of the resulting natively colored glass-based substrates and/or increased throughput due to the ability of glass melt to have lower thermal gradients that otherwise obtainable under predetermined processing conditions. After step 603, methods can proceed to step 605 comprising cooling the raw materials to form a natively colored glass-based substrate, which can exhibit one or more of the color coordinates within the corresponding ranges discussed above.

After step 605, methods can proceed to step 607 comprising heating the natively colored glass-based substrate at a predetermined temperature for a predetermined period of time to form a glass-ceramic substrate. In aspects, the predetermined temperature can be 500° C. or more, 550° C. or more, 600° C. or more, 650° C. or more, 700° C. or more, 800° C. or less, 750° C. or less, 700° C. or less, 650° C. or less, or 600° C. or less. In aspects, the predetermined temperature can be from 500° C. to 800° C., from 550° C. to 750° C., from 600° C. to 700° C., from 600° C. to 650° C., or any range or subrange therebetween. In aspects, the predetermined period of time can be 0.5 hours or more, 1.0 hour or more, 1.5 hours or more, 2.0 hours or more, 4 hours or more, 8 hours or more, 24 hours or less, 12 hours or less, 6 hours or less, 4 hours or less, or 2 hours or less. In aspects, the predetermined period of time can be from 0.5 hours to 24 hours, from 1.0 hour to 12 hours, from 1.5 hours to 6 hours, from 2.0 hours to 4 hours, or any range or subrange therebetween. Also, it is to be understood that step 607 can comprise heating at multiple temperatures, for example at a lower temperature followed by a higher temperature, where both the lower temperature and the higher temperature are within one or more ranges discussed above in this paragraph for the predetermined temperature, and/or a combined period of time associated with the lower temperature and the higher temperature can be within one or more ranges discussed above in this paragraph for the predetermined period of time. For example, the lower temperature can facilitate nucleation of crystals, and the higher temperature can facilitate growth of the crystals. In aspects, the glass-ceramic can comprise petalite crystals and/or lithium disilicate crystals, which can in further aspects be the predominant crystal phase. In further aspects, the glass-ceramic can additionally comprise a beta-quartz solid solution, a beta-spodumene solid solution, a lithium phosphate (Li₃PO₄) crystal phase, and/or a zirconium-containing crystal phase. In further aspects, the glass-ceramic can exhibit fracture toughness within one or more of the corresponding ranges discussed above while also exhibiting color coordinates within one or more of the corresponding ranges discussed above.

After step 605 or 607, as shown in FIGS. 7-8, methods can proceed to step 609 comprising chemically strengthening the natively colored glass-based substrate (e.g., glass-ceramic substrate) to form a natively colored glass-based article (e.g., glass-ceramic article). In aspects, chemically strengthening the glass-based substrate can comprise exposing the glass-based substrate to one or more ion-exchange medium(s) (e.g., molten salt solutions). The exchange medium(s) can include a molten nitrate salt (e.g., KNO₃, NaNO₃, or combinations thereof), for example, as a molten salt solution, although other sodium salts and/or potassium salts may be used in the ion-exchange medium, such as, for example sodium or potassium nitrites, phosphates, or sulfates. In aspects, the ion-exchange medium may include lithium salts, such as LiNO₃. The ion-exchange medium may additionally include additives commonly included when ion exchanging glass, such as silicic acid. In aspects, the ion-exchange medium may include a mixture of sodium and potassium (e.g., including both NaNO₃ and KNO₃), although the molten salt solution can consist of a single alkali metal salt. In aspects, the ion-exchange medium may include any combination NaNO₃ and KNO₃ in the amounts described below, such as a molten salt bath containing 80 wt % NaNO₃ and 20 wt % KNO₃, a molten salt bath containing 70 wt % NaNO₃ and 30 wt % KNO₃, a molten salt bath containing 60 wt % NaNO₃ and 40 wt % KNO₃, a molten salt bath containing 50 wt % NaNO₃ and 50 wt % KNO₃, a molten salt bath containing 40 wt % NaNO₃ and 60 wt % KNO₃, or any range or subrange therebetween. For example, as shown in FIG. 7, the glass-based substrate (e.g., glass article 511) can be exposed to a molten salt solution 703 (e.g., contained in a salt bath 701), for example, by immersing the glass-based substrate (e.g., glass article 511) in the molten salt solution 703. Alternatively, although not shown, can comprise spraying the ion-exchange medium onto a glass substrate made from the glass composition or otherwise physically applying the ion-exchange medium to the glass-based to form the ion-exchanged glass-based article. In further aspects, the ion-exchange medium (e.g., molten salt solution 703) can be maintained at a predetermined temperature and/or the glass-based substrate 103 can be in contact with the ion-exchange medium (e.g., molten salt solution 703) for a predetermined period of time. In further aspects, the predetermined temperature can be 350° C. or more, 360° C. or more, 370° C. or more, 380° C. or more, 390° C. or more, 400° C. or more, 410° C. or more, 420° C. or more, 430° C. or more, 440° C. or more, 500° C. or less, 480° C. or less, 470° C. or less, 460° C. or less, 450° C. or less, 440° C. or less, or 430° C. or less. In further aspects, the predetermined temperature can be in a range from greater than or equal to 350° C. to less than or equal to 500° C., from greater than or equal to 360° C. to less than or equal to 500° C., from greater than or equal to 370° C. to less than or equal to 490° C., from greater than or equal to 380° C. to less than or equal to 480° C., from greater than or equal to 390° C. to less than or equal to 470° C., from greater than or equal to 390° C. to less than or equal to 460° C., from greater than or equal to 400° C. to less than or equal to 450° C., from greater than or equal to 400° C. to less than or equal to 440° C., from greater than or equal to 410° C. to less than or equal to 440° C., or any range or subrange therebetween. In further aspects, the predetermined period of time can be 5 minutes or more, 10 minutes or more, 0.25 hours or more, 0.5 hours or more, 1 hour or more, 2 hours or more, 4 hours or more, 24 hours or less, 8 hours or less, 4 hours or less, 3 hours or less, or 2 hours or less. In aspects, the predetermined period of time can be in a range from greater than or equal to 5 minutes to less than or equal to 24 hours, from greater than or equal to 10 minutes to less than or equal to 24 hours, from greater than or equal to 0.25 hours to less than or equal to 8 hours, from greater than or equal to 0.5 hours to less than or equal to 8 hours, from greater than or equal to 1 hour to less than or equal to 4 hours, or any range or subrange therebetween. In aspects, the ion exchange process may include a second ion exchange treatment. In further aspects, the second ion exchange treatment may include ion exchanging the glass-based article in a second molten salt bath. The second ion exchange treatment may utilize any of the ion-exchange mediums described herein. In aspects, the second ion exchange treatment utilizes a second molten salt bath that includes KNO₃. As a result of the chemical strengthening in step 609, the glass-based article can have the compressive stress regions 811 and/or 821 (see FIG. 8), the maximum compressive stress, depth of compression, and/or central tension within one or more of the corresponding ranges discussed above.

After step 605, 607, or 609, methods can proceed to step 611. In aspects, step 611 can comprise assembling a display device (e.g., the consumer electronic device in FIGS. 1-2) comprising the natively colored glass-based substrate and/or natively colored glass-based article, for example, as part of the natively colored glass housing 500 shown in FIG. 5 and/or the natively colored glass housing 322 including glass article 350 shown in FIGS. 3-4. Alternatively or additionally, methods can be complete upon reaching step 611.

In aspects, methods of making a natively colored glass-based substrate and/or natively colored glass-based article in accordance with aspects of the disclosure can proceed along steps 601, 603, 605, 607, 609, and 611 of the flow chart in FIG. 6 sequentially, as discussed above. In aspects, arrow 602 can be followed from step 605 to step 611, for example, when methods are complete after forming the natively colored glass-based substrate. In aspects, arrow 604 can be followed from step 605 to step 609, for example, when the natively colored glass-based substrate is to be chemically strengthened without being cerammed (e.g., to form a natively colored glass article). In aspects, arrow 606 can be followed from step 508 to step 611, for example, if methods are complete at the end of step 507 (e.g., the natively colored glass-ceramic substrate is not to be chemically strengthened). Any of the above options may be combined to make a color converter sheet in accordance with aspects of the disclosure.

### Examples

Embodiments will be further clarified by the following examples. It should be understood that these examples are not limiting to the aspects described above. Glass-based compositions were prepared and analyzed. The analyzed glass compositions included the components listed in Tables I-X below and were prepared by conventional glass forming methods. As mentioned above, the compositions reported in Table I refers to the composition of the resulting glass-based substrate in mol %. The compositions reported in Tables II-X refers to the composition of the resulting glass-based substrate in wt % (which can be readily converted to mol %—as reported in Tables IIA-XA).

Table I presents the compositions, thermal conductivity, and electrical resistivity of Examples 1-6. As shown, the non-alkali metal components of Examples 1-6 are essentially the same. Consequently, the differences in properties (e.g., thermal conductivity) can be directly attributed to changes in the alkali metal identity (and/or ratios thereof). As shown, Examples 2-4 and 6 have higher thermal conductivity than Example 1, which is associated with an increase in the amount of non-lithium alkali metals (i.e., Na₂O+K₂O) and, consequently, an increase in the (Na₂O+K₂O)/R₂O ratio. Likewise, Example 5 has lower thermal conductivity relative to Example 1 due to a decrease in the amount of non-lithium alkali metals. At the same time, Examples 1-6 have essentially the same electrical resistivity. This indicates that the thermal conductivity can be increased without impacting electrical resistivity (e.g., heating and/or melting by resistance heating) through the addition of small amounts of non-lithium alkali (e.g., within the (Na₂O+K₂O)/R₂O ratio discussed above).

TABLE I

| Composition (wt %) | 1 | 2 | 3 | 4 | 5 | 6 |
|---|---|---|---|---|---|---|
| SiO₂ | 68.0 | 68.0 | 68.0 | 68.0 | 68.0 | 68.0 |
| Al₂O₃ | 3.09 | 3.09 | 3.09 | 3.09 | 3.09 | 3.09 |
| P₂O₅ | 1.0 | 1.0 | 1.0 | 1.0 | 1.0 | 1.0 |
| Li₂O | 23.536 | 23.222 | 23.381 | 23.302 | 23.043 | 23.451 |
| Na₂O | 0.028 | 0.042 | 0.056 | 0.028 | 0.025 | 0.145 |
| K₂O | 0.010 | 0.034 | 0.146 | 0.012 | 0.095 | 0.931 |
| MgO | 0.007 | 0.0013 | 0.009 | 0.0021 | 0.021 | 0.020 |
| CaO | 0.749 | 0.750 | 0.750 | 0.768 | 0.760 | 0.760 |
| ZrO₂ | 3.9 | 3.9 | 3.9 | 3.9 | 3.9 | 3.9 |
| SnO₂ | 0.02 | 0.02 | 0.02 | 0.02 | 0.02 | 0.02 |
| Fe₂O₃ | 0.02 | 0.02 | 0.02 | 0.02 | 0.02 | 0.02 |
| R₂O | 23.574 | 23.298 | 23.583 | 23.342 | 23.163 | 24.527 |
| (Na₂O + K₂O)/R₂O | 0.0016 | 0.0031 | 0.0083 | 0.0017 | 0.0050 | 0.0425 |
| Thermal Conductivity | 155 | 168 | 204 | 178 | 134 | 259 |
| K (W/m-K) (1600° C.) | | | | | | |
| Electrical Resistivity | 0.54 | 0.54 | 0.54 | 0.54 | 0.54 | 0.54 |
| (Ohm-cm) (1385° C.) | | | | | | |
| Electrical Resistivity | 0.59 | 0.59 | 0.59 | 0.59 | 0.59 | 0.59 |
| (Ohm-cm) (1420° C.) | | | | | | |

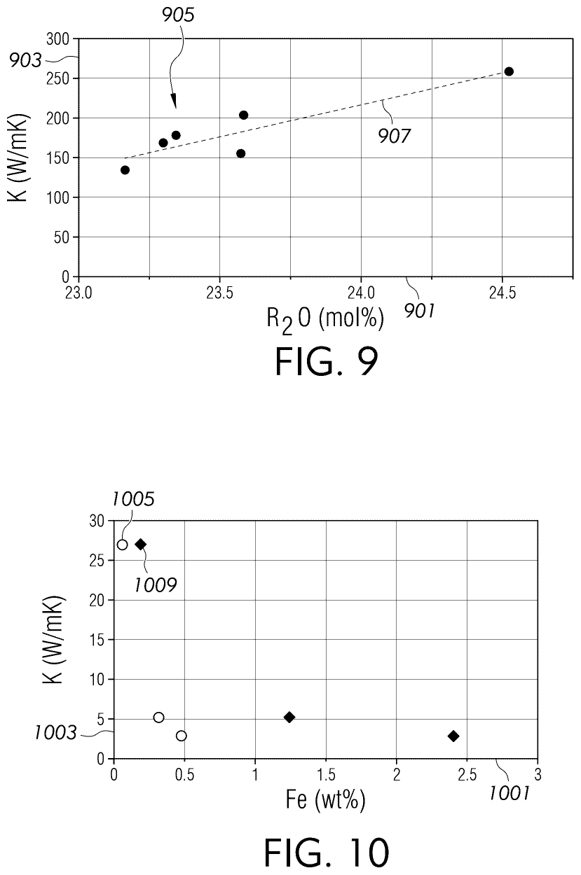

FIG. 9 presents a relationship between thermal conductivity (K) in W/m-K on the vertical axis 903 (i.e., y-axis) as a function of alkali metal oxide content (R₂O) in mol % on the horizontal axis 901 (i.e., x-axis) for Examples 1-6 (see Table I) plotted as points 905. As shown by line 907, there is a linear relationship between a total amount of alkali (for these examples with the specific ratios of non-lithium alkali metals to all alkali metals) and thermal conductivity. For these examples, as discussed above, the ratio (Na₂O+K₂O)/R₂O is also correlated with thermal conductivity.

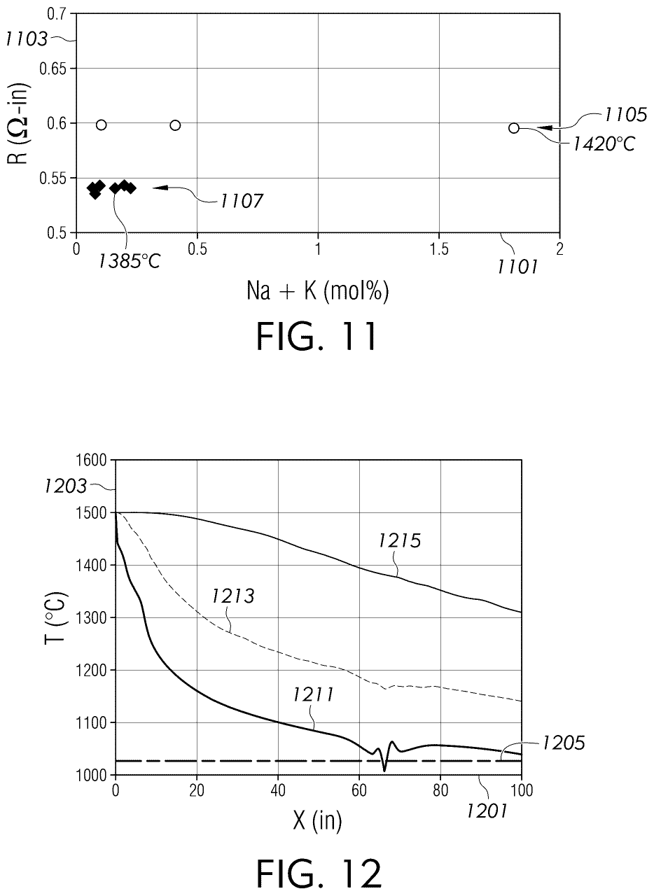

FIG. 11 presents a relationship between resistivity (R) in Ohm-in on the vertical axis 1103 (i.e., y-axis) (although the values are converted to Ohm-cm in Table I) as a function of sodium and potassium content (Na+K) in mol % on the horizontal axis 1101 (i.e., x-axis) for Examples 1-5. Points 1105 are for resistivity at 1420° C. while points 1107 are for resistivity at 1385° C. The sodium and potassium content corresponds to double the amount of sodium oxide and potassium oxide, respectively, reported in Table I since sodium oxide is associated with two sodium ions (and likewise for potassium in potassium oxide). At each temperature, Examples 1-6 have essentially the same electrical resistivity.

FIG. 10 schematically illustrates a relationship between thermal conductivity (K) in W/m-K on the vertical axis 1003 (i.e., y-axis) as a function of iron (Fe) in wt % on the horizontal axis 1001 (i.e., x-axis) for a natively colored glass-based substrate with base composition AA, nominally, 69.2 mol % SiO₂, 12.6 mol % Al₂O₃, 1.8 mol % B₂O₃, 7.7 mol % Li₂O, 0.4 mol % Na₂O, 2.9 mol % MgO, 1.7 mol % ZnO, 3.5 mol % TiO₂, and 0.1 mol % SnO₂. Various amounts of iron (Fe₂O₃) have been added to composition AA (as indicated in wt % on the horizontal axis 1001 of FIG. 10) to obtain a black color. Points 1005 correspond to the amount of Fe²⁺ only while points 1007 correspond to the total amount of iron (Fe₂O₃) for the same examples. As shown in FIG. 10, the thermal conductivity dramatically decreases as the amount of iron is increased. For example, the thermal conductivity decreases from about 27 W/m-K for about 0.2 wt % Fe₂O₃ to about 5 W/m-K (80% or more decrease) for about 1.2 wt % Fe₂O₃. While not shown, it is to be understood that the thermal conductivity for base composition AA (without any iron) would be much higher than that shown in FIG. 10 (e.g., about 100 W/m-K). Consequently, the addition of colorants (like iron) drastically reduces the thermal conductivity of the glass composition (e.g., glass melt).

FIG. 12 schematically shows modeled thermal profiles for base composition AA with 1.2 wt % Fe₂O₃ in a glass melter with temperature (T) in degrees Celsius on the vertical axis 1203 (i.e., y-axis) versus position (x) in inches (in) along a travel direction in the glass melter on the horizontal axis 1201 (i.e., x-axis). Horizonal line 1205 corresponds to a temperature of 1025° C., curve 1211 corresponds to the modeled temperature profile along the surface of the platinum melter, curve 1213 corresponds to the modeled temperature profile along the surface of the molten glass, and curve 1215 corresponds to the modeled temperature profile along a midline of the molten glass (furthest from the surface of the platinum melter). As shown, large thermal gradients (between points at the same location along the horizontal axis 1201 between curves 1215 and 1213) develop due to the low thermal conductivity (as discussed above with reference to FIG. 10). For example, a temperature difference of 200° C. is developed after traveling for 40 inches (about 1.0 meter). This demonstrates that low thermal conductivity can result in vastly different thermal histories for portions of molten glass at different positions within a glass manufacturing apparatus (e.g., glass melter).

Table II presents the composition, crystal phases, and CIE color coordinates for Examples AA and 6-11. While Examples 6-11 (and Examples 6-29 more generally) have ratios of (Na₂O+K₂O)/R₂O within the above-mentioned ranges, it is expected that the thermal conductivity of these examples could further be increased by increasing the value of this ratio, based on the trend observed above with reference to examples in Table I. Examples 6-7 include gold (Au) and iron (Fe), which produces a red color (positive CIE a* and CIE b* values). Examples 8-9 include cobalt (Co) and iron (Fe), which exhibits a blue color (positive CIE a* value, negative CIE b* value). Examples 10-11 include chrome (Cr) and cobalt (Co), which exhibits a green color (negative CIE a* value, negative CIE b* value).

TABLE II

| Composition | BB | 6 | 7 | 8 | 9 | 10 | 11 |
|---|---|---|---|---|---|---|---|
| SiO₂ | 74.35 | 74.03 | 73.89 | 73.66 | 73.33 | 73.69 | 73.14 |
| Al₂O₃ | 7.56 | 7.69 | 7.72 | 7.63 | 7.61 | 7.64 | 7.61 |
| P₂O₅ | 2.09 | 1.94 | 1.96 | 1.93 | 1.95 | 1.94 | 1.92 |
| Li₂O | 11.18 | 11.86 | 11.97 | 11.97 | 11.87 | 11.78 | 11.96 |
| Na₂O | 0.05 | 0.02 | 0.02 | 0.02 | 0.02 | 0.04 | 0.02 |
| K₂O | 0.12 | 0.03 | 0.03 | 0.03 | 0.03 | 0.03 | 0.03 |
| ZrO₂ | 4.31 | 4.36 | 4.34 | 4.30 | 4.31 | 4.34 | 4.29 |
| SnO₂ | 0.02 | 0.02 | 0.02 | 0.02 | 0.02 | 0.02 | 0.02 |
| Fe₂O₃ | 0 | 0.04 | 0.04 | 0.04 | 0.04 | 0.04 | 0.04 |
| Au | 0 | 0.02 | 0.03 | 0 | 0 | 0 | 0 |
| Co₃O₄ | 0 | 0 | 0 | 0.41 | 0.83 | 0 | 0 |
| Cr₂O₃ | 0 | 0 | 0 | 0 | 0 | 0.51 | 0.98 |
| CuO | 0 | 0 | 0 | 0 | 0 | 0 | 0 |
| R₂O | 11.35 | 11.91 | 12.02 | 12.02 | 11.92 | 11.85 | 12.01 |
| (Na₂O + K₂O)/ | 0.0150 | 0.0042 | 0.0042 | 0.0042 | 0.0042 | 0.0059 | 0.0042 |
| R₂O | | | | | | | |
| Crystal Phase | P, LS | P, LS | — | P, LS, | — | P, LS, | — |
| | | | | LMS | | LMS, C | |
| CIE L* | — | 67.37 | 64.31 | 34.32 | 19.70 | 44.80 | 18.83 |
| CIE a* | — | 32.98 | 36.27 | 25.78 | 49.45 | −10.05 | 0.01 |
| CIE b* | — | 3.07 | 1.10 | −89.67 | −99.29 | 14.00 | 27.37 |
| Appearance | Clear | Rose | Rose | Royal | Royal | Dark | Dark |
| | | Red | Red | Blue | Blue | Green | Green |

TABLE IIA

| Composition | BB | 6 | 7 | 8 | 9 | 10 | 11 |
|---|---|---|---|---|---|---|---|
| SiO₂ | 71.21 | 70.22 | 70.02 | 69.95 | 69.92 | 70.12 | 69.64 |
| Al₂O₃ | 4.27 | 4.30 | 4.31 | 4.27 | 4.28 | 4.28 | 4.27 |
| P₂O₅ | 0.85 | 0.78 | 0.79 | 0.78 | 0.79 | 0.78 | 0.77 |
| Li₂O | 21.53 | 22.62 | 22.81 | 22.86 | 22.76 | 22.54 | 22.90 |
| Na₂O | 0.046 | 0.018 | 0.018 | 0.018 | 0.018 | 0.037 | 0.018 |
| K₂O | 0.073 | 0.018 | 0.018 | 0.018 | 0.018 | 0.018 | 0.018 |
| ZrO₂ | 2.01 | 2.02 | 2.01 | 1.99 | 2.00 | 2.01 | 1.99 |
| SnO₂ | 0.01 | 0.01 | 0.01 | 0.01 | 0.01 | 0.01 | 0.01 |
| Fe₂O₃ | 0 | 0.015 | 0.015 | 0.015 | 0.015 | 0.015 | 0.015 |
| Au | 0 | 0.006 | 0.009 | 0 | 0 | 0 | 0 |
| Co₃O₄ | 0 | 0 | 0 | 0.10 | 0.20 | 0 | 0 |
| Cr₂O₃ | 0 | 0 | 0 | 0 | 0 | 0.19 | 0.37 |
| CuO | 0 | 0 | 0 | 0 | 0 | 0 | 0 |
| R₂O | 21.65 | 22.66 | 22.84 | 22.89 | 22.79 | 22.59 | 22.93 |
| (Na₂O + K₂O)/R₂O | 0.0055 | 0.0016 | 0.0016 | 0.0016 | 0.0016 | 0.0024 | 0.0016 |
| Crystal Phase | P, LS | P, LS | — | P, LS, LMS | — | P, LS, LMS, C | — |
| CIE L* | — | 67.37 | 64.31 | 34.32 | 19.70 | 44.80 | 18.83 |
| CIE a* | — | 32.98 | 36.27 | 25.78 | 49.45 | −10.05 | 0.01 |
| CIE b* | — | 3.07 | 1.10 | −89.67 | −99.29 | 14.00 | 27.37 |
| Appearance | Clear | Rose Red | Rose Red | Royal Blue | Royal Blue | Dark Green | Dark Green |

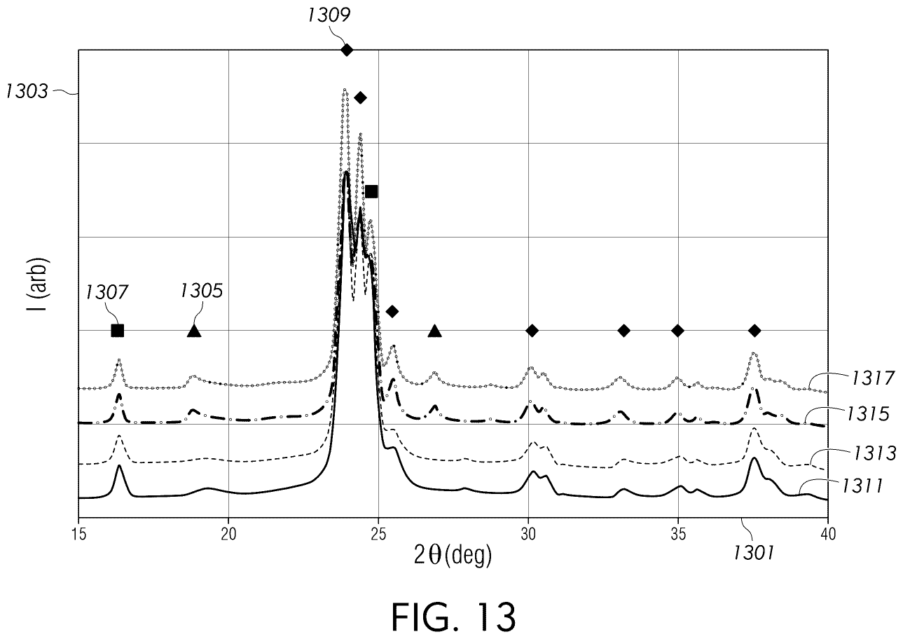

Examples BB-DD and 6-29 were heated to form a glass-ceramic. Unless otherwise indicated, the heating (e.g., ceramming) process comprised heating the natively colored glass-based substrate at 580° C. for 4 hours followed by 750° C. for 1 hour. In Tables II-IV, for the “crystal phases,” “P” refers to petalite, “LS” refers to lithium disilicate, “LMS” refers to lithium metasilicate, and “C” refers to cristobalite. The crystal phases were measured by X-ray diffractometry (XRD). Examples BB, 6, 8, and 10 were analyzed by XRD (see FIG. 13) while the analysis was not performed for Examples 6-11, although similar results are expected for those Examples as well. FIG. 13 presents scattering counts (intensity) on the vertical axis 1303 as a function of the double scattering angle (in degrees) on the horizontal axis 1301 for the glass-ceramics formed for Examples BB, 6, 8, and 10 with the curves vertically offset for readability. In FIG. 13, triangles 1305 mark peaks associated with lithium metasilicate, squares 1307 mark peaks associated with lithium disilicate, and diamonds 1309 mark peaks associated with petalite. Curve 1311 corresponds to Example BB, curve 1313 corresponds to Example 6, curve 1315 corresponds to Example 8, and curve 1317 corresponds to Example 10. As shown, the crystal peaks in these curves (and associated crystal structure in the underlying glass-ceramic) appears to be substantially the same. This indicates that the addition of these colorants does not impact the crystals and, therefore, the associated mechanical properties (e.g., fracture toughness).

Table III presents the composition and CIE color coordinates for Examples CC and 12-22. Examples 12-14 includes gold (Au), which produces a red color (positive CIE a* and CIE b* values). Examples 15-17 include copper, which exhibits a blue color. Examples 18-22 also exhibit a blue color, but include cobalt (Co) rather than copper.

Table IV presents the composition and CIE color coordinates for Examples DD and 23-29. Examples 23-25 includes gold (Au), which produces a red color (positive CIE a* and CIE b* values). Examples 26-29 include cobalt (Co), which exhibits a blue color.

TABLE III

| Composition | CC | 12 | 13 | 14 | 15 | 16 |
|---|---|---|---|---|---|---|
| SiO₂ | 71.81 | 71.51 | 71.58 | 71.65 | 71.69 | 71.72 |
| Al₂O₃ | 7.12 | 7.09 | 7.10 | 7.10 | 7.11 | 7.11 |
| P₂O₅ | 2.51 | 2.51 | 2.51 | 2.51 | 2.51 | 2.51 |
| Li₂O | 11.61 | 11.58 | 11.58 | 11.59 | 11.60 | 11.60 |
| Na₂O | 0.07 | 0.07 | 0.07 | 0.07 | 0.08 | 0.08 |
| K₂O | 0.12 | 0.11 | 0.11 | 0.11 | 0.11 | 0.11 |
| CaO | 0.70 | 0.70 | 0.70 | 0.70 | 0.70 | 0.70 |
| ZrO₂ | 6.00 | 5.97 | 5.97 | 5.98 | 5.98 | 5.98 |
| SnO₂ | 0.07 | 0.07 | 0.07 | 0.07 | 0.07 | 0.07 |
| Fe₂O₃ | 0.06 | 0.02 | 0.02 | 0.02 | 0.02 | 0.02 |
| Au | 0 | 0.34 | 0.26 | 0.17 | 0 | 0 |
| Co₃O₄ | 0 | 0 | 0 | 0 | 0 | 0 |
| Cr₂O₃ | 0 | 0 | 0 | 0 | 0 | 0 |
| CuO | 0 | 0 | 0 | 0 | 0.10 | 0.07 |
| R₂O | 11.80 | 11.76 | 11.76 | 11.77 | 11.79 | 11.79 |
| (Na₂O + K₂O)/R₂O | 0.0161 | 0.0153 | 0.0153 | 0.0153 | 0.0161 | 0.0161 |
| Appearance | Clear | Red | Red | Red | Sky Blue | Sky Blue |

| Composition | 17 | 18 | 19 | 20 | 21 | 22 |
|---|---|---|---|---|---|---|
| SiO₂ | 71.75 | 71.46 | 71.54 | 71.62 | 71.70 | 71.75 |
| Al₂O₃ | 7.11 | 7.09 | 7.09 | 7.10 | 7.10 | 7.11 |
| P₂O₅ | 2.51 | 2.50 | 2.51 | 2.51 | 2.51 | 2.51 |
| Li₂O | 11.60 | 11.57 | 11.58 | 11.59 | 11.59 | 11.60 |
| Na₂O | 0.08 | 0.07 | 0.07 | 0.07 | 0.08 | 0.08 |
| K₂O | 0.11 | 0.11 | 0.11 | 0.11 | 0.11 | 0.11 |
| CaO | 0.70 | 0.70 | 0.70 | 0.70 | 0.70 | 0.70 |
| ZrO₂ | 5.98 | 5.97 | 5.97 | 5.98 | 5.98 | 5.98 |
| SnO₂ | 0.07 | 0.07 | 0.07 | 0.07 | 0.07 | 0.07 |
| Fe₂O₃ | 0.02 | 0.02 | 0.02 | 0.02 | 0.02 | 0.02 |
| Au | 0 | 0 | 0 | 0 | 0 | 0 |
| Co₃O₄ | 0 | 0.42 | 0.31 | 0.21 | 0.10 | 0.04 |
| Cr₂O₃ | 0 | 0 | 0 | 0 | 0 | 0 |
| CuO | 0.03 | 0 | 0 | 0 | 0 | 0 |
| R₂O | 11.79 | 11.75 | 11.76 | 11.77 | 11.78 | 11.79 |
| (Na₂O + K₂O)/R₂O | 0.0161 | 0.0153 | 0.0153 | 0.0153 | 0.0161 | 0.0161 |
| Appearance | Pale Blue | Royal Blue | Royal Blue | Dark Blue | Blue | Blue |

TABLE IIIA

| Composition | CC | 12 | 13 | 14 | 15 | 16 |
|---|---|---|---|---|---|---|
| SiO₂ | 68.86 | 68.78 | 68.81 | 68.83 | 68.81 | 68.83 |
| Al₂O₃ | 4.02 | 4.02 | 4.02 | 4.02 | 4.02 | 4.02 |
| P₂O₅ | 1.02 | 1.02 | 1.02 | 1.02 | 1.02 | 1.02 |
| Li₂O | 22.39 | 22.39 | 22.38 | 22.39 | 22.39 | 22.38 |
| Na₂O | 0.07 | 0.07 | 0.07 | 0.07 | 0.07 | 0.07 |
| K₂O | 0.07 | 0.07 | 0.07 | 0.07 | 0.07 | 0.07 |
| CaO | 0.72 | 0.72 | 0.72 | 0.72 | 0.72 | 0.72 |
| ZrO₂ | 2.81 | 2.80 | 2.80 | 2.80 | 2.80 | 2.80 |
| SnO₂ | 0.03 | 0.03 | 0.03 | 0.03 | 0.03 | 0.03 |
| Fe₂O₃ | 0.02 | 0.01 | 0.01 | 0.01 | 0.01 | 0.01 |
| Au | 0 | 0.10 | 0.08 | 0.05 | 0 | 0 |
| Co₃O₄ | 0 | 0 | 0 | 0 | 0 | 0 |
| Cr₂O₃ | 0 | 0 | 0 | 0 | 0 | 0 |
| CuO | 0 | 0 | 0 | 0 | 0.07 | 0.05 |
| R₂O | 22.52 | 22.53 | 22.52 | 22.52 | 22.53 | 22.53 |
| (Na₂O + K₂O)/R₂O | 0.0061 | 0.0059 | 0.0059 | 0.0059 | 0.0063 | 0.0063 |
| Appearance | Clear | Red | Red | Red | Sky Blue | Sky Blue |

| Composition | 17 | 18 | 19 | 20 | 21 | 22 |
|---|---|---|---|---|---|---|
| SiO₂ | 68.86 | 68.78 | 68.80 | 68.82 | 68.86 | 68.87 |
| Al₂O₃ | 4.02 | 4.02 | 4.02 | 4.02 | 4.02 | 4.02 |
| P₂O₅ | 1.02 | 1.02 | 1.02 | 1.02 | 1.02 | 1.02 |
| Li₂O | 22.38 | 22.39 | 22.39 | 22.39 | 22.38 | 22.39 |
| Na₂O | 0.07 | 0.07 | 0.07 | 0.07 | 0.07 | 0.07 |
| K₂O | 0.07 | 0.07 | 0.07 | 0.07 | 0.07 | 0.07 |
| CaO | 0.72 | 0.72 | 0.72 | 0.72 | 0.72 | 0.72 |
| ZrO₂ | 2.80 | 2.80 | 2.80 | 2.80 | 2.80 | 2.80 |
| SnO₂ | 0.03 | 0.03 | 0.03 | 0.03 | 0.03 | 0.03 |
| Fe₂O₃ | 0.01 | 0.01 | 0.01 | 0.01 | 0.01 | 0.01 |
| Au | 0 | 0 | 0 | 0 | 0 | 0 |
| Co₃O₄ | 0 | 0.10 | 0.074 | 0.05 | 0.024 | 0.010 |
| Cr₂O₃ | 0 | 0 | 0 | 0 | 0 | 0 |
| CuO | 0.02 | 0 | 0 | 0 | 0 | 0 |
| R₂O | 22.53 | 22.52 | 22.53 | 22.53 | 22.52 | 22.53 |
| (Na₂O + K₂O)/R₂O | 0.0063 | 0.0059 | 0.0059 | 0.0059 | 0.0063 | 0.0063 |
| Appearance | Pale Blue | Royal Blue | Royal Blue | Dark Blue | Blue | Blue |

TABLE IV

| Composition | DD | 23 | 24 | 25 | 26 | 27 | 28 | 29 |
|---|---|---|---|---|---|---|---|---|
| SiO₂ | 69.51 | 69.30 | 69.37 | 69.43 | 69.24 | 69.33 | 69.41 | 69.49 |
| Al₂O₃ | 2.01 | 1.88 | 1.88 | 1.88 | 1.88 | 1.88 | 1.88 | 1.88 |
| P₂O₅ | 3.96 | 3.97 | 3.97 | 3.98 | 3.97 | 3.97 | 3.98 | 3.98 |
| Li₂O | 13.98 | 13.99 | 14.00 | 14.01 | 13.98 | 13.99 | 14.00 | 14.01 |
| Na₂O | 0.09 | 0.09 | 0.09 | 0.09 | 0.09 | 0.09 | 0.09 | 0.09 |
| K₂O | 0.19 | 0.18 | 0.18 | 0.18 | 0.18 | 0.18 | 0.18 | 0.18 |
| CaO | 1.60 | 1.60 | 1.60 | 1.60 | 1.60 | 1.60 | 1.60 | 1.60 |
| ZrO₂ | 8.48 | 8.51 | 8.52 | 8.52 | 8.51 | 8.51 | 8.52 | 8.53 |
| SnO₂ | 0.10 | 0.07 | 0.07 | 0.07 | 0.07 | 0.07 | 0.07 | 0.07 |
| Fe₂O₃ | 0.02 | 0.02 | 0.02 | 0.02 | 0.02 | 0.02 | 0.02 | 0.02 |
| Au | 0 | 0.35 | 0.26 | 0.17 | 0 | 0 | 0 | 0 |
| Co₃O₄ | 0 | 0 | 0 | 0 | 0.43 | 0.32 | 0.21 | 0.11 |
| Cr₂O₃ | 0 | 0 | 0 | 0 | 0 | 0 | 0 | 0 |
| CuO | 0 | 0 | 0 | 0 | 0 | 0 | 0 | 0 |
| TiO₂ | 0.03 | 0.15 | 0 | 0 | 0 | 0 | 0 | 0 |
| R₂O | 14.26 | 14.26 | 14.27 | 14.28 | 14.25 | 14.26 | 14.27 | 14.28 |
| (Na₂O + K₂O)/R₂O | 0.0196 | 0.0189 | 0.0189 | 0.0189 | 0.0189 | 0.0189 | 0.0189 | 0.0189 |
| Appearance | Clear | Red | Red | Red | Dark Blue | Dark Blue | Blue | Blue |

TABLE IVA

| Composition | DD | 23 | 24 | 25 | 26 | 27 | 28 | 29 |
|---|---|---|---|---|---|---|---|---|
| SiO₂ | 65.20 | 65.05 | 65.14 | 65.16 | 65.11 | 65.14 | 65.17 | 65.19 |
| Al₂O₃ | 1.11 | 1.04 | 1.04 | 1.04 | 1.04 | 1.04 | 1.04 | 1.04 |
| P₂O₅ | 1.57 | 1.58 | 1.58 | 1.58 | 1.58 | 1.58 | 1.58 | 1.58 |
| Li₂O | 26.37 | 26.40 | 26.43 | 26.44 | 26.43 | 26.43 | 26.43 | 26.43 |
| Na₂O | 0.08 | 0.08 | 0.08 | 0.08 | 0.08 | 0.08 | 0.08 | 0.08 |
| K₂O | 0.11 | 0.11 | 0.11 | 0.11 | 0.11 | 0.11 | 0.11 | 0.11 |
| CaO | 1.61 | .61 | 1.61 | 1.61 | 1.61 | 1.61 | 1.61 | 1.61 |
| ZrO₂ | 3.88 | 3.89 | 3.90 | 3.90 | 3.90 | 3.90 | 3.90 | 3.90 |
| SnO₂ | 0.04 | 0.03 | 0.03 | 0.03 | 0.03 | 0.03 | 0.03 | 0.03 |
| Fe₂O₃ | 0.0072 | 0.0072 | 0.0072 | 0.0072 | 0.0072 | 0.0072 | 0.0072 | 0.0072 |
| Au | 0 | 0.10 | 0.07 | 0.05 | 0 | 0 | 0 | 0 |
| Co₃O₄ | 0 | 0 | 0 | 0 | 0.10 | 0.075 | 0.05 | 0.026 |
| Cr₂O₃ | 0 | 0 | 0 | 0 | 0 | 0 | 0 | 0 |
| CuO | 0 | 0 | 0 | 0 | 0 | 0 | 0 | 0 |
| TiO₂ | 0.02 | 0.105 | 0 | 0 | 0 | 0 | 0 | 0 |
| R₂O | 26.56 | 26.59 | 26.62 | 26.63 | 26.62 | 26.62 | 26.62 | 26.62 |
| (Na₂O + K₂O)/R₂O | 0.0074 | 0.0071 | 0.0071 | 0.0071 | 0.0071 | 0.0071 | 0.0071 | 0.0071 |
| Appearance | Clear | Red | Red | Red | Dark Blue | Dark Blue | Blue | Blue |

Tables V-VI (and Tables V A-VI A) present the compositions, phase assemblage, and CIE color coordinates for Examples 30-44. Glass-based samples of Examples 30-44 were heated at 575° C. for 4 hours followed by 740° C. for 1 hour to form a glass-ceramic article. As reported in Tables V A and VI A, the molar ratio (Na₂O+K₂O)/R₂O for Examples 30-44 is within the range discussed above (e.g., here from 0.005 to 0.05, from 0.007 to 0.03; or, if excluding Examples 35-35, from 0.005 to 0.01 or from 0.007 to 0.008). Also, the Au (ppm) was measured by ICP in the final article while the Au row above refers to the amount of Au batched. As shown in Tables V and VI, the amount of Au (ppm) retained in the glass was from about 60% to about 95% of the amount batched (wt %) (e.g., from 64% to 75% excluding Examples 30-31 and 37). Consequently, it is to be understood that the amount of Au in the final article will generally be less than that batched (i.e., raw materials used to form that article). Also, Examples 30-44 have non-zero amounts of gold, manganese, titanium, and iron. Additionally, Examples 39 and 41-44 additionally have one of bismuth, nickel, cobalt, and tungsten.

For Tables V-VI (and Tables V A-VI A), the phase assemblage was measured by XRD (using Rietveld refinement, where the results may more accurately as a “Reitveld parameter” but will be used interchangeably with wt %). Examples 30-44 have less than 25 wt % (e.g., from 10% to 20 wt %) amorphous material in the glass-ceramic article. The crystal phases present in Examples 30-44 are lithium disilicate (Li₂Si₂O₅), petalite, and at least one of virgilite (a form of beta-quartz) and cristobalite. For these examples, petalite is the predominant crystalline phase (e.g., having from 40 wt % to 50 wt %). These examples have from about 30 wt % to 40 wt % lithium disilicate.

For Tables V-VI (and Tables V A-VI A), the CIE color coordinates were measured for the glass-ceramic articles having a thickness of 2.4 mm. For Examples 30-44, the CIE L* values are greater than 15 (e.g., from 25 to 75), the CIE a* are greater than 5 (and, when excluding Example 41, greater than or equal to 20), and absolute value of the CIE b* value is greater than 0.2 (and, when excluding Example 43, greater than or equal to 10). Also, Examples 30-44 have a sum of an absolute value of the CIE a* value and an absolute value of the CIE b* value (i.e., |a*|+|b*|) greater than or equal to 25. Also, Examples 32, 34-40 and 42-44 satisfy the relationship |a*|+|b*|>L*).

TABLE V

| Composition | 30 | 31 | 32 | 33 | 34 | 35 | 36 | 37 |
|---|---|---|---|---|---|---|---|---|
| SiO₂ | 73.42 | 74.93 | 73.66 | 73.75 | 73.26 | 72.91 | 72.71 | 76.71 |
| Al₂O₃ | 6.77 | 6.15 | 6.53 | 6.66 | 6.80 | 6.79 | 6.71 | 5.27 |
| P₂O₅ | 2.36 | 2.20 | 2.30 | 2.29 | 2.35 | 2.35 | 2.32 | 1.81 |
| Li₂O | 10.99 | 10.93 | 10.64 | 10.86 | 10.79 | 10.69 | 10.80 | 10.31 |
| Na₂O | 0.0881 | 0.0810 | 0.0822 | 0.0967 | 0.0846 | 0.5560 | 0.0823 | 0.0758 |
| K₂O | 0.1208 | 0.1241 | 0.1230 | 0.1126 | 0.1171 | 0.1121 | 0.8378 | 0.1213 |
| MgO | 0.020 | 0.014 | 0.018 | 0.020 | 0.017 | 0.019 | 0.019 | 0.027 |
| CaO | 0.69 | 0.59 | 0.67 | 0.70 | .071 | 0.71 | 0.70 | 1.67 |
| ZrO₂ | 5.45 | 4.90 | 5.24 | 5.32 | 5.45 | 5.44 | 5.39 | 4.18 |
| SnO₂ | 0.0008 | 0.0008 | 0.2248 | 0.0026 | 0.2254 | 0.2285 | 0.2300 | 0.1901 |
| Fe₂O₃ | 0.0478 | 0.0432 | 0.4652 | 0.1352 | 0.1394 | 0.1384 | 0.1372 | 0.1051 |
| Au | 0.0040 | 0.0076 | 0.0119 | 0.0079 | 0.0122 | 0.0136 | 0.0146 | 0.0096 |
| Au (ppm) | 37 | 56 | 77 | 57 | 78 | 89 | 99 | 84 |
| MnO₂ | 0.0185 | 0.0167 | 0.0181 | 0.0188 | 0.0191 | 0.0190 | 0.0190 | 0.0015 |
| TiO₂ | 0.0274 | 0.0241 | 0.0270 | 0.0275 | 0.0277 | 0.0273 | 0.0277 | 0.0218 |
| Amorphous (wt %) | 16.7 | 15.5 | 15.2 | 14.2 | 14.3 | 13.9 | 16.3 | 14.3 |
| Li₂Si₂O₅ (wt %) | 33.1 | 35.5 | 33.4 | 35.0 | 33.6 | 36.3 | 38.8 | 36.7 |
| Petalite (wt %) | 44.2 | 46.3 | 46.0 | 46.0 | 47.0 | 47.1 | 44.9 | 41.7 |
| Virgilite (wt %) | 4.3 | 2.7 | 4.2 | 4.1 | 4.3 | 1.4 | 0 | 7.3 |
| Cristobalite (wt %) | 1.8 | 0 | 1.2 | 0.7 | 0.8 | 1.2 | 0 | 0 |
| L* | 66.6 | 58.2 | 49.8 | 61.5 | 50.1 | 46.6 | 42.7 | 45.9 |
| a* | 31.4 | 37.9 | 31.2 | 29.1 | 28.1 | 32.2 | 38.8 | 30.3 |
| b* | 8.3 | 15.2 | 31.1 | 25.4 | 36.6 | 33.8 | 27.4 | 34.2 |

TABLE V A

| Composition | 30 | 31 | 32 | 33 | 34 | 35 | 36 | 37 |
|---|---|---|---|---|---|---|---|---|
| SiO₂ | 70.50 | 71.57 | 71.19 | 70.83 | 70.61 | 70.35 | 70.21 | 73.09 |
| Al₂O₃ | 3.83 | 3.46 | 3.72 | 3.77 | 3.86 | 3.86 | 3.82 | 2.96 |
| P₂O₅ | 0.96 | 0.89 | 0.94 | 0.93 | 0.96 | 0.96 | 0.95 | 0.73 |
| Li₂O | 21.21 | 20.99 | 20.67 | 20.97 | 20.92 | 20.74 | 20.96 | 19.76 |
| Na₂O | 0.082 | 0.075 | 0.077 | 0.090 | 0.079 | 0.52 | 0.077 | 0.070 |
| K₂O | 0.074 | 0.0756 | 0.0758 | 0.069 | 0.072 | 0.069 | 0.516 | 0.0737 |
| MgO | 0.029 | 0.020 | 0.026 | 0.028 | 0.025 | 0.027 | 0.027 | 0.038 |
| CaO | 0.71 | 0.60 | 0.69 | 0.72 | 0.73 | 0.73 | 0.72 | 1.19 |
| ZrO₂ | 2.55 | 2.28 | 2.47 | 2.49 | 2.56 | 2.56 | 2.54 | 1.94 |
| SnO₂ | 0.0003 | 0.0003 | 0.0866 | 0.0010 | 0.0866 | 0.0879 | 0.0885 | 0.0722 |
| Fe₂O₃ | 0.0176 | 0.01581 | 0.1724 | 0.0498 | 0.0515 | 0.0512 | 0.0508 | 0.0384 |
| Au | 0.00116 | 0.0022 | 0.0035 | 0.0023 | 0.0036 | 0.0040 | 0.0043 | 0.0028 |
| Au (ppm) | 37 | 56 | 77 | 57 | 78 | 89 | 99 | 84 |
| Ag | 0 | 0 | 0 | 0 | 0 | 0 | 0 | 0 |
| MnO₂ | 0.0123 | 0.0110 | 0.0121 | 0.0125 | 0.0127 | 0.0127 | 0.0127 | 0.0010 |
| TiO₂ | 0.01977 | 0.0173 | 0.0196 | 0.0199 | 0.0201 | 0.0198 | 0.0201 | 0.0156 |
| R₂O | 21.37 | 21.14 | 20.82 | 21.13 | 21.07 | 21.39 | 21.55 | 19.91 |
| (Na₂O + K₂O)/R₂O | 0.0073 | 0.0071 | 0.0073 | 0.0075 | 0.0072 | 0.0276 | 0.0275 | 0.0072 |
| Amorphous (wt %) | 16.7 | 15.5 | 15.2 | 14.2 | 14.3 | 13.9 | 16.3 | 14.3 |
| Li₂Si₂O₅ (wt %) | 33.1 | 35.5 | 33.4 | 35.0 | 33.6 | 36.3 | 38.8 | 36.7 |
| Petalite (wt %) | 44.2 | 46.3 | 46.0 | 46.0 | 47.0 | 47.1 | 44.9 | 41.7 |
| Virgilite (wt %) | 4.3 | 2.7 | 4.2 | 4.1 | 4.3 | 1.4 | 0 | 7.3 |
| Cristobalite (wt %) | 1.8 | 0 | 1.2 | 0.7 | 0.8 | 1.2 | 0 | 0 |
| L* | 66.6 | 58.2 | 49.8 | 61.5 | 50.1 | 46.6 | 42.7 | 45.9 |
| a* | 31.4 | 37.9 | 31.2 | 29.1 | 28.1 | 32.2 | 38.8 | 30.3 |
| b* | 8.3 | 15.2 | 31.1 | 25.4 | 36.6 | 33.8 | 27.4 | 34.2 |

TABLE VI

| Composition | 38 | 39 | 40 | 41 | 42 | 43 | 44 |
|---|---|---|---|---|---|---|---|
| SiO₂ | 73.78 | 73.55 | 73.31 | 73.54 | 73.45 | 73.78 | 73.22 |
| Al₂O₃ | 6.64 | 6.73 | 6.82 | 6.66 | 6.73 | 6.59 | 6.69 |
| P₂O₅ | 2.31 | 2.32 | 2.38 | 2.31 | 2.35 | 2.30 | 2.35 |
| Li₂O | 10.68 | 10.60 | 10.64 | 10.77 | 10.60 | 10.55 | 10.67 |
| Na₂O | 0.0872 | 0.0862 | 0.0900 | 0.0890 | 0.0876 | 0.0865 | 0.0874 |
| K₂O | 0.1138 | 0.1106 | 0.1157 | 0.1073 | 0.1207 | 0.1031 | 0.1143 |
| CaO | 0.0174 | 0.0188 | 0.0181 | 0.0174 | 0.0174 | 0.0201 | 0.0173 |
| ZrO₂ | 5.32 | 5.42 | 5.48 | 5.32 | 5.40 | 5.29 | 5.39 |
| SnO₂ | 0.16 | 0.23 | 0.23 | 0.24 | 0.23 | 0.23 | 0.23 |
| Fe₂O₃ | 0.1370 | 0.1375 | 0.1389 | 0.1378 | 0.1375 | 0.1367 | 0.1370 |
| Au | 0.0133 | 0.0132 | 0.0143 | 0 | 0.0143 | 0.1358 | 0 |
| Au (ppm) | 103 | 96 | 105 | 0 | 101 | 102 | 89 |
| Ag | 0.0017 | 0.0019 | 0.0017 | 0.0748 | 0.0019 | 0.0017 | 0.0019 |
| Co₃O₄ | 0 | 0 | 0 | 0 | 0 | 0.0369 | 0 |
| Bi₂O₃ | 0 | 0.0249 | 0 | 0 | 0 | 0 | 0 |
| WO₃ | 0 | 0 | 0 | 0 | 0 | 0 | 0.3552 |
| NiO | 0 | 0 | 0 | 0.0001 | 0.1188 | 0 | 0 |
| MnO₂ | 0.0189 | 0.0189 | 0.0190 | 0.186 | 0.0187 | 0.0187 | 0.0186 |
| TiO₂ | 0.0276 | 0.0280 | 0.0280 | 0.0283 | 0.0277 | 0.0273 | 0.0274 |
| Amorphous (wt %) | 14.5 | 17.4 | 16.7 | 16.7 | 15.3 | 13.2 | 15.8 |
| Li₂Si₂O₅ (wt %) | 34.3 | 32.5 | 34.2 | 32.2 | 33.2 | 35.9 | 33.8 |
| Petalite (wt %) | 46.4 | 44.4 | 43.9 | 44.8 | 43.3 | 46.2 | 46.0 |
| Virgilite (wt %) | 4.2 | 4.1 | 4.4 | 4.5 | 7.0 | 3.8 | 3.6 |
| Cristobalite (wt %) | 0.63 | 1.6 | 0.9 | 1.8 | 1.2 | 1.0 | 0.9 |
| L* | 43.7 | 49.5 | 41.8 | 46.1 | 30.8 | 25.3 | 47.4 |
| a* | 30.9 | 21.4 | 29.8 | 9.0 | 33.7 | 28.4 | 32.2 |
| b* | 30.0 | 31.8 | 34.4 | 20.1 | 27.9 | −0.3 | 30.2 |

TABLE VI A

| Composition | 38 | 39 | 40 | 41 | 42 | 43 | 44 |
|---|---|---|---|---|---|---|---|
| SiO₂ | 71.05 | 71.01 | 70.73 | 70.82 | 70.92 | 71.25 | 70.79 |
| Al₂O₃ | 3.77 | 3.83 | 3.88 | 3.78 | 3.83 | 3.75 | 3.81 |
| P₂O₅ | 0.94 | 0.95 | 0.97 | 0.94 | 0.96 | 0.94 | 0.96 |
| Li₂O | 20.68 | 20.57 | 20.65 | 20.86 | 20.58 | 20.49 | 20.74 |
| Na₂O | 0.08143 | 0.0807 | 0.0842 | 0.0831 | 0.0820 | 0.0810 | 0.0819 |
| K₂O | 0.0699 | 0.0681 | 0.0712 | 0.0659 | 0.0743 | 0.0635 | 0.0705 |
| MgO | 0.025 | 0.027 | 0.026 | 0.025 | 0.025 | 0.029 | 0.025 |
| CaO | 0.71 | 0.73 | 0.73 | 0.71 | 0.72 | 0.72 | 0.72 |
| ZrO₂ | 2.50 | 2.55 | 2.58 | 2.50 | 2.54 | 2.49 | 2.54 |
| SnO₂ | 0.061 | 0.0884 | 0.0894 | 0.0903 | 0.0875 | 0.0879 | 0.0892 |
| Fe₂O₃ | 0.0506 | 0.0509 | 0.0514 | 0.0509 | 0.0509 | 0.0506 | 0.0508 |
| Au | 0.0039 | 0.0039 | 0.0042 | 0 | 0.0042 | 0.040 | 0 |
| Au (ppm) | 103 | 96 | 105 | 0 | 101 | 102 | 89 |
| Ag | 0.0009 | 0.0010 | 0.0009 | 0.0401 | 0.0010 | 0.0009 | 0.0010 |
| Co₃O₄ | 0 | 0 | 0 | 0 | 0 | 0.0089 | 0 |
| Bi₂O₃ | 0 | 0.0031 | 0 | 0 | 0 | 0 | 0 |
| WO₃ | 0 | 0 | 0 | 0 | 0 | 0 | 0.0890 |
| NiO | 0 | 0 | 0 | 0.0001 | 0.0923 | 0 | 0 |
| MnO₂ | 0.0126 | 0.0126 | 0.0127 | 0.0124 | 0.0125 | 0.0125 | 0.0124 |
| TiO₂ | 0.0200 | 0.0203 | 0.0203 | 0.0205 | 0.0201 | 0.0198 | 0.0199 |
| R₂O | 20.83 | 20.72 | 20.80 | 21.01 | 20.73 | 20.64 | 20.90 |
| (Na₂O + K₂O)/R₂O | 0.0073 | 0.0072 | 0.0075 | 0.0071 | 0.0075 | 0.0070 | 0.0073 |
| Amorphous (wt %) | 14.5 | 17.4 | 16.7 | 16.7 | 15.3 | 13.2 | 15.8 |
| Li₂Si₂O₅ (wt %) | 34.3 | 32.5 | 34.2 | 32.2 | 33.2 | 35.9 | 33.8 |
| Petalite (wt %) | 46.4 | 44.4 | 43.9 | 44.8 | 43.3 | 46.2 | 46.0 |
| Virgilite (wt %) | 4.2 | 4.1 | 4.4 | 4.5 | 7.0 | 3.8 | 3.6 |
| Cristobalite (wt %) | 0.63 | 1.6 | 0.9 | 1.8 | 1.2 | 1.0 | 0.9 |
| L* | 43.7 | 49.5 | 41.8 | 46.1 | 30.8 | 25.3 | 47.4 |
| a* | 30.9 | 21.4 | 29.8 | 9.0 | 33.7 | 28.4 | 32.2 |
| b* | 30.0 | 31.8 | 34.4 | 20.1 | 27.9 | −0.3 | 30.2 |

Tables VII-VIII (and Tables VII A-VIII A) present the compositions, phase assemblage, and CIE color coordinates for Examples 45-59. Glass-based samples of Examples 45-59 were heated at 575° C. for 3 hours followed by 735° C. for 1 hour to form a glass-ceramic article. As reported in Tables VII A and VIII A, the molar ratio (Na₂O+K₂O)/R₂O for Examples 45-59 is within the range discussed above (e.g., here from 0.001 to 0.05, from 0.003 to 0.01, or even from 0.003 to 0.007). Also, the Au (ppm) was measured by ICP in the final article while the Au row above refers to the amount of Au batched. As shown in Tables VII and VIII, the amount of Au (ppm) retained in the glass was from about 75% to about 95% of the amount batched (wt %). Also, Examples 45-59 have non-zero amounts of gold, titanium, and iron. Additionally, Examples 51-59 additionally non-zero amounts of nickel.

For Tables VII-VIII (and Tables VII A-VIII A), the phase assemblage was measured by XRD (using Rietveld refinement, where the results may more accurately as a “Reitveld parameter” but will be used interchangeably with wt %). Examples 45-59 have less than 25 wt % (e.g., from 10% to 20 wt %) amorphous material in the glass-ceramic article. The crystal phases present in Examples 30-44 are lithium disilicate (Li₂Si₂O₅), petalite, virgilite (a form of beta-quartz), and optionally cristobalite. For these examples, petalite is the predominant crystalline phase (e.g., having from 40 wt % to 50 wt %). These examples have from about 30 wt % to 40 wt % lithium disilicate.

For Tables VII-VIII (and Tables VII A-VIII A), the CIE color coordinates were measured for the glass-ceramic articles having a thickness of 2.4 mm. For Examples 45-59, the CIE L* values are greater than 50 (e.g., from 50 to 90), the CIE a* values are greater than 20, and absolute value of the CIE b* value is greater than 2. Also, Examples 45-59 have a sum of an absolute value of the CIE a* value and an absolute value of the CIE b* value (i.e., |a*|+|b*|) greater than or equal to 25. Also, Example 50 satisfies the relationship |a*|+|b*|>L*).

TABLE VII

| Composition | 45 | 46 | 47 | 48 | 49 | 50 | 51 | 52 |
|---|---|---|---|---|---|---|---|---|
| SiO₂ | 72.65 | 72.12 | 72.66 | 68.19 | 72.41 | 72.78 | 73.59 | 74.79 |
| Al₂O₃ | 7.02 | 7.03 | 7.05 | 6.55 | 6.99 | 6.97 | 6.63 | 6.17 |
| P₂O₅ | 2.41 | 2.42 | 2.43 | 2.24 | 2.41 | 2.39 | 2.33 | 2.09 |
| Li₂O | 11.22 | 11.16 | 11.02 | 10.61 | 11.37 | 11.22 | 10.85 | 10.60 |
| Na₂O | 0.0230 | 0.0230 | 0.0230 | 0.0234 | 0.0249 | 0.0241 | 0.0309 | 0.0218 |
| K₂O | 0.1192 | 0.1236 | 0.1262 | 0.1098 | 0.1198 | 0.1203 | 0.1234 | 0.1198 |
| MgO | 0.028 | 0.027 | 0.030 | 0.024 | 0.032 | 0.029 | 0.025 | 0.024 |
| CaO | 0.73 | 0.73 | 0.73 | 0.69 | 0.73 | 0.72 | 0.66 | 0.62 |
| ZrO₂ | 5.64 | 5.76 | 5.77 | 11.37 | 5.73 | 5.56 | 5.59 | 5.54 |
| SnO₂ | 0.07 | 0.07 | 0.07 | 0.07 | 0.07 | 0.07 | 0.07 | 0.07 |
| Fe₂O₃ | 0.0492 | 0.4889 | 0.0490 | 0.0460 | 0.04894 | 0.0473 | 0.0439 | 0.0418 |
| Au | 0.0027 | 0.0044 | 0.0061 | 0.0067 | 0.0109 | 0.0146 | 0.0031 | 0.0020 |
| Au (ppm) | 23 | 33 | 41 | 51 | 69 | 101 | 23 | 25 |
| NiO | 0 | 0 | 0 | 0 | 0 | 0 | 0.0040 | 0.0030 |
| TiO₂ | 0.0270 | 0.0279 | 0.0290 | 0.0254 | 0.0269 | 0.0270 | 0.0249 | 0.0258 |
| Amorphous (wt %) | 15.2 | 17.1 | 15.5 | 15.7 | 16.7 | 16.0 | 16.5 | 15.7 |
| Li₂Si₂O₅ (wt %) | 36.9 | 36.4 | 36.7 | 37.0 | 37.1 | 36.8 | 35.3 | 34.6 |
| Petalite (wt %) | 45.9 | 43.8 | 45.5 | 45.1 | 44.3 | 44.3 | 43.8 | 43.7 |
| Virgilite (wt %) | 2.0 | 2.7 | 2.3 | 2.1 | 1.9 | 2.9 | 2.9 | 4.8 |
| Cristobalite (wt %) | 0 | 0 | 0 | 0 | 0 | 0 | 1.6 | 1.3 |
| L* | 75.9 | 64.5 | 61.5 | 60.6 | 58.8 | 51.4 | 70.0 | 67.4 |
| a* | 24.2 | 31.0 | 36.4 | 37.9 | 38.4 | 40.1 | 25.02 | 30.0 |
| b* | −3.9 | −12.5 | −5.7 | −0.7 | 15.8 | 25.5 | −7.1 | −2.0 |

TABLE VII A

| Composition | 45 | 46 | 47 | 48 | 49 | 50 | 51 | 52 |
|---|---|---|---|---|---|---|---|---|
| SiO₂ | 69.76 | 69.64 | 69.97 | 69.63 | 69.46 | 69.83 | 70.77 | 71.82 |
| Al₂O₃ | 3.97 | 4.00 | 4.00 | 3.94 | 3.95 | 3.94 | 3.76 | 3.49 |
| P₂O₅ | 0.98 | 0.99 | 0.99 | 0.97 | 0.98 | 0.97 | 0.95 | 0.85 |
| Li₂O | 21.66 | 21.67 | 21.33 | 21.78 | 21.94 | 21.65 | 20.99 | 20.47 |
| Na₂O | 0.0214 | 0.0215 | 0.0215 | 0.0232 | 0.0232 | 0.0224 | 0.0288 | 0.0203 |
| K₂O | 0.0730 | 0.0761 | 0.0775 | 0.0715 | 0.0733 | 0.0736 | 0.0757 | 0.0734 |
| MgO | 0.040 | 0.039 | 0.043 | 0.037 | 0.046 | 0.042 | 0.036 | 0.035 |
| CaO | 0.75 | 0.75 | 0.75 | 0.75 | 0.75 | 0.74 | 0.68 | 0.64 |
| ZrO₂ | 2.64 | 2.71 | 2.71 | 5.66 | 2.68 | 2.60 | 2.62 | 2.53 |
| HfO₂ | 0.02 | 0.02 | 0.02 | 0.02 | 0.02 | 0.02 | 0.02 | 0.02 |
| SnO₂ | 0 | 0 | 0 | 0 | 0 | 0 | 0 | 0 |
| Cl⁻ | 0.0278 | 0.0262 | 0.0279 | 0.0310 | 0.0358 | 0.0474 | 0.0228 | 0.0162 |
| SO₃ | 0 | 0 | 0 | 0.0252 | 0 | 0.0001 | 0 | 0 |
| Fe₂O₃ | 0.0181 | 0.181 | 0.0181 | 0.0180 | 0.0180 | 0.0174 | 0.0162 | 0.0154 |
| Au | 0.0008 | 0.0013 | 0.0018 | 0.0021 | 0.0032 | 0.0043 | 0.0009 | 0.0006 |
| Au (ppm) | 23 | 33 | 41 | 51 | 69 | 101 | 23 | 25 |
| NiO | 0 | 0 | 0 | 0 | 0 | 0 | 0.0031 | 0.0023 |
| TiO₂ | 0.0195 | 0.0203 | 0.0210 | 0.0195 | 0.0194 | 0.0195 | 0.0180 | 0.0186 |
| R₂O | 21.76 | 21.77 | 21.43 | 21.87 | 22.04 | 21.75 | 21.09 | 20.56 |
| (Na₂O + K₂O)/R₂O | 0.0043 | 0.0045 | 0.0046 | 0.0043 | 0.0044 | 0.0044 | 0.0050 | 0.0046 |
| Amorphous (wt %) | 15.2 | 17.1 | 15.5 | 15.7 | 16.7 | 16.0 | 16.5 | 15.7 |
| Li₂Si₂O₅ (wt %) | 36.9 | 36.4 | 36.7 | 37.0 | 37.1 | 36.8 | 35.3 | 34.6 |
| Petalite (wt %) | 45.9 | 43.8 | 45.5 | 45.1 | 44.3 | 44.3 | 43.8 | 43.7 |
| Virgilite (wt %) | 2.0 | 2.7 | 2.3 | 2.1 | 1.9 | 2.9 | 2.9 | 4.8 |
| Cristobalite (wt %) | 0 | 0 | 0 | 0 | 0 | 0 | 1.6 | 1.3 |
| L* | 75.9 | 64.5 | 61.5 | 60.6 | 58.8 | 51.4 | 70.0 | 67.4 |
| a* | 24.2 | 31.0 | 36.4 | 37.9 | 38.4 | 40.1 | 25.02 | 30.0 |
| b* | −3.9 | −12.5 | −5.7 | −0.7 | 15.8 | 25.5 | −7.1 | −2.0 |

TABLE VIII

| Composition | 53 | 54 | 55 | 56 | 57 | 58 | 59 |
|---|---|---|---|---|---|---|---|
| SiO₂ | 74.06 | 75.20 | 73.17 | 74.71 | 75.37 | 74.03 | 73.38 |
| Al₂O₃ | 6.61 | 5.85 | 6.90 | 6.25 | 5.85 | 6.73 | 6.47 |
| P₂O₅ | 2.26 | 2.05 | 2.38 | 2.13 | 2.00 | 2.30 | 2.27 |
| Li₂O | 10.60 | 10.74 | 10.81 | 10.41 | 11.69 | 10.41 | 10.76 |
| Na₂O | 0.0190 | 0.0167 | 0.0210 | 0.0198 | 0.0188 | 0.0210 | 0.0227 |
| K₂O | 0.1190 | 0.1232 | 0.1162 | 0.1189 | 0.1208 | 0.1132 | 0.1135 |
| MgO | 0.028 | 0.022 | 0.030 | 0.024 | 0.022 | 0.025 | 0.025 |
| CaO | 0.69 | 0.57 | 0.73 | 0.63 | 0.58 | 0.68 | 0.64 |
| ZrO₂ | 5.45 | 5.27 | 5.66 | 5.32 | 5.19 | 5.52 | 5.49 |
| HfO₂ | 0.07 | 0.07 | 0.07 | 0.07 | 0.07 | 0.07 | 0.07 |
| SnO₂ | 0 | 0 | 0 | 0 | 0 | 0 | 0 |
| Cl⁻ | 0.0140 | 0.0109 | 0.0160 | 0.0149 | 0.0099 | 0.0150 | 0.0148 |
| SO₃ | 0.0019 | 0 | 0 | 0 | 0 | 0 | 0.0069 |
| Fe₂O₃ | 0.0460 | 0.0376 | 0.0493 | 0.0446 | 0.0389 | 0.0462 | 0.0437 |
| Au | 0.0044 | 0.0010 | 0.0051 | 0.0061 | 0.0017 | 0.0037 | 0.0054 |
| Au (ppm) | 24 | 22 | 28 | 35 | 22 | 17 | 32 |
| NiO | 0.0040 | 0.0069 | 0.0090 | 0.0080 | 0.0109 | 0.0130 | 0.0129 |
| TiO₂ | 0.0271 | 0.0226 | 0.0280 | 0.2382 | 0.0228 | 0.0260 | 0.0257 |
| Amorphous (wt %) | 16.3 | 15.6 | 15.7 | 16.8 | 15.5 | 15.5 | 14.5 |
| Li₂Si₂O₅ (wt %) | 33.6 | 34.4 | 36.2 | 34.4 | 35.8 | 35.6 | 36.8 |
| Petalite (wt %) | 43.3 | 44.8 | 43.5 | 41.9 | 43.8 | 43.8 | 43.4 |
| Virgilite (wt %) | 4.8 | 6.5 | 3.1 | 4.7 | 3.4 | 3.6 | 4.3 |
| Cristobalite (wt %) | 2.0 | 1.7 | 1.6 | 2.2 | 1.5 | 1.4 | 1.0 |
| L* | 74.2 | 69.1 | 66.1 | 66.1 | 68.5 | 67.6 | 66.0 |
| a* | 21.0 | 21.2 | 31.2 | 31.2 | 24.4 | 26.4 | 30.2 |
| b* | 8.0 | −8.2 | 2.9 | 9.8 | −3.5 | −4.8 | 14.6 |

TABLE VIII A

| Composition | 53 | 54 | 55 | 56 | 57 | 58 | 59 |
|---|---|---|---|---|---|---|---|
| SiO₂ | 71.31 | 71.95 | 70.50 | 72.04 | 72.11 | 71.49 | 70.98 |
| Al₂O₃ | 3.75 | 3.30 | 3.92 | 3.55 | 3.30 | 3.83 | 3.69 |
| P₂O₅ | 0.92 | 0.83 | 0.97 | 0.87 | 0.81 | 0.94 | 0.93 |
| Li₂O | 20.52 | 20.67 | 20.95 | 20.18 | 20.56 | 20.21 | 20.92 |
| Na₂O | 0.0177 | 0.0155 | 0.0196 | 0.0185 | 0.0174 | 0.0197 | 0.0213 |
| K₂O | 0.0731 | 0.0752 | 0.0714 | 0.0731 | 0.0737 | 0.0697 | 0.0700 |
| MgO | 0.040 | 0.031 | 0.043 | 0.034 | 0.032 | 0.036 | 0.036 |
| CaO | 0.71 | 0.58 | 0.75 | 0.65 | 0.59 | 0.70 | 0.66 |
| ZrO₂ | 2.56 | 2.46 | 2.66 | 2.50 | 2.42 | 2.60 | 2.59 |
| HfO₂ | 0.02 | 0.02 | 0.02 | 0.02 | 0.02 | 0.02 | 0.2 |
| SnO₂ | 0 | 0 | 0 | 0 | 0 | 0 | 0 |
| Cl⁻ | 0.0229 | 0.0176 | 0.0262 | 0.0244 | 0.0161 | 0.0246 | 0.0243 |
| SO₃ | 0.0014 | 0 | 0 | 0 | 0 | 0 | 0.0050 |
| Fe₂O₃ | 0.0170 | 0.0138 | 0.0182 | 0.0165 | 0.0143 | 0.0171 | 0.0162 |
| Au | 0.0013 | 0.0003 | 0.0015 | 0.0018 | 0.0005 | 0.0011 | 0.0016 |
| Au (ppm) | 24 | 22 | 28 | 35 | 22 | 17 | 32 |
| NiO | 0.0031 | 0.0053 | 0.0070 | 0.0062 | 0.0084 | 0.0101 | 0.0100 |
| TiO₂ | 0.0196 | 0.0163 | 0.0203 | 0.180 | 0.0164 | 0.0189 | 0.0187 |
| R₂O | 20.61 | 20.76 | 21.04 | 20.27 | 20.66 | 20.30 | 21.01 |
| (Na₂O + K₂O)/R₂O | 0.0044 | 0.0044 | 0.0043 | 0.0045 | 0.0044 | 0.0044 | 0.0043 |
| Amorphous (wt %) | 16.3 | 15.6 | 15.7 | 16.8 | 15.5 | 15.5 | 14.5 |
| Li₂Si₂O₅ (wt %) | 33.6 | 34.4 | 36.2 | 34.4 | 35.8 | 35.6 | 36.8 |
| Petalite (wt %) | 43.3 | 44.8 | 43.5 | 41.9 | 43.8 | 43.8 | 43.4 |
| Virgilite (wt %) | 4.8 | 6.5 | 3.1 | 4.7 | 3.4 | 3.6 | 4.3 |
| Cristobalite (wt %) | 2.0 | 1.7 | 1.6 | 2.2 | 1.5 | 1.4 | 1.0 |
| L* | 74.2 | 69.1 | 66.1 | 66.1 | 68.5 | 67.6 | 66.0 |
| a* | 21.0 | 21.2 | 31.2 | 31.2 | 24.4 | 26.4 | 30.2 |
| b* | 8.0 | −8.2 | 2.9 | 9.8 | −3.5 | −4.8 | 14.6 |

Tables IX-X (and Tables IX-X A) present the compositions, phase assemblage, and CIE color coordinates for Examples 60-71. Glass-based samples of Examples 60-71 were heated at 585° C. for 2.5 hours followed by 735° C. for 1 hour to form a glass-ceramic article. As reported in Tables IX A and X A, the molar ratio (Na₂O+K₂O)/R₂O for Examples 60-71 is within the range discussed above (e.g., here from 0.001 to 0.05, from 0.003 to 0.01, or even from 0.003 to 0.007). These examples did not contain gold (Au). Instead, Examples 60-71 comprises nonzero-amounts of chromium. Additionally, Examples 60-67 have non-zero amount of cobalt; Examples 66 and 68-71 have non-zero amounts of copper; Example 67 has a non-zero amount of manganese; Examples 64 and 6-71 have non-zero amounts of titanium.

For Tables IX-X (and Tables IX A-X A), the phase assemblage was measured by XRD (using Rietveld refinement, where the results may more accurately as a “Reitveld parameter” but will be used interchangeably with wt %). Examples 60-71 have less than 25 wt % (e.g., from 10% to 25 wt %) amorphous material in the glass-ceramic article. The crystal phases present in Examples 60-71 are lithium disilicate (Li₂Si₂O₅), petalite, cristobalite, and optionally virgilite (a form of beta-quartz). For these examples, petalite is the predominant crystalline phase (e.g., having from 40 wt % to 60 wt %). These examples have from about 15 wt % to 30 wt % lithium disilicate.

For Tables IX-X (and Tables IX A-X A), the CIE color coordinates were measured for the glass-ceramic articles having a thickness of 2.4 mm. For Examples 60-71, the CIE L* values are greater than 15 (e.g., when excluding Example 67, from 30 to 75), an absolute value of the CIE a* values is greater than 0.5 (e.g., when excluding Examples 60 and 67, greater than or equal to 5), and absolute value of the CIE b* value is greater than 0.2 (e.g., when excluding Examples 69-70, greater than or equal to 5). Also, Examples 60-71 have a sum of an absolute value of the CIE a* value and an absolute value of the CIE b* value (i.e., |a*|+|b*|) greater than or equal to 10. Also, Examples 61-67 satisfies the relationship |a*|+|b*|>L*).

TABLE IX

| Composition | 60 | 61 | 62 | 63 | 64 | 65 | 66 |
|---|---|---|---|---|---|---|---|
| SiO₂ | 72.22 | 72.11 | 71.99 | 72.01 | 71.92 | 71.88 | 71.81 |
| Al₂O₃ | 7.17 | 7.14 | 7.16 | 7.16 | 7.16 | 7.15 | 7.15 |
| P₂O₅ | 2.47 | 2.46 | 2.46 | 2.46 | 2.45 | 2.42 | 2.46 |
| Li₂O | 11.50 | 11.50 | 11.50 | 11.50 | 11.50 | 11.50 | 11.50 |
| Na₂O | 0.038 | 0.039 | 0.05 | 0.039 | 0.044 | 0.041 | 0.039 |
| K₂O | 0.126 | 0.131 | 0.129 | 0.123 | 0.122 | 0.127 | 0.123 |
| MgO | 0.028 | 0.029 | 0.031 | 0.027 | 0.027 | 0.026 | 0.029 |
| CaO | 0.73 | 0.74 | 0.73 | 0.73 | 0.73 | 0.73 | 0.73 |
| ZrO₂ | 5.80 | 5.83 | 5.82 | 5.83 | 5.80 | 5.81 | 5.80 |
| SnO₂ | 0 | 0 | 0 | 0 | 0 | 0 | 0 |
| Fe₂O₃ | 0.0510 | 0.0510 | 0.0510 | 0.0500 | 0.0510 | 0.0500 | 0.0500 |
| Au | 0 | 0 | 0 | 0 | 0 | 0 | 0 |
| Co₃O₄ | 0.0470 | 0.0730 | 0.0980 | 0.1470 | 0.0970 | 0.0980 | 0.0970 |
| Cr₂O₃ | 0.0010 | 0.0010 | 0.0010 | 0.00010 | 0.0970 | 0.143 | 0.192 |
| CuO | 0 | 0 | 0 | 0 | 0 | 0 | 0.0500 |
| TiO₂ | 0 | 0 | 0 | 0 | 0.0010 | 0 | 0 |
| Amorphous (wt %) | 20.5 | 18.2 | 14.9 | 20.0 | 17.1 | 16.4 | 17.7 |
| Li₂Si₂O₅ (wt %) | 26.1 | 20.0 | 22.6 | 26.3 | 21.5 | 21.9 | 20.3 |
| Petalite (wt %) | 48.0 | 52.2 | 54.3 | 48.8 | 51.5 | 52.5 | 51.9 |
| Virgilite (wt %) | 0 | 0 | 0.4 | 0.9 | 1.0 | 0 | 0 |
| Cristobalite (wt %) | 5.4 | 7.8 | 6.3 | 4.1 | 7.2 | 7.2 | 7.8 |
| L* | 66.0 | 55.0 | 46.0 | 34.7 | 37.4 | 35.3 | 30.7 |
| a* | 0.6 | 5.5 | 11.7 | 23.5 | 6.5 | −5.5 | −10.5 |
| b* | −44.4 | −62.4 | −75.6 | −89.0 | −63.2 | −42.9 | −33.2 |

TABLE IX A

| Composition | 60 | 61 | 62 | 63 | 64 | 65 | 66 |
|---|---|---|---|---|---|---|---|
| SiO₂ | 69.17 | 69.12 | 69.08 | 69.09 | 69.05 | 69.04 | 68.97 |
| Al₂O₃ | 4.05 | 4.03 | 4.05 | 4.05 | 4.05 | 4.05 | 4.05 |
| P₂O₅ | 1.00 | 1.00 | 1.00 | 1.00 | 1.00 | 0.98 | 1.00 |
| Li₂O | 22.15 | 22.17 | 22.19 | 22.18 | 22.20 | 22.21 | 22.21 |
| Na₂O | 0.0353 | 0.0362 | 0.0465 | 0.0363 | 0.0410 | 0.0382 | 0.0363 |
| K₂O | 0.0770 | 0.0800 | 0.0789 | 0.0753 | 0.0747 | 0.0778 | 0.0753 |
| MgO | 0.0400 | 0.041 | 0.044 | 0.039 | 0.039 | 0.037 | 0.042 |
| CaO | 0.75 | 0.76 | 0.75 | 0.75 | 0.75 | 0.75 | 0.75 |
| ZrO₂ | 2.71 | 2.72 | 2.72 | 2.73 | 2.72 | 2.72 | 2.72 |
| SnO₂ | 0 | 0 | 0 | 0 | 0 | 0 | 0 |
| Fe₂O₃ | 0.0187 | 0.0187 | 0.0188 | 0.0184 | 0.0188 | 0.0184 | 0.0184 |
| Au | 0 | 0 | 0 | 0 | 0 | 0 | 0 |
| Co₃O₄ | 0.0112 | 0.0175 | 0.0235 | 0.0352 | 0.0232 | 0.0235 | 0.0232 |
| Cr₂O₃ | 0.0004 | 0.0004 | 0.0004 | 0.0001 | 0.0368 | 0.0543 | 0.0729 |
| CuO | 0 | 0 | 0 | 0 | 0 | 0 | 0.0363 |
| TiO₂ | 0 | 0 | 0 | 0 | 0.0007 | 0 | 0 |
| R₂O | 22.26 | 22.28 | 22.31 | 22.30 | 22.32 | 22.33 | 22.32 |
| (Na₂O + K₂O)/R₂O | 0.0050 | 0.0052 | 0.0056 | 0.0050 | 0.0052 | 0.0052 | 0.0050 |
| Amorphous (wt %) | 20.5 | 18.2 | 14.9 | 20.0 | 17.1 | 16.4 | 17.7 |
| Li₂Si₂O₅ (wt %) | 26.1 | 20.0 | 22.6 | 26.3 | 21.5 | 21.9 | 20.3 |
| Petalite (wt %) | 48.0 | 52.2 | 54.3 | 48.8 | 51.5 | 52.5 | 51.9 |
| Virgilite (wt %) | 0 | 0 | 0.4 | 0.9 | 1.0 | 0 | 0 |
| Li₂SiO₃ (wt %) | 5.4 | 7.8 | 6.3 | 4.1 | 7.2 | 7.2 | 7.8 |
| L* | 66.0 | 55.0 | 46.0 | 34.7 | 37.4 | 35.3 | 30.7 |
| a* | 0.6 | 5.5 | 11.7 | 23.5 | 6.5 | −5.5 | −10.5 |
| b* | −44.4 | −62.4 | −75.6 | −89.0 | −63.2 | −42.9 | −33.2 |

TABLE X

| Composition | 67 | 68 | 69 | 70 | 71 |
|---|---|---|---|---|---|
| SiO₂ | 71.67 | 71.95 | 71.50 | 71.77 | 71.53 |
| Al₂O₃ | 7.16 | 7.13 | 7.14 | 7.17 | 7.16 |
| P₂O₅ | 2.45 | 2.44 | 2.44 | 2.45 | 2.44 |
| Li₂O | 11.50 | 11.50 | 11.50 | 11.50 | 11.50 |
| Na₂O | 0.039 | 0.042 | 0.043 | 0.038 | 0.040 |
| K₂O | 0.126 | 0.123 | 0.124 | 0.125 | 0.126 |
| MgO | 0.031 | 0.027 | 0.028 | 0.025 | 0.027 |
| CaO | 0.73 | 0.73 | 0.73 | 0.73 | 0.74 |
| ZrO₂ | 5.78 | 5.84 | 5.80 | 5.83 | 5.81 |
| SnO₂ | 0 | 0 | 0 | 0 | 0 |
| Fe₂O₃ | 0.0490 | 0.0500 | 0.0490 | 0.0500 | 0.0500 |
| Au | 0 | 0 | 0 | 0 | 0 |
| Co₃O₄ | 0.1960 | 0 | 0 | 0 | 0 |
| Cr₂O₃ | 0.1920 | 0.1910 | 0.5710 | 0.1920 | 0.2870 |
| CuO | 0 | 0.0170 | 0.0320 | 0.2130 | 0.2160 |
| MnO₂ | 0.0150 | 0 | 0 | 0 | 0 |
| TiO₂ | 0.0280 | 0.0280 | 0.0270 | 0.270 | 0.0280 |
| Amorphous | 16.2 | 21.5 | 20.2 | 15.5 | 16.8 |
| (wt %) | | | | | |
| Li₂Si₂O₅ | 21.8 | 24.2 | 18.9 | 23.4 | 23.0 |
| (wt %) | | | | | |
| Petalite | 54.8 | 48.2 | 51.0 | 52.0 | 50.1 |
| (wt %) | | | | | |
| Virgilite | 0 | 0 | 0 | 1.1 | 1.3 |
| (wt %) | | | | | |
| Cristobalite | 5.6 | 6.1 | 7.7 | 6.7 | 7.4 |
| (wt %) | | | | | |
| L* | 15.6 | 67.2 | 62.8 | 51.3 | 42.6 |
| a* | 3.3 | −14.2 | −13.3 | −18.8 | −21.7 |
| b* | −50.9 | 11.8 | −0.7 | −0.2 | 6.5 |

TABLE IX A

| Composition | 67 | 68 | 69 | 70 | 71 |
|---|---|---|---|---|---|
| SiO₂ | 68.39 | 69.05 | 68.81 | 68.88 | 68.79 |
| Al₂O₃ | 4.06 | 4.03 | 4.05 | 4.06 | 4.06 |
| P₂O₅ | 1.00 | 0.99 | 0.99 | 1.00 | 0.99 |
| Li₂O | 22.24 | 22.19 | 22.25 | 22.19 | 22.24 |
| Na₂O | 0.0364 | 0.0391 | 0.0401 | 0.0354 | 0.0373 |
| K₂O | 0.0773 | 0.0753 | 0.0761 | 0.0765 | 0.0773 |
| MgO | 0.044 | 0.039 | 0.040 | 0.036 | 0.039 |
| CaO | 0.75 | 0.75 | 0.075 | 0.075 | 0.76 |
| ZrO₂ | 2.71 | 2.73 | 2.72 | 2.73 | 2.72 |
| SnO₂ | 0 | 0 | 0 | 0 | 0 |
| Fe₂O₃ | 0.0181 | 0.0184 | 0.0181 | 0.0184 | 0.0184 |
| Au | 0 | 0 | 0 | 0 | 0 |
| Co₃O₄ | 0.0470 | 0 | 0 | 0 | 0 |
| Cr₂O₃ | 0.0730 | 0.0725 | 0.2172 | 0.0728 | 0.1091 |
| CuO | 0 | 0.0123 | 0.0233 | 0.1544 | 0.1569 |
| MnO₂ | 0.0100 | 0 | 0 | 0 | 0 |
| TiO₂ | 0.0203 | 0.0202 | 0.0195 | 0.1949 | 0.0203 |
| R₂O | 22.35 | 22.30 | 22.37 | 22.31 | 22.35 |
| (Na₂O + | 0.0051 | 0.0051 | 0.0052 | 0.0050 | 0.0051 |
| K₂O)/R₂O | | | | | |
| Amorphous | 16.2 | 21.5 | 20.2 | 15.5 | 16.8 |
| (wt %) | | | | | |
| Li₂Si₂O₅ | 21.8 | 24.2 | 18.9 | 23.4 | 23.0 |
| (wt %) | | | | | |
| Petalite | 54.8 | 48.2 | 51.0 | 52.0 | 50.1 |
| (wt %) | | | | | |
| Virgilite | 0 | 0 | 0 | 1.1 | 1.3 |
| (wt %) | | | | | |
| Li₂SiO₃ | 5.6 | 6.1 | 7.7 | 6.7 | 7.4 |
| (wt %) | | | | | |
| L* | 15.6 | 67.2 | 62.8 | 51.3 | 42.6 |
| a* | 3.3 | −14.2 | −13.3 | −18.8 | −21.7 |
| b* | −50.9 | 11.8 | −0.7 | −0.2 | 6.5 |

The above observations can be combined to produce natively colored glass-based articles with high fracture toughness and/or high thermal conductivity. Chemical strengthening processes can be used to achieve high strength and high toughness properties. Also, the natively colored glass-based articles include glass-ceramics (e.g., including petalite and/or lithium disilicate crystal phases) can have increased fracture toughness relative to glass substrates. The natively colored glass-based material disclosed herein can provide good dimensional stability, good impact resistance, good crack resistance, good puncture resistance, and/or good flexural strength. The natively colored glass-based article can include a compressive stress region (e.g., be chemically strengthened), which can provide improved crack resistance, puncture resistance, impact resistance, and/or improved flexural strength. Also, minimizing the combination of R₂O, CaO, MgO, and ZnO in the glass composition may provide the resultant colored glass article with a desirable dielectric constant, for example when the colored glass article is used as a portion of a housing for an electronic device. Providing a dielectric constant for frequencies from 10 GHz to 60 GHz from 5.6 to 6.4 can allow wireless communication through the glass article.

Natively colored glass-based substrates, articles, and/or housings including the same include at least one colorant. A predetermined color of the glass article and/or natively colored glass can be achieved by controlling an amount and identity of the colorant. The examples demonstrate that the one or more colorants (e.g., gold, copper, cobalt, chromium) can be added without impairing the mechanical properties of the corresponding article. Providing a natively colored glass housing with a colored glass article can eliminate the need for an additional layer to impart color to the housing, which can simplify assembly and provide a more consistent color. Consequently, the natively colored glass housing including the glass article can provide an aesthetically pleasing appearance (e.g., color) while simultaneously protecting an electronic device from damage and/or permitting wireless communication therethrough.

As discussed herein, the inventors have unexpectedly determined that the addition of low amounts of other alkali metal oxides (e.g., sodium oxide, potassium oxide), for example in predetermined ratios, can improve the heat transfer properties of the corresponding glass melt. In particular, the colorants used to obtain natively colored glass-based articles can decrease radiative heat transfer of the corresponding glass melt, which can pose processing problems (e.g., increased thermal gradients leading to inhomogeneity and/or limitations on throughput). By increasing the radiative heat transfer, these problems can be mitigated without impairing a meltability, appearance, or potential crystal structures in the resulting natively colored article. Until the work of the present inventors, it is believed that the impact of various alkali metal oxides on heat transfer (e.g., radiative), especially for colored glass-based melts, had not been investigated or understood. For example, adding relatively small amounts of larger alkali metal oxides (e.g., Na₂O+K₂O) can increase radiative thermal transfer (e.g., of colored glass-based melts) without significantly impacting resistivity, ion-exchangeability, and/or associated crystal phases (e.g., in the case of glass-ceramics). Moreover, it is believed that it was not possible to reliably quantify radiative heat transfer coefficients at (or near) temperatures of glass melts; consequently, the relationship between non-lithium alkali metal oxides and radiative heat transfer coefficient could not have been appreciated, especially for low amounts of non-lithium alkali metal oxides relative to a total amount of alkali metal oxides.

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed.

also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A natively colored glass-based article comprising a composition, based on 100 mol % of the composition, comprising:
from greater than or equal to 55.0 mol % to less than or equal to 80.0 mol % SiO₂;
from greater than or equal to 10.0 mol % to less than or equal to 30 mol % L₂O;
from greater than or equal to 0.01 mol % to less than or equal to 5.0 mol % Na₂O;
from greater than or equal to 0.01 mol % to less than or equal to 5.0 mol % K₂O; and
from greater than or equal to 0.0005 mol % to less than or equal to 5.0 mol % of one or more colorants, the one or more colorants includes silver, gold, copper, NiO, Cr₂O₃, Co₃O₄, MnO₂, or combinations thereof,
wherein a molar ratio (Na₂O+K₂O)/(Li₂O+Na₂O+K₂O) is from greater than or equal to 0.0015 to less than or equal to 0.10.

2. The natively colored glass-based article of claim 1, wherein the composition further comprises:
from greater than or equal to 0.5 mol % to less than or equal to 8.0 mol % P₂O₅; and
from greater than or equal to 3.0 mol % to less than or equal to 10.0 mol % ZrO₂.

3. The natively colored glass-based article of claim 1, wherein the composition further comprises:
from greater than or equal to 0.0 mol % to less than or equal to 20.0 mol % Al₂O₃;
from greater than or equal to 0.0 mol % to less than or equal to 4.0 mol % B₂O₃; and
from greater than or equal to 0.0 mol % to less than or equal to 3 mol % CaO.

4. The natively colored glass-based article of claim 1, wherein the composition comprises from greater than or equal to 13.0 mol % to less than or equal to 30.0 mol % of a total amount of L₂O, Na₂O, and K₂O.

5. The natively colored glass-based article of claim 1, wherein the composition comprises:
from greater than or equal to 0.02 mol % to less than or equal to 3.0 mol % Na₂O; and
from greater than or equal to 0.03 mol % to less than or equal to 2.0 mol % K₂O.

6. The natively colored glass-based article of claim 1, wherein the molar ratio (Na₂O+K₂O)/(Li₂O+Na₂O+K₂O) is from greater than or equal to 0.005 to less than or equal to 0.10.

7. The natively colored glass-based article of claim 1, wherein the natively colored glass-based article exhibits:
a CIE L* value from greater than or equal to 15 to less than or equal to 90;
a CIE a* value from greater than or equal to −75 to less than or equal to 75; and
an absolute value of a CIE b* value from greater than or equal to 5.0 to less than or equal to 100.

8. The natively colored glass-based article of claim 7, wherein a sum of an absolute value of CIE a* value and an absolute value of the CIE b* value (|a*|+|b*|) is greater than or equal to 10 and less than or equal to 100.

9. The natively colored glass-based article of claim 1, wherein the composition comprises from greater than or equal to 0.1 mol % to less than or equal to 5.0 mol % of a combination of NiO, Co₃O₄, and MnO₂.

10. The natively colored glass-based article of claim 1, wherein the glass composition comprises gold in an amount from 1 parts-per-million to 100 parts-per-million.

11. The natively colored glass-based article of claim 1, wherein the one or more colorants includes Cr₂O₃ in a range from greater than or equal to 0.01 mol % to less than or equal to 1.0 mol %.

12. The natively colored glass-based article of claim 1, wherein the composition comprises:
CuO in a range from greater than or equal to 0.01 mol % to less than or equal to 0.5 mol %; and
SnO₂ in a range from greater than or equal to 0.01 mol % to less than or equal to 0.5 mol %.

13. The natively colored glass-based article of claim 1, wherein the composition exhibits a liquidus viscosity from greater than or equal to 50 Pascal-seconds to less than or equal to 550 Pascal-seconds.

14. The natively colored glass-based article of claim 1, wherein the composition exhibits a radiative thermal conductivity at 1600° C. from greater than or equal to 150 Watts per meter-Kelvin (W/m-K) to less than or equal to 400 W/m-K.

15. The natively colored glass-based article of claim 1, wherein the natively colored glass-based article is a glass-ceramic having a petalite crystal phase or a lithium disilicate crystal phase.

16. A consumer electronic product, comprising:
a housing comprising a front surface, a back surface, and side surfaces;
electrical components at least partially within the housing, the electrical components comprising a controller, a memory, and a display, the display at or adjacent the front surface of the housing; and
a cover substrate disposed over the display,
wherein at least one of a portion of the housing comprises the natively colored glass-based article of claim 1.

17. A method of forming a natively colored glass-based article comprising:
heating precursor materials to form a molten material, a composition of the molten material comprises, based on 100 mol % of the composition:
from greater than or equal to 0.01 mol % to less than or equal to 5.0 mol % Na₂O;
from greater than or equal to 0.01 mol % to less than or equal to 5.0 mol % K₂O; and
from greater than or equal to 0.1 mol % to less than or equal to 5.0 mol % of one or more colorants, the one or more colorants includes silver, gold, NiO, Cr₂O₃, Co₃O₄, MnO₂, or combinations thereof, and
cooling the molten material to form the natively colored glass-based article,
wherein a molar ratio (Na₂O+K₂O)/(Li₂O+Na₂O+K₂O) is from greater than or equal to 0.0015 to less than or equal to 0.10, the molten material exhibits a radiative thermal conductivity at 1600° C. from greater than or equal to 150 Watts per meter-Kelvin (W/m-K) to less than or equal to 400 W/m-K, and the natively colored glass-based article exhibits:
a CIE L* value from greater than or equal to 15 to less than or equal to 90;
a CIE a* value from greater than or equal to −75 to less than or equal to 75; and
a CIE b* value is greater than or equal to −100 to less than or equal to 100.

18. The method of claim 17, wherein the composition further comprises:
from greater than or equal to 0.5 mol % to less than or equal to 8.0 mol % P₂O₅; and
from greater than or equal to 3.0 mol % to less than or equal to 10.0 mol % ZrO₂.

19. The method of claim 17, wherein the composition further comprises:
from greater than or equal to 0.0 mol % to less than or equal to 20.0 mol % Al₂O₃;
from greater than or equal to 0.0 mol % to less than or equal to 4.0 mol % B₂O₃; and
from greater than or equal to 0.0 mol % to less than or equal to 3 mol % CaO.

20. The method of claim 17, further comprising:
heating natively colored glass-based article at a temperature from 500° C. to 800° C. for a period of time from 30 minutes to 24 hours to form one or more crystal phases including a petalite crystal phase, a lithium disilicate crystal phase, or combinations thereof.
